(19) United States
(12) Patent Application Publication
(10) Pub. No.: US 2018/0089709 A1
(43) Pub. Date: Mar. 29, 2018

(54) TARGET MARKETING AND TRACKING SYSTEM AND METHOD

(71) Applicant: Christopher Michael Rousseau-Villella, Sarasota, FL (US)

(72) Inventor: Christopher Michael Rousseau-Villella, Sarasota, FL (US)

(21) Appl. No.: 15/280,039

(22) Filed: Sep. 29, 2016

(51) Int. Cl. G06Q 30/02; G06F 17/30

(52) U.S. Cl. CPC G06Q 30/0224; G06F 17/3087; G06Q 30/0261; G06Q 30/0255; G06F 17/30867

(57) ABSTRACT

A target marketing and tracking method is disclosed that includes collecting user-specific and venue-specific information; tracking and communicating with users using mobile devices associated with the users; allowing the users to enter user attractiveness values for other users; and determining a user attractiveness rating for each user based on the user attractiveness values entered for that user. User attendance at a venue can be determined using a stored venue location and user location information from the associated mobile device. Current venue attractiveness ratings can be determined based on the user attractiveness ratings for the users currently at and/or planning to attend the venue. The venues can access user-specific information and generate guest lists. Users can automatically be checked into venues based on associated mobile device location. Venues can offer vouchers to selected users. Voucher discount level and/or reload time can be set based on user attractiveness rating.

### FIELD OF THE DISCLOSURE

The present disclosure relates to marketing and tracking systems and methods, and more particularly, to a target marketing and tracking system and method that tracks specific users to aid in targeted marketing.

### BACKGROUND

Venues, especially food and beverage venues, such as, bars, lounges, restaurants, and nightclubs typically try to target a particular market. In targeting a particular market, it is common to market specifically to a demographic that will attract a greater market share. In one marketing strategy, a venue will spend resources trying to persuade popular people to come to their venue. It is believed that the popular people will attract additional patrons and ultimately increase sales generated by the venue.

Currently, a venue that distributes goods and services, such as a bar or restaurant, often requires opening and closing a tab or bill to pay for the goods and/or services utilized by the patron. Opening and closing tabs takes time and costs the venue money. When a venue is busy, opening and closing tabs utilizes time that could be used to serve other patrons. Some computer or phone applications or apps let users order drinks from their phone. These apps usually only work for one venue or one chain of venues and require the user to download an app that only applies to a specific location or chain.

Other apps that let users purchase drinks in the app require barcode scanning. Bar code scanning technology can require additional equipment and require time that could be spent serving patrons. Some venues implement free drink coupons to preferred patrons. It is common for a venue to give their staff and promoter's physical coupons to disperse to the patrons. However, physical coupons are difficult to control once distributed to the patrons. Accordingly, once the physical coupon is distributed to the public, the venue has no method of ensuring the coupon remains with the intended recipient.

Promotion guest list systems are often used and have promoters put the names of expected guests on a list, and when those guests arrive, they check in with a representative of the venue. The venue can then verify the guest has arrived and that the guest receives their discount or reward for checking in. This method requires the venue to pay a representative to meet guests and check them off a guest list. This method also creates uncertainty about whether the guest is in fact the person they say they are, often requiring the representative to spend extra time checking the user's identification (ID). In the meantime, other guests may be waiting to get into the venue. The longer that guests are kept waiting outside the venue, the more money the venue is losing.

Many mobile applications or apps use a cell phone's GPS location to verify that a user is actually at a location. This check-in system is vulnerable to users that can modify their cell phone or other mobile device to fake the actual GPS location. This can be a problem for venues that offer rewards to users of certain apps for checking in, because mobile device GPS locations may be fraudulently shown, which means the venue could lose revenue by rewarding a user that is not actually present at the venue.

One method of increasing a venue's popularity is by maintaining a customer base filled with influential people. Patrons typically want to attend venues filled with other people who have large networks and/or a large influence on the patrons' network. Another method for venues to attract patrons is to market to “hot” people, i.e. people who are attractive to their patrons, whether physically, through celebrity or by some other metric. In this example, a venue may try to attract the “hottest” people in a given area.

Promoters may be hired to attract the proper demographic to a venue. The promotors are instructed to only invite the “hottest” people in a city to the respective venues. However, this solution is expensive and often does not provide a financial return to the venue for the cost of the promotor. In addition, patrons often identify the promoter and acknowledge that they only work for one venue. This causes the patron to question the truth about the promotor's claims about the popularity of the venue they are promoting.

Venues also try to place physical marketing ads at locations where they think their desired patrons frequent. For example, gyms, hair salons, malls or other locations often have physical marketing ads for these venues. Physical marketing ads create uncertainty about who is getting the marketing material. This uncertainty restricts the types of offers the venue can advertise in order to avoid attracting undesired patrons. In addition, if a desired patron does want to attend an event at a particular venue based on a physical ad they observed, there is not a convenient way for this patron to let their network know they are going to that venue. Accordingly, unless the patron decides to be proactive and post the promotion on their social media, the physical ad will be less effective at broadly attracting the desired patrons.

Currently, the only way to determine the type of attendance at a venue is to physically be at that venue, or to communicate with a patron that is physically at the venue. In some venues, a general idea of the types of patrons that the venue attracts can be determined based on the types of patrons that attended the venue the week before. Further, patrons could go online and look at photos of people from events the week before.

### SUMMARY

A target marketing and tracking system can include a feature to offer free drink, food or other items to patrons of certain venues. The system can enable a user to give free coupons for drinks, food or other items at participating venues to other users.

The system can utilize a Global Positioning System (“GPS) to allow users to automatically be checked into a guest list using the GPS system from a computer, mobile device, cell phone, or any other similar electronic device. Further, check-in time can be minimized by creating digital guest lists that are available electronically on mobile devices. In some embodiments, a venue representative can quickly search for the names on the digital guest list.

The system can utilize a wireless fidelity (“Wi-Fi”) location for check-in verification. More specifically, the system may check that the user is in range of the venue WiFi network before allowing the user to check into that specific venue. Implementing venue-specific WiFi network requirements can help prevent users from faking a GPS location.

Some system embodiments may implement a method that does not require a user to input a password. For example, the system can verify the network name for the specific location to determine whether the user is physically at a venue. For example, a venue can fill in their network name in the settings area and then a user's phone can check to make sure the venue's WiFi name and network are within the vicinity of the phones WiFi range.

The system can provide a tool for users to find the venues in which select individuals are located.

A venue may have coupon offers that reload based on how long a user has been checked into the venue. Further, a user may get a reward for posting a photo while checked into the venue where the posted photo includes the venues logo. In some embodiments, the system may require posted photos to come directly from the user's mobile device camera. That is to say, the user cannot upload a photo that was previously taken but rather must actively take a photo with the user's mobile device camera while using the system to upload the picture.

In other embodiments, the user's device may connect to an Application Program Interface (“API”) of another application to determine a social influence score for the user. The influence score may allow users to filter potential venues and display venues with the highest influential score first.

A target marketing and tracking method is disclosed that includes collecting user-specific information for a plurality of users; collecting venue-specific information for a plurality of venues; storing the user-specific information and the venue-specific information in a system database; and tracking and communicating with each of the users using a plurality of mobile devices where each of the mobile devices is associated with one of the users. The target marketing and tracking method can also include allowing each of the users to enter an user attractiveness value for each of the other users; storing the user attractiveness values in the system database; and determining an user attractiveness rating for each user based on the user attractiveness values entered for that user. The target marketing and tracking method can also include storing a venue location for each of the venues in the system database; receiving user location information from each of the mobile devices; and determining user attendance at a particular venue based on the venue location for the particular venue and the user location information. The target marketing and tracking method can also include for each particular venue, determining users currently at the venue based on the venue location for the particular venue and the user location information from the mobile devices; retrieving the user attractiveness rating for each of the users currently at the venue; and calculating a current venue attractiveness rating for the particular venue based on the user attractiveness ratings for the users currently at the venue.

The target marketing and tracking method can also include allowing each individual user of the plurality of users to enter going-to information, the going-to information including a going-to location identifier and a going-to time identifier. The target marketing and tracking method can also include for each particular venue: determining users currently at the venue based on the venue location for the particular venue and the user location information from the mobile devices; determining users planning to attend the venue today based on the going to information where the going-to location identifier indicates the particular venue and the going-to time identifier indicates today; retrieving the user attractiveness rating for each of the users currently at the venue and for each of the users planning to attend the venue today that are not currently at the venue; and calculating a current venue attractiveness rating for the particular venue based on the user attractiveness ratings for the users currently at the venue and the users planning to attend the venue today. The target marketing and tracking method can also include for each particular venue: determining the N most attractive users currently at the venue and/or planning to attend the venue today based on their user attractiveness ratings, where N is a positive whole number. A requesting user can specify the value of N.

The target marketing and tracking method can also include for each individual venue: enabling the individual venue to access the user-specific information and the user attractiveness values; enabling the individual venue to generate a venue guest list that includes a plurality of the users; and when an individual user is determined to be at the individual venue based on the venue location for the individual venue and the user location information for the mobile device associated with the individual user: automatically checking the venue guest list to determine whether the individual user is included on the venue guest list; and if the individual user is included on the venue guest list, updating the venue guest list to indicate the individual user has arrived. The target marketing and tracking method can also include enabling the individual venue to set a venue attractiveness threshold; and enabling the individual venue to generate the venue guest list based on one or more guest list criteria where one of the guest list criteria can be that the user attractiveness rating of each user on the guest list is higher than the venue attractiveness threshold.

The target marketing and tracking method can also include for each individual venue: enabling the individual venue to offer venue vouchers to selected users where the venue vouchers are redeemable for discounted items at the individual venue. The target marketing and tracking method can also include enabling the individual venue to set a discount level for the venue vouchers offered to the selected users, the discount level of a particular venue voucher offered to a particular selected user can be based on the user attractiveness rating for the selected user. The target marketing and tracking method can also include enabling the individual venue to set a reload time for the venue vouchers offered to the selected users, the reload time of a particular venue voucher offered to a particular selected user can be based on the user attractiveness rating for the selected user.

The target marketing and tracking method can also include for each individual venue, when an individual user is determined to be at the individual venue based on the venue location and the user location information for the mobile device associated with the individual user: retrieving the user attractiveness rating for the individual user; and offering a particular venue voucher to the individual user, if the user attractiveness rating for the individual user is equal to or greater than a user attractiveness threshold set by the individual venue. The target marketing and tracking method can also include enabling the individual venue to set a discount level and/or a reload time for the venue vouchers. The discount level and/or reload time for a particular venue voucher can be based on the user attractiveness rating for the individual user.

These and other aspects of the present disclosure and the manner of obtaining them will become more apparent and the disclosure itself will be better understood by reference to the following description of the embodiments of the disclosure, taken in conjunction with the accompanying drawings of exemplary embodiments.

### BRIEF DESCRIPTION OF THE DRAWINGS

FIG. 1 illustrates an exemplary embodiment of an environment for a target marketing and tracking system;

FIG. 2 illustrates an exemplary embodiment of a hoots/news stream display with navigation controls;

FIG. 3 illustrates an exemplary embodiment of a place or event profile;

FIG. 4 illustrates an exemplary embodiment of a people display;

FIG. 5 illustrates an exemplary embodiment of a spots/places display;

FIG. 6 illustrates an exemplary embodiment of a venue menu display;

FIG. 7 illustrates an exemplary embodiment of a my venue items display;

FIG. 8 illustrates an exemplary embodiment of a show order to server/bartender display;

FIG. 9 illustrates an exemplary embodiment of a show order-server id display;

FIG. 10 illustrates an exemplary embodiment of a show order-status display;

FIG. 11 illustrates an exemplary embodiment of a show order-tip display;

FIG. 12 illustrates an exemplary embodiment of a pick-up order display;

FIG. 13 illustrates an exemplary embodiment of a submit order for later pickup display;

FIG. 14 illustrates an exemplary embodiment of a bring-to-me-table number display;

FIG. 15 illustrates an exemplary embodiment of a bring-to-me display;

FIG. 16 illustrates an exemplary embodiment of a bring-me-later display;

FIG. 17 illustrates an exemplary embodiment of a status and alerts display;

FIG. 18 illustrates an exemplary embodiment of a settings display;

FIG. 19 illustrates an exemplary embodiment of a spot legend display;

FIG. 20 illustrates an exemplary embodiment of a place open display;

FIG. 21A illustrates an exemplary embodiment of a first portion of an edit venue information display;

FIG. 21B illustrates an exemplary embodiment of a second portion of the edit venue information display;

FIG. 21C illustrates an exemplary embodiment of a third portion of the edit venue information display;

FIG. 21D illustrates an exemplary embodiment of a fourth portion of the edit venue information display;

FIG. 22 illustrates an exemplary embodiment of a create event display;

FIG. 23 illustrates an exemplary embodiment of a spot location display;

FIG. 24 illustrates an exemplary embodiment of a guest list display;

FIG. 25 illustrates an exemplary embodiment of a VIP list display;

FIG. 26 illustrates an exemplary embodiment of a free drinks display;

FIG. 27 illustrates an exemplary embodiment of a sell items display;

FIG. 28 illustrates an exemplary embodiment of an option edit display;

FIG. 29 illustrates an exemplary embodiment of an option choice edit display;

FIG. 30 illustrates an exemplary embodiment of a loot offer display;

FIG. 31 illustrates an exemplary embodiment of a referral program display;

FIG. 32 illustrates an exemplary embodiment of a customer display;

FIG. 33 illustrates an exemplary embodiment of an account activity display;

FIG. 34 illustrates an exemplary embodiment of an attendee display;

FIG. 35 illustrates an exemplary embodiment of a drink code display;

FIG. 36 illustrates an exemplary embodiment of a check-in display;

FIG. 37 illustrates an exemplary embodiment of a checked in display;

FIG. 38 illustrates an exemplary embodiment of a post-a-photo earn rewards display;

FIG. 39 illustrates an exemplary embodiment of a camera rewards display;

FIG. 40 illustrates an exemplary embodiment of a camera share display;

FIG. 41 illustrates an exemplary embodiment of a camera display;

FIG. 42 illustrates an exemplary embodiment of a camera share display;

FIG. 43 illustrates an exemplary embodiment of a notifications display;

FIG. 44 illustrates an exemplary embodiment of a profile display;

FIG. 45 illustrates an exemplary system implementation and corresponding displays to target market to particular people;

FIG. 46 illustrates an exemplary system implementation to determine a hot/attractiveness rating for a venue;

FIG. 47 illustrates an exemplary system implementation to purchase items from a venue;

FIG. 48 illustrates an exemplary system implementation to market offers to hot/attractive people;

FIG. 49 illustrates an exemplary system implementation for GPS promotion guest list tracking;

FIG. 50 illustrates an exemplary implementation of a reloading coupon/voucher;

FIG. 51 illustrates an example of an embodiment for providing rewards to users for taking a photo or video for marketing once checked into a place;

FIG. 52 illustrates an exemplary embodiment for locating people with social influence;

FIG. 53 illustrates an example of a marketing company business model using the disclosed system; and

FIG. 54 shows a flow diagram for an exemplary wireless check-in verification process.

### DESCRIPTION OF EXEMPLARY EMBODIMENTS

The exemplary embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

A target marketing and tracking system can include one or more of the following capabilities, as well as other capabilities described herein. The system may enable venues to target a market of selected people; and/or give free drink, food or other promotional coupons to users for use at participating venues. The system may generate coupon offers that reload based on how long a user has been checked into a venue; and/or provide users with rewards for posting a photo while checked into a venue where the photo posted includes the logo of the venue. The system may generate a venue promotion guest list by tracking users and automatically checking the users into the venue promotion guest list when they arrive at the venue. The system may ensure proper location by using venue Wi-Fi location check-in verification. The system may enable users to find places with selected people; and/or enable users to find places with the people who have the most followers. The system may generate hidden likes that enable a first user to indicate to the system that they like a second user, wherein the like fades away so that other users or someone who looked at the first user's mobile device do not know that the first user indicated that they liked the second user.

The system can enable venues to target market to the “hottest” people and/or can enable users to find the venues with the “hottest” people. The system can include a tool for venues to sell drinks faster and more efficiently, and/or can generate free drink coupons for users that can be used at participating venues.

The system can include a GPS guest list tracking system that enables a user to automatically get checked into the venue guest list using their mobile device's GPS system.

The system can enable users to find the places where people who have a large number of followers are located. This embodiment may allow users to network with people who may be able to expand and further their network of followers and/or raise their influence rating.

Some embodiments may connect to other systems to assist in determining a social influence score for the user or venue. The influence score can enable users to filter the potential locations/venues to list the venues in descending order based on the influence scores of users at the location. These embodiments may allow users to find out what venues are being visited by other users, and/or allow users to plan their evening or networking schedule around knowing where other users will be meeting and networking.

The target marketing and tracking system can enable venues to target a market of a selected demographic of people. The system can enable a venue to post general venue information and create events. The venue can also charge a fee for a user to check into an event.

The target marketing and tracking system may enable updating of event information by updating the information in the system. The updating of event information may be done locally or remotely via an electronic device such as a phone, computer, mobile device, or any other similar hardware. When people start indicating that they are Going to an event within the system, venues can see who is planning to attend the event, the popularity of the people, the expected ratio of females to males, etc. and the venue can adjust their marketing efforts accordingly. The venue can change cover charges for men and women independently, target influential people, or give out free vouchers to men and/or women. When these changes are made on the system by the venue, the system may automatically update end users of the changes. Real-time information may update potential venue patrons based on current user attendance in the venue.

The target marketing and tracking system may enable venues to coordinate general marketing tools with an attractiveness marketing filter. The attractiveness marketing filter may allow venues to filter users in their general target market and remove the least popular or attractive users from the venues marketing campaigns or reward offers.

The system may let venues post their general venue information and create events. The system may allow a venue to access advanced features that provide user preferences or scores. Accordingly, the system may have several different access or use levels where some access levels do not include advanced features. A first access level may only allow venues or users to view generic information such as venue location and general events. A second access level may allow the venue or user to access more detailed information, for example, the number of patrons in attendance at a venue and/or specific details about those patrons.

Venues can utilize remote access to the system to see exactly who is planning to attend the venue, an attractiveness rating of the people in attendance, and the male to female ratio. The venue can actively adjust their marketing efforts based on this and other information. The active adjustment may include changing the cover charges for males or females, targeting the people with high attractiveness ratings, or giving out free vouchers to men, women, or both. All of this can be done remotely through the system via any electronic device with proper access credentials. Further, an end user may access the updates immediately.

The attractiveness rating can be measured by various methods, for example a “chili peppers” score. The more chili peppers, the more popular. The chili peppers score may allow venues to filter out the users in their general target market and remove people with the lowest attractiveness rating or amount of chili peppers.

The venue may have set a target distance as part of a general marketing tool. More specifically, the venue may input their GPS location into the system as a center point and select how far away from their venue they want to market. Additionally, the venue may select a target age range as part of the general marketing tool. The target age range may be the specific age ranges to which the venue wants to provide marketing material. The general marketing tool may also provide the venue with a selection for gender. For example, the venue may desire to provide marketing material only to men. If the venue selects this preference in the general marketing tool, the marketing material will only be provided to male users. Alternatively, women may be the target market of the venue, and only women will be sent marketing material from the venue.

The venue may also select which users receive marketing material based on the number of followers a user has. In this embodiment, marketing material for the venue may not be distributed or displayed to users that do not have at least some threshold amount of followers. In yet another example, the venue may set a maximum number of people allowed on an entry list or guest list per day. In this example, the system may stop offering a guest list option to users after a set number of users say they are going to attend an event hosted by the venue.

The system may also allow the venue to set different cover charges for different target markets. In this embodiment, a user with a high attractiveness rating or many different contacts or followers may be issued a lower cover charge than a user with a lower attractiveness rating or fewer contacts or followers.

The system can allow the venue to set a predefined number of guests that can join an active user on the guest list. In this embodiment, a user with a high attractiveness rating or many contacts may be allowed to have more guests added to the guest list than a user with lower attractiveness rating or fewer contacts. Additionally, the venue may set specific cover charges for guests of the different users.

The system may also allow a venue to offer users a free drink, food or other voucher after the user's first time checking-in to the venue. The system can filter out users who have previously checked-in to the venue by storing check-in information in a server, database, mobile device, local machine, or any other known place to store data. Similarly, the system may let venues limit the number of free vouchers that will be given out to users. The venue may select a predefined number of free vouchers to give out on any given night. Once a user has been offered a free voucher, the total number of free vouchers that user can attain may be reduced. Further still, the particular times in which free vouchers will be offered may be limited in the system by the venue. In this aspect of the system, the venue may select a beginning time and an ending time for offers and free vouchers to be presented to users.

The system can also enable a venue to specify the specific types of drinks, food or other promotional items that may be offered for free or at a discounted rate. In this embodiment, the offers presented to the users may only apply to specific types of promotional items. The venue may alter the promotional items offered to the users based on venue supply, user demand, special events, or any other similar reason to provide a discount for a particular type of promotional item.

In some embodiments, the venue may use the system to set instructions for using the promotional item voucher or executing any of the other features of the system. More specifically, the venue can set instructions so the user knows how to check into the venue via the guest list or how to redeem a promotional item voucher. As one non-exclusive example, the venue may say “show the free drink ticket to the bartender” or “show the free food item coupon to the waitress” when the user is presented with the promotional item voucher.

In some embodiments, the promotional item vouchers and discounts discussed above may be programmed within the system to reload based on the venue's preference. More specifically, if the user uses a voucher then the venue can set a time period after which another voucher for the same or a different promotional item may be offered to the user. Accordingly, if a user has a drink voucher that is set to reload after sixty minutes, the countdown will begin as soon as the previous drink voucher is used. In yet another aspect of this embodiment, the venue can also set the maximum amount of times a drink voucher can reload.

Similarly, in another embodiment the venue may also set the amount of time a user needs to wait in order to use a drink voucher. This may encourage the user to remain in the venue and potentially purchase other items from the venue while they are waiting for their free drink voucher to activate. This feature may also deter users from travelling between different venues to get free drinks therefrom.

Other embodiments of the system may enable a venue to set a marketing budget for each day. In these embodiments, the venue can set a maximum marketing budget for the day. Alternatively, the venue can set multiple days marketing budgets at the same time. The marketing budget may affect the number of free vouchers sent to users. Additionally, the marketing budget set by the venue may adjust the cover charges for each respective user.

The system may also allow the venue to pre-set how many days prior to an event to begin marketing for the event. For example, the venue may decide to initiate a marketing campaign through the system one week prior to an event. Alternatively, the venue may prefer to start marketing the event only one day before the event. This embodiment may allow the venue to select any number of days before the marketing campaign is initiated by the system. Similarly, a venue may pause a marketing campaign to better utilize the venues marketing budget. In one non-exclusive example of this embodiment, the venue may start a marketing campaign a month before the event; then the venue may pause the marketing campaign after a day of marketing; and finally the venue may resume the marketing campaign a week prior to the event. In yet another example of the variable marketing option, the venue may monitor the number of patrons attending an event or the number of tickets sold. Once a desired quota is reached, the venue may pause or cancel the marketing campaign.

In other embodiments, the venue may use the system to present a more enticing offer to users from certain areas or demographics. More specifically, in one non-exclusive example, if the venue wants to attract a college crowd it may provide additional drink coupons or cover charge discounts to users who live within a particular college area or who have college identification. Further still, the venue may give different drink vouchers or other discounts to patrons in different age demographics.

The system may also provide several benefits to an active user. More specifically, in one embodiment the active user may use the system to determine which venue has patrons with the highest attractiveness rating. Additionally, the active user may use the system to determine how busy a given venue is in real time. The system may also provide an active user with a list of people who plan on attending a venue or event. The active user may then view more specific details about the people planning to attend. The active user may also indicate on the system that the active user likes another user on the system. If the two users indicate a like to one another's user information then the system may indicate that they have been matched up. Accordingly, the active user can implement the system to select a venue based on any of the above-described factors. In addition, the venues may be listed based on the statistical data obtained from the users within a given venue or attending a given event. Accordingly, the system may generate substantially unbiased lists of venues with the user's desired preferences.

In yet another embodiment, the system may allow the venue to pre-sell drinks or sell drinks at the venue with greater speed and efficiency. More specifically, a venue implementing the sale of a beverage through the system may process the transaction remotely without requiring the attention of a server. In one non-exclusive example of this feature, the user may display a coupon or other indicator on their mobile device to the bartender, server, or other venue representative, and they may touch the coupon or other indicator on the active user's mobile device to indicate the coupon's use. Further, the server may confirm the coupon is real via a code that is revealed on the active user's mobile device once the drink coupon is marked as used. The system may maintain a list of drink codes that correlate with a particular event. If the drink coupon code matches the list of drink codes shown in the system, the code is correct and the server can serve the active user. The venue may keep this screen displayed during normal operating hours to allow all servers an opportunity to verify drink codes. Another form of verification can be that an active user's order/coupon redemption appears on a list of open orders where the coupon codes were displayed.

The system may also allow the venue to distribute drink, food or other promotional vouchers to preferred users. The vouchers may then show up on the respective user's mobile device and the server or venue representative may click the vouchers and retrieve the active user's promotional item as described above. Once the server touches the voucher, the code is revealed and the server can confirm whether the code matches the list of voucher codes in the system or otherwise displayed in the venue. The list of drink codes may be maintained by a website that the venue can access. Another form of verification can be that the active user's order/coupon redemption appears on a list of open orders where the coupon codes were displayed.

The system may also utilize a GPS tracking system to automatically check the user into the guest list of the venue when the user is within certain proximity of the venue. The user may have an auto check-in option on the system that allows the system to check to see if a user is within check-in range of a venue. If the user is in the check-in range of a venue then the system will automatically check the user into the venue's guest list. If the auto check-in feature is not enabled by the user, the system will send a notification to the user's phone to check-in at the venue.

The venue may utilize the system to record and identify users at the venue at any given time. When a guest utilizing the system enters the venue, the system may either automatically check the user into the guest list or a venue representative may electronically execute a check-in for the user. Further, when the automatic check-in of the system is enabled, the venue may also identify and record when the user leaves. Additionally, the system may also allow a venue to identify who attended the venue as another user's guest and/or the number of guests that accompanied a user.

Utilizing the system may allow the user to check into venues quickly and efficiently as described above. Further, check-in processes utilizing the system may reduce wait time at venue entrances. The system may also confirm an active user's identification. In this embodiment, the check-in time can be further reduced when the venue confirms identification of the active user based on their system credentials. Further, once the active user is checked-in to the guest list, the user can also automatically be given any applicable coupons or rewards for checking in, and any time released reward clocks can be displayed and begin to count down as described above.

The system can enable each user to generate a social influence score based on a plurality of metrics ranging from number of contacts to the attractiveness level of the active user. This can provide a way to see the preferences of different types of users. The system may allow users to find venues around them that have the users with the highest social influence score. This system may also allow for a method of arranging a physical meeting with other users.

In another embodiment, rather than paying for ads on social media sites, the system may allow a user to get rewards from the venue for posting a photo while checked-in to the venue via their social media networks. The venue may require that the photo include the name and logo of the venue so the venue is advertised to all of the people that follow or are friends with the user on their social networks.

Further, the system may connect to an API of another application to assist in determining the social influence scores for a user. The social influence score can enable users to filter venues so that the venues with the most influential users are displayed first.

The system may utilize a Hoots area, where the hoots area is comprised of a streaming feed made up of a photo stream, and going notifications. The photo stream may be photos posted using a mobile device uploaded to the system by users and user followers. The photos posted in the photo stream may be displayed along with other information. The other information may include one or more of the user's username, main profile picture, time stamp (time since photo was posted), a like button, a comment button, a list of other users who liked the photo, a link to the list of users, a list of the comments made to that photo, etc.

The going notification may let users know that one of the people they follow has touched the going button in a geographic area, venue, or event of interest. The going notification also includes the user's profile photo, the day they are going to the location, the name of the location they are going to, a time stamp (time since posted), and a going button for a viewing user to go to the location, venue or event as well.

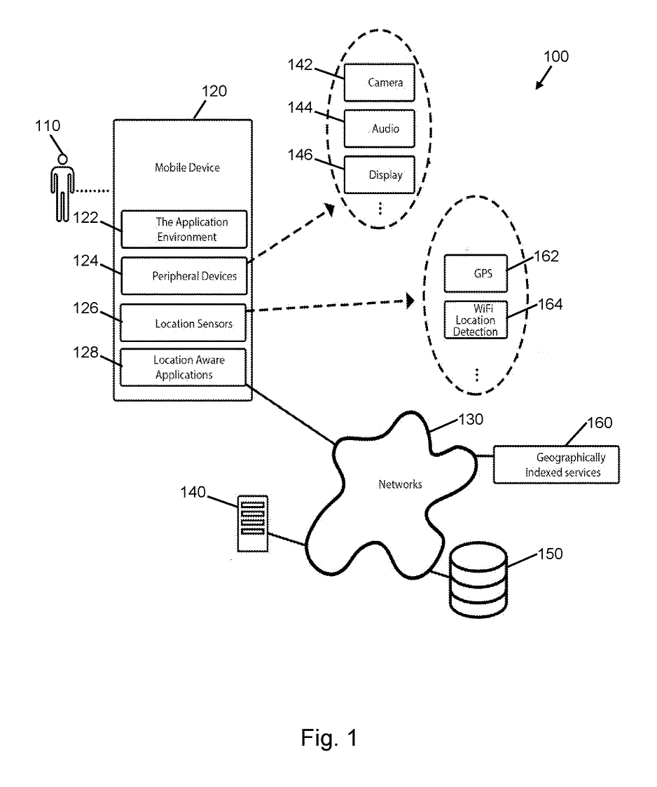

FIG. 1 illustrates an exemplary embodiment of an environment 100 for a target marketing and tracking system. The environment includes a user 110, the user's mobile device 120, available networks 130, servers 140, databases 150 and geographically indexed services 160. The mobile device 120, servers 140, databases 150 and geographically indexed services 160 are connected by the available networks 130. The mobile device 120 includes an application environment 122, peripheral device(s) 124, location sensor(s) 126 and location aware application(s) 128. The application environment 122 includes the operating system and other services supporting applications that operate on the mobile device 120. The peripheral device(s) 124 can include a camera 142, audio devices 144 and a display 146. The audio devices 144 can include speakers and/or microphone. The location sensor(s) 126 can include GPS location sensors 162 and wireless network location sensors 164. The location aware application(s) 128 can send and receive information with the servers 140, databases 150 and geographically indexed services 160 over the available networks 130. The servers 140, databases 150 and geographically indexed services 160 can include remote system servers, databases and services and/or local venue based servers, databases and services.

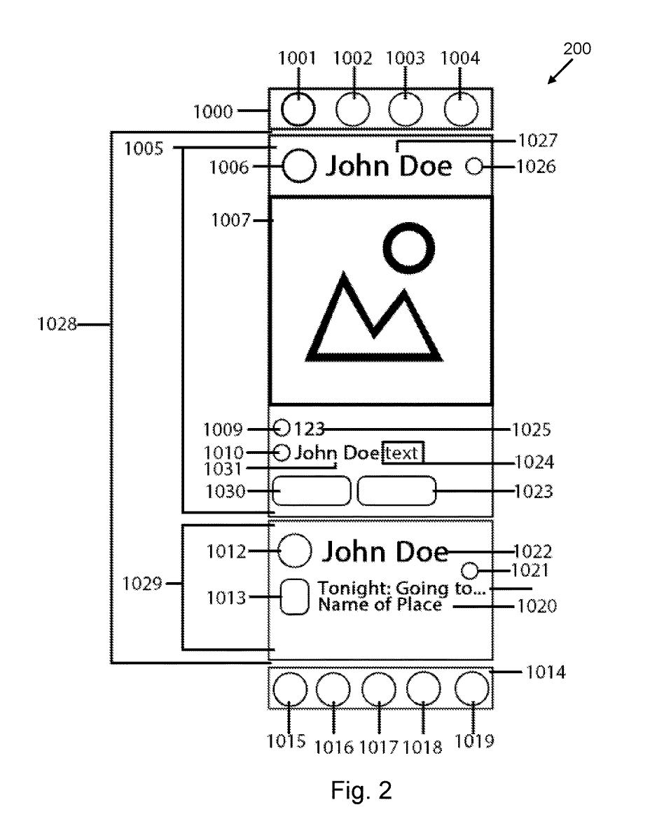

FIG. 2 illustrates an exemplary embodiment of a hoots/news stream display 200 with navigation controls on the display 146 of a mobile device 120. The exemplary hoots/news stream display 200 includes a top navigation legend 1000, a bottom navigation legend 1014 and a hoots/news stream area 1028 that includes a posts area 1005 and a going area 1029.

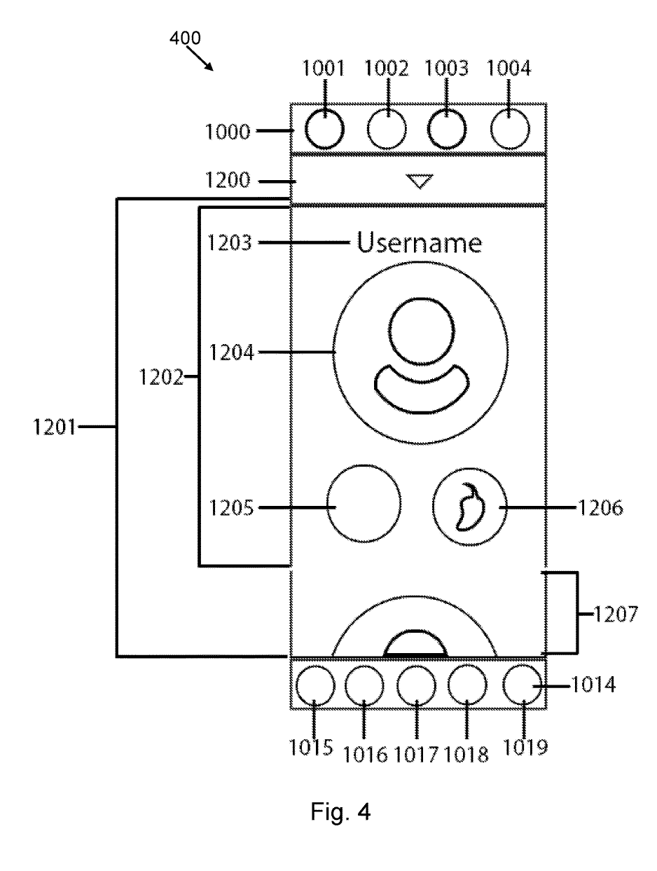

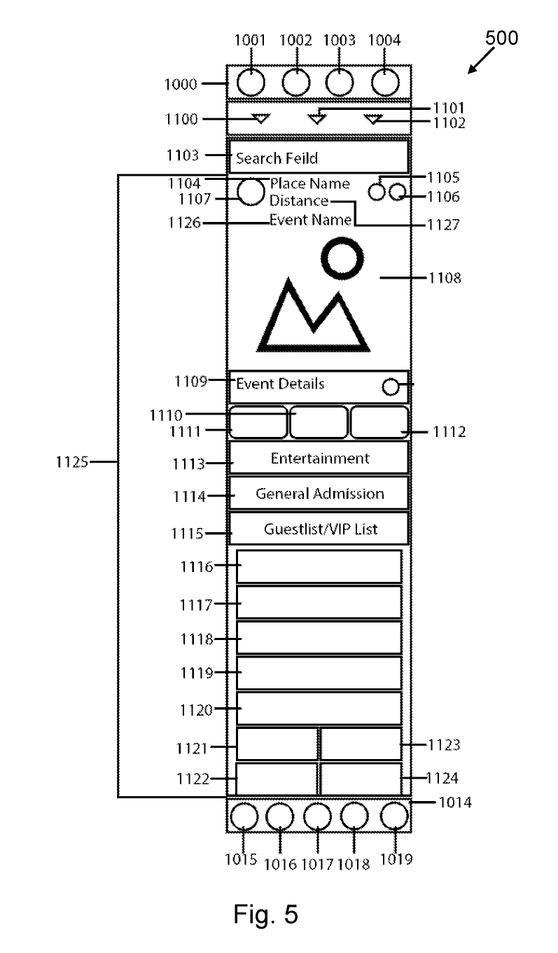

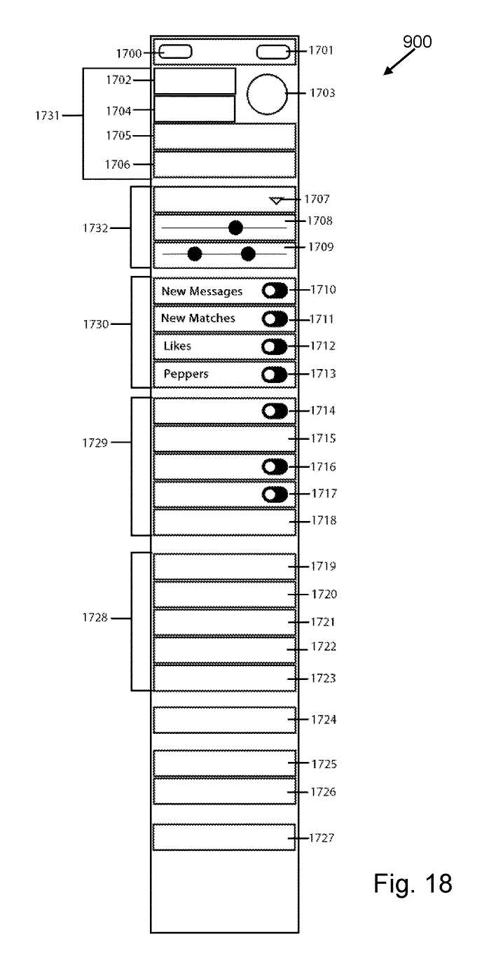

The top navigation legend 1000 can include a hoots button 1001, a spots button 1002, a people button 1003 and a settings button 1004 to enable the active user to quickly switch between displays. The hoots button 1001 can link the active user from any display to the hoots/news stream display 200 that includes photos posted by other users, and notifications that other users are planning to attend specific places (or spots). The hoots/news stream area 1028 can include news and information posted by system users. For example, when users take photos, the photos can be shown to their followers in the posts area 1005 of the hoots/news stream area 1028. The spots button 1002 can link the active user from any display to a spots/places display 500 (see FIG. 5). The spots button 1002 can also notify other users of the geographic location of the mobile device 120. The people button 1003 can link the active user from any display to a people display 400 (see FIG. 4) that shows a list of system users, and can enable the active user to identify other users of interest. The settings button 1004 can link the active user from any display to a settings display 900 (see FIG. 18). The settings display 900 can include a distance setting that lets the active user select the distance from their current location or a selected location that they want the system to search when returning search results. For example, if the active users distance setting is 10 miles then in the people display 400, all the users or all the users with public profiles will be listed that are within 10 miles of the active user's current location or selected location. The settings display 900 can include various other settings that allow the active user to enter a settings configuration for the system on their mobile device 120.

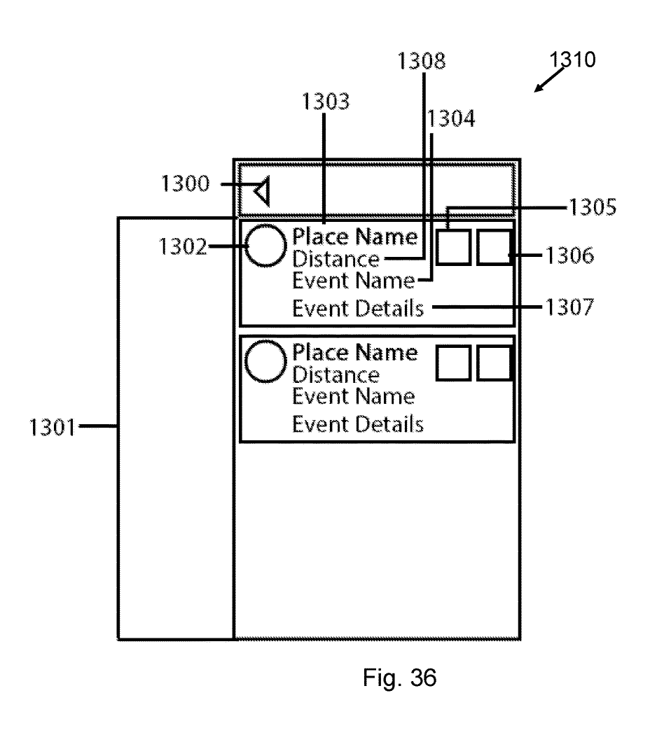

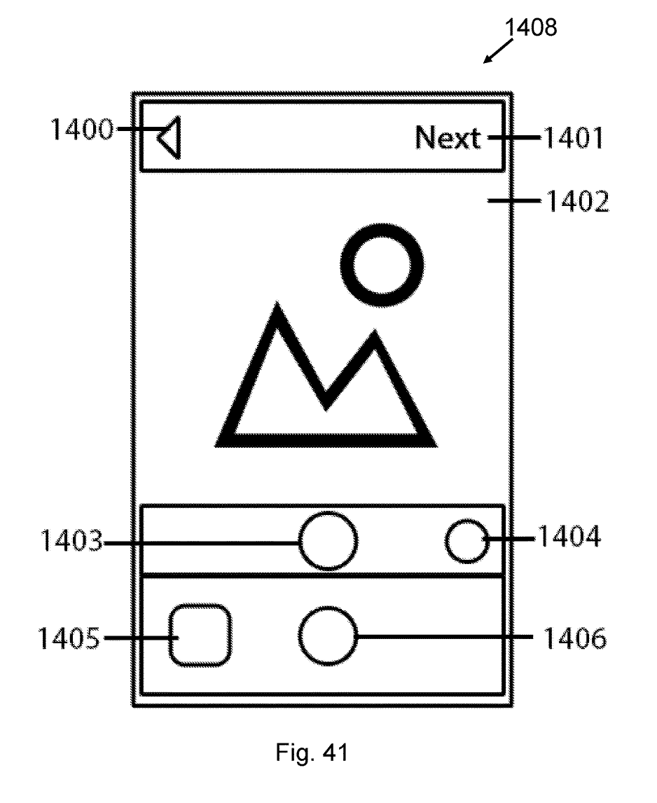

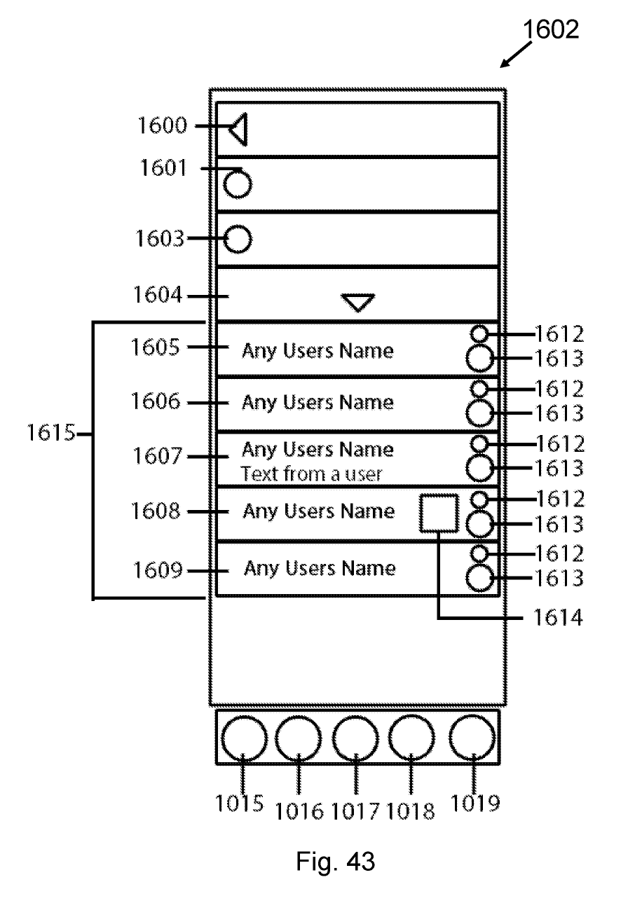

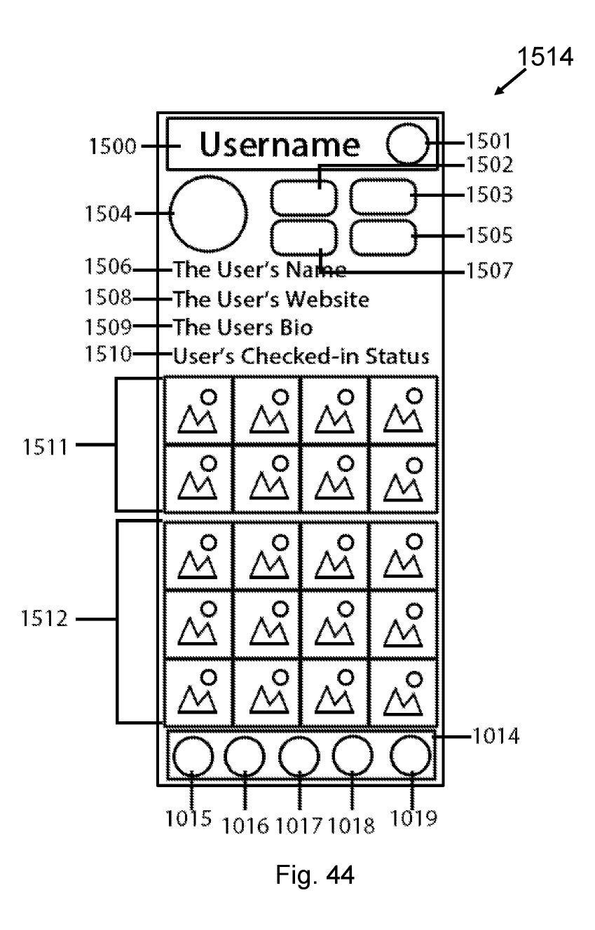

An exemplary bottom navigation legend 1014 may include a home button 1015, a check-in button 1016, a camera button 1017, a notification button 1018 and a user profile button 1019. The home button 1015 can link the active user from any display to a geographic area home screen that identifies venues located within a preset geographic area of the user. The check-in button 1016 can link the active user from any display to a check-in display (see FIG. 36) that can enable the active user to manually check-in to a venue's guest list. The camera button 1017 can link the active user from any display to a camera display (see FIG. 41) that provides controls for the camera 142 of the mobile device 120. The notification button 1018 can link the active user from any display to a notifications display (see FIG. 43) that shows the notifications in the respective geographic area being posted by other users. The user profile button 1019 can link the active user from any display to a user profile display (see FIG. 44).

The exemplary news stream area 1028 includes posts and going announcements from remote users that the active user follows. The posts can be shown in the posts area 1005, and the going announcements can be shown in the going announcements area 1028 which may include one or more scrollable areas to enable the user to see more content associated with the posts and/or going announcements than can be simultaneously shown on the display screen.

The posts area 1005 can display posts from remote users that the active user follows. The posts area 1005 can include various fields associated with the remote user posts including, for example, one or more of the following exemplary fields. A profile image 1006 that provides an image of the remote user that made the post. The profile image 1006 may be a selectable button that links the active user to the remote user's user profile. A username field 1027 that provides the username of the remote user that made the post. A post time stamp 1026 that shows a time stamp of when the post was made by the remote user. A posted image 1007 that provides any images associated with the post from the remote user. A selectable comment list button 1009 that provides a link for the active user to view comments by other users that have commented or responded to the post from the remote user. A comment or likes count 1025 that indicates the total number of likes or comments that the post has received from other users. When a post is liked or commented on by other users, the total number of likes and/or comments can be tracked by the system. A commenting user icon 1010 and a commenting user name 1031 which are an icon and username, respectively, associated with the user that posted the comment. The commenting user icon 1010 and/or commenting user name 1031 may include a selectable link that connects to the user profile of the commenting user. A comment text area 1024 includes any text of the comment. In one nonexclusive embodiment, the three most recent comments are shown to the active user, and any additional comments are available to the user through a link. The active user can select a like button 1030 to indicate that the active user likes this post. A comment entry area 1023 can open a comments entry area where the active user can enter a comment regarding this post by the remote user.

The going area 1029 displays going announcement posts generated by the system when a going user chooses to share where they are going with the users that follow them. A going user link 1012 shows a profile image of the going user that made the going announcement post. Selecting the going user link 1012 can display the going user's user profile. A going user username 1022 shows the username of the going user that made the going announcement post. A going post time stamp 1021 indicates when the going user made the going announcement post. An active user going button 1013 is a selectable going button for the active user. The active user can select the active user going button 1013 to indicate that they will also be attending the venue or event associated with the going announcement post displayed in the going area 1029. A going event name and time area 1020 shows the name of the venue or event and the event or attendance time associated with the going announcement post displayed in the going area 1029.

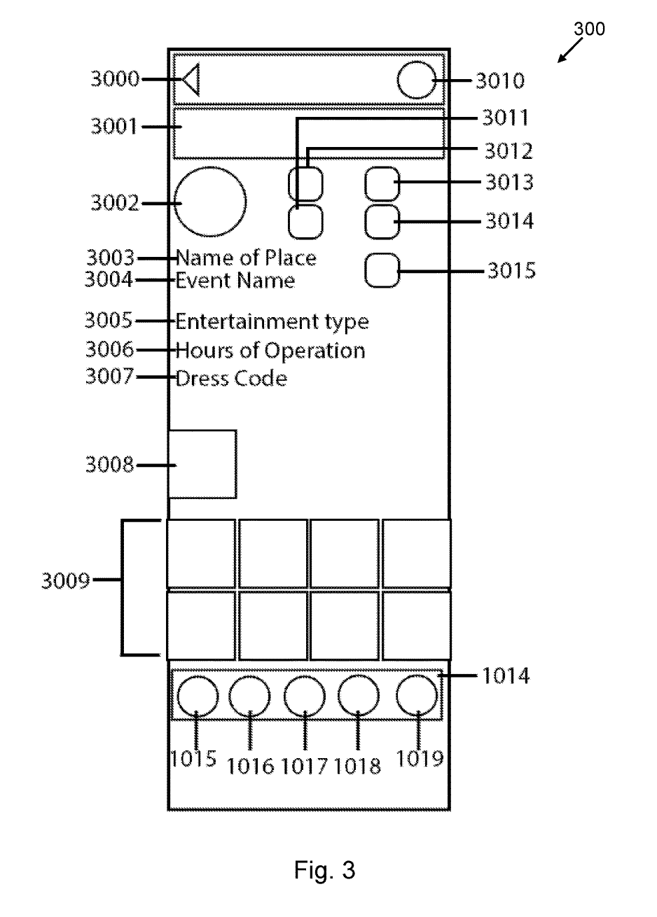

FIG. 3 illustrates an exemplary embodiment of a place or event profile 300. The place profile display may include the top and bottom navigation legends 1000, 1014 shown and described with regard to FIG. 2. The place profile 300 may include a back button 3000 that brings the active user to the previous screen, a venue settings icon 3010 and a date filter field 3001. The active user can select the venue settings icon 3010 to direct the system to a venue settings page. The active user can select or enter a date or date range in the date filter field 3001 to indicate a date of interest for displaying any events scheduled for the date of interest at a selected place.

The place profile 300 may include a logo or icon area 3002, a venue name field 3003 and an event name field 3004. The icon area 3002 can display a logo or icon for the place or event. The venue name 3003 and event name 3004 fields can indicate the venue and event names, respectively, for any special event at the selected venue during the date of interest selected in the date filter field 3001. An entertainment type 3005, an event or venue hours 3006, and a dress code 3007 may be displayed that are associated with the venue and event displayed in the venue name 3003 and event name 3004 fields. In one non-exclusive example, the entertainment type 3005 may display a band name, the name of a speaker, or any other similar information that a user interested in the event may want to see. Similarly, the dress code 3007 may identify any required dress code for the event and/or venue. An event flag 3008 can indicate whether a venue has an event for the date of interest selected in the date filter field 3001. The venue information displayed by the event profile 300 can be altered in a venue settings page.

The place profile 300 may also include a mapping link 3011, an attractiveness or chili pepper rating 3012, a male to female ratio indicator 3013, a follow button 3014, an error flag 3015, and a photo display area 3009. The mapping link 3011 may link the active user to a mapping function of the system that allows the active user to open the location of the venue in a separate mapping software application on the mobile device 120. The attractiveness or chili pepper rating 3012 can indicate the attractiveness or chili pepper rating for the venue shown in the icon area 3002. The male to female ratio indicator 3013 may identify the male to female ratio of the members attending or planning to attend the event listed in the event name 3004. The follow button 3014 can be selected by the active user to request routine updates for events at the venue being displayed in the icon area 3002. The error flag 3015 may allow the active user to notify the system or a system administrator of false information or errors displayed on the place or event profile 300. The photo display area 3009 may display any photos that have been posted by the active user through the system at the selected venue.

FIG. 4 illustrates an exemplary embodiment of a people display 400. The people display 400. The people display 400 may include the top and bottom navigation legends 1000, 1014 shown and described with regard to FIG. 2. The people display 400 may also include a people legend 1200 that filters a list of remote users in a manner defined by the active user. The active user can sort the list of remote users by gender, proximity to current location or a selected location, highest chili pepper score/attractiveness rating, remote users' proximity to a location, or other filter parameters in the people legend 1200. In one embodiment, the remote users that fit the filter parameters can be displayed in a user display area 1201 ordered by closeness to the location of the active user.

The user display area 1201 may include a remote user information section 1202 and a next remote user selector 1207. The remote user information section 1202 may include a username field 1203, a profile picture field 1204, a follow selector 1205, and an attractiveness rating 1206 for the remote user fitting the filter parameters, if any, in the people legend 1200. The username field 1203 and profile picture field 1204 display the username and the profile picture for the remote user, and may include a link to the user profile for the remote user. The attractiveness rating 1206 provides an attractiveness or chili pepper score for the displayed remote user. The active user can select the follow selector 1205 to receive notifications of certain activities of the followed remote user. The chili pepper button 1206 can allow the active user to add to an attractiveness rating or chili pepper score for the displayed remote user. When a user touches the chili pepper button of another user the receiving user's chili pepper score increases by one and the increase is seen system wide. The active user can select the next remote user selector 1207 to scroll through the remote users that fit the filter parameters in the people legend 1200.

FIG. 5 illustrates an exemplary embodiment of a spots/places display 500. The spots/places display 500 may include the top and bottom navigation legends 1000, 1014 shown and described with regard to FIG. 2. Additionally, the spots/places display 500 may include a date selection 1100, a refine filter 1101, a place type filter 1102, a search field 1103 and a search results area 1125. The date selection 1100 can display a dropdown menu or open a calendar that allows the active user to select dates for or from search results displayed in the search results area 1125. The refine filter 1101 may display a dropdown menu that lists items that the active user can use to filter the list of venues/events displayed in the search results area 1125. The place type 1102 may display several options for different types of places (for example, bars, pool halls, clubs, restaurants, etc.) that can be selected by the active user to filter the list of venues/events displayed in the search results area 1125.

The active user can enter key words or other search criteria in the search field 1103 to identify desired venues. Venues or places that meet the search criteria in the search field 1103, date selection 1100, refine filter 1101 and place type filter 1102 can be shown in the search results area 1125. The search results area 1125 displays venue information for venues found in the search. In some embodiments, the search results area 1125 may only show a venue or venues that meet the search criteria. In other embodiments, the search results area 1125 may display all venues available on the system in order of how well the venue meets the search criteria. Other embodiments may have other guidelines for the venues in the search results area 1125. The active user may scroll through the venues displayed in the search results area 1125 as desired.

For each venue displayed, the search results area 1125 can include a venue name 1104, a venue attractiveness or chili pepper score 1105, a male to female ratio 1106, a venue logo 1107, an event name 1126, a distance to the venue 1127, and a scrollable photo area 1108. For each venue displayed, the search results area 1125 can also include a special event details area 1109, a remote user attendance list 1110, a going to event selection 1111, and a promotions button 1112. The active user can select the going to event selection 1111 to indicate intentions to attend the event or venue currently displayed. The promotions button 1112 may display the number of drinks or other promotions that the active user has available at the event or venue currently displayed. Selecting the promotions button 1112 may link the active user to a system promotions display that more specifically lists the types of promotions available to the active user at the currently displayed event or venue.

The search results area 1125 may also include an entertainment area 1113, a general admission area 1114, a guest list or VIP list 1115 and a description box 1116. The entertainment area 1113 may display what type of entertainment the venue is offering during the currently displayed event. This information may be stored and generated from the system database 150. The general admission area 1114 may display the general admission of a venue if available. The guest list or VIP list 1115 may be displayed if the venue is offering guest lists or a VIP pass. A description box 1116 may be displayed that shows the active user additional benefits for being on the guest list or having a VIP pass. The description box 1116 may also display admission price and the number of guests the active user can bring with them if they are on the guest list or VIP list.

The search results area 1125 may also include an offer duration field 1117, a check-in time field 1118, a check-in instructions field 1119, a guest list name field 1120, first and second input fields 1121, 1123, a cancel button 1122 and a save button 1124. The offer duration field 1117 may display when an offer ends. For example, the offer duration field 1117 may display an end date and time for a particular offer for the currently displayed event. The check-in time field 1118 may indicate to the active user when they can check-in to the venue to receive the offer displayed in the offer duration 1117. The check-in instructions field 1119 may provide instructions to the active user identifying how the venue would like the active user to check-in once they arrive. The guest list name field 1120 may show the active user what name is on the guest list or VIP pass that allows the active user to check-in. The first and second input fields 1121, 1123 may be used by the active user to indicate the number of guests that the active user anticipates bringing to the event. As one example embodiment, the first input field 1121 may indicate the number of male guests and the second input field 1123 may indicate the number of female guests the active user anticipates bringing to the event. The cancel button 1122 may enable the active user to close an offer drop down and not save any changes made thereto. The save button 1124 may enable the active user to save selections made on the spots/places display 500 and close the dropdown.

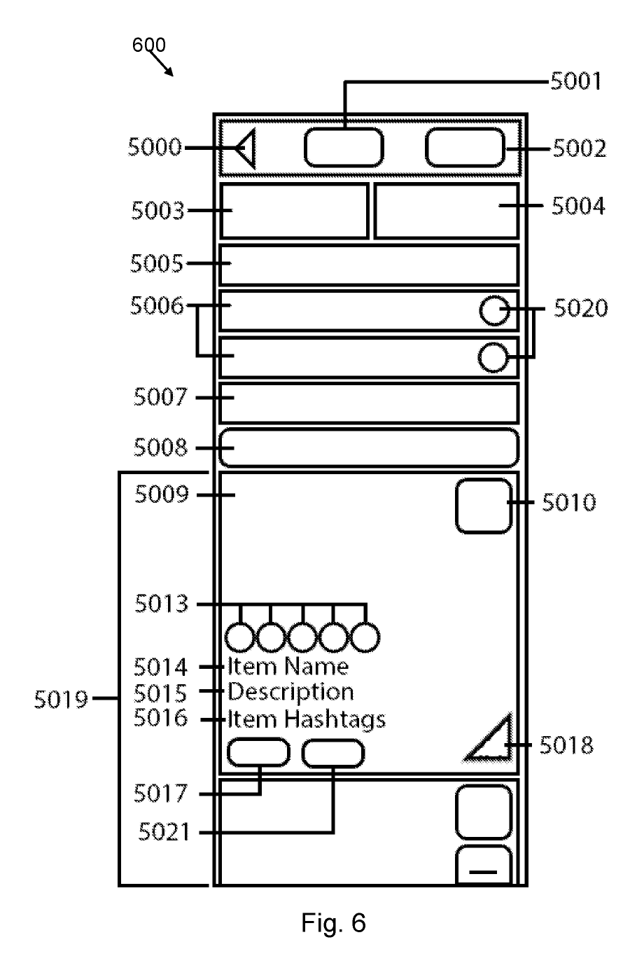

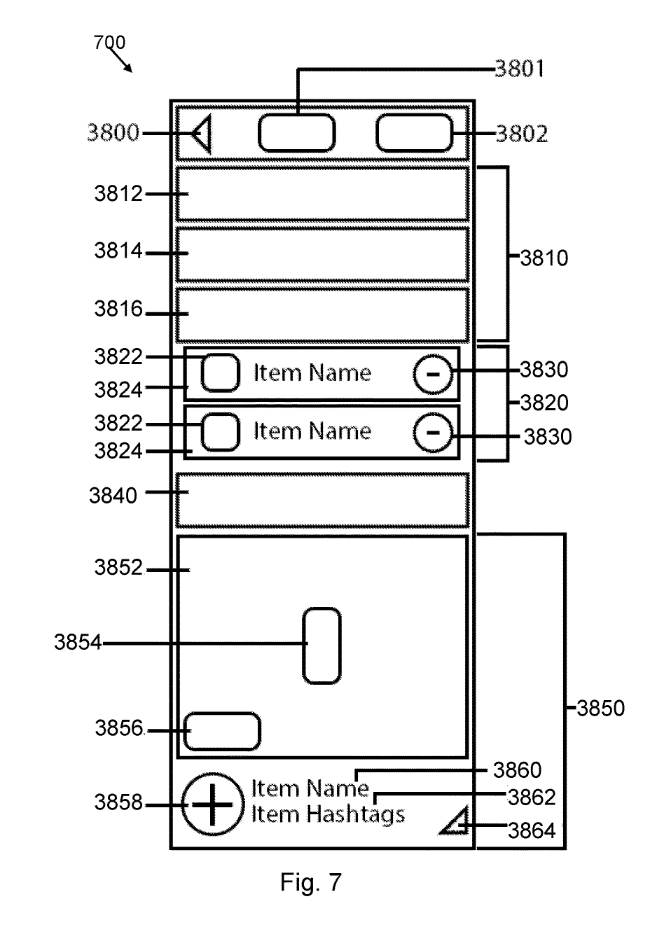

FIG. 6 illustrates an exemplary embodiment of a venue menu display 600 that enables an active user to select and purchase items from the venue's menu. The venue menu display 600 may include a navigation section with a back button 5000, a my venue items tab 5001 that links the user to a my venue items display (see FIG. 7), and a venue menu tab 5002 that links the user to the venue menu display 600. The back button 5000 can take the active user back to the spots/places display 500.

The venue menu display 600 may include a venue menu items list 5019, a star filter 5003, a popularity filter 5004, a purchase now button 5005, a selected items list 5006, a total cost area 5007, and a search field 5008.

The venue menu items list 5019 may include a scrollable list of menu items that the venue offers users the ability to purchase through the system. The venue menu items list 5019 may include one or more of the following fields as well as others related to the menu items. A menu item image 5009 may show one or more images of the item. A star rating 5013 may show a star rating (for example, one to five stars) for the menu item as rated by other users. An item name field 5014 and an item description field 5015 may provide a name and short description for the menu item. A detailed description link 5018 may link the active user to a display where a more detailed description of the menu item is given. An item hashtags field 5016 may show item hashtags that have been set by the venue in order to identify categories for menu item. The item hashtags could include, for example, #dessert, #Mexican, #gluten-free, #non-alcoholic, etc. An item price button 5017 may indicate the purchase price for the menu item. A system currency or point price button 5021 may indicate a price for the menu item in points or currency issued by the system, for example, it may show an amount of “hoot loot” it would cost a user to purchase the menu item if the active user wanted to use points instead of their credit card. A quantity field 5010 can be used by the active user to indicate how many of that menu item the active user wants to purchase.

When selected by the active user, the star filter 5003 arranges the list of menu items in the venue menu items list 5019 based on which menu items have the highest numerical average star rating. When selected by the active user, the popularity filter 5004 arranges the list of venue menu items in the venue menu items list 5019 based on popularity, where the menu items purchased most frequently come up first. The search field 5008 can enable the active user to filter or order the items in the venue menu items list 5019 by words or parts of words in the item name, description, hashtags, etc. The selected menu items list 5006 may list the menu items the active user has selected from the venue menu items list 5019. Each item in the selected menu items list 5006 may include a delete item button 5020 that the active user can select to remove that menu item from the selected menu items list 5006. The total cost area 5007 may indicate the total cost to purchase all of the items in the selected menu items list 5006 using money and system currency as specified by the user. The purchase now button 5005 enables the active user to purchase the items they have selected in the selected menu items list 5006.

The active user can select the item price button 5017 to move the associated menu item 5009 into their selected items list 5006 for payment using money (e.g., a credit card or other payment account). The active user can select the system currency button 5021 to move the associated menu item 5009 into their selected items list 5006 for payment using system currency. When the active user selects the item price button 5017 or system currency button 5021, the quantity of the item indicated in the quantity field 5010 is moved to the selected items list 5006, and the cost in money or system currency is added to the total cost area 5007. The total cost area 5007 can show the current total the user has selected to spend in money and in system currency.

When the active user purchases the selected items in the selected menu items list 5006 using the purchase now button 5005, the amount of money in the total cost area 5007 will be charged to a credit card or other payment account of the active user that is known to the system, and the amount of system currency in the total cost area 5007 will be deducted from the active user's system currency account. When the active user purchases the selected items, vouchers for the selected items are moved to a my venue items list stored in the system for the active user.

FIG. 7 illustrates an exemplary embodiment of a my venue items display 700 where the active user can request delivery of items from their my venue items list which can include items purchased through the venue menu display 600 and promotional vouchers provided by the system, the various venues or other sources. The my venue items display 700 may include a navigation section with a back button 3800, a my venue menu tab 3801 that links the user to a my venue items display, and a venue menu tab 3802 that links the user to the venue menu display 600. The back button 3800 can return the active user to the spots/places display 500.

The my venue items list 700 may include an item voucher list 3850, a redemption list 3820 of item vouchers selected for redemption, and a redemption method area 3810 where the active user may select the method in which they would like to redeem the selected vouchers.

Each voucher in the item voucher list 3850 may include a voucher image 3852, a redeemable venues list 3805, an item name 3860, item hashtags 3862, a details button 3864, a vouchers remaining area 3856 and a voucher selection button 3858. The voucher image 3852 can provide an image of the voucher and/or of the items for which the voucher is redeemable. The redeemable venues list 3805 shows the active user the venues where the voucher is honored. The venue can supply the item hashtags 3862 to make their menu items more easily searchable by an active user. The details button 3864 can open a screen that displays additional details for the voucher/item, the details may include what the item actually is, or how the voucher can be redeemed, or what the voucher can be redeemed for, etc. The vouchers remaining area 3856 indicates to the active user how many of the voucher or item coupon they have been given by the venue and how many are still available to be redeemed. The voucher selection button 3858 allows the active user to add a displayed voucher in the item voucher list 3850 to their redemption list 3820. The my venue items list 700 may also include a search bar 3840 for the active user to search for vouchers in their item vouchers list 3850 by all or portions of name, hashtags, item description, etc. Each voucher or item in the redemption list 3820 may include an item image 3822, an item name 3824, and a delete button 3830 to remove that item from the redemption list 3820.

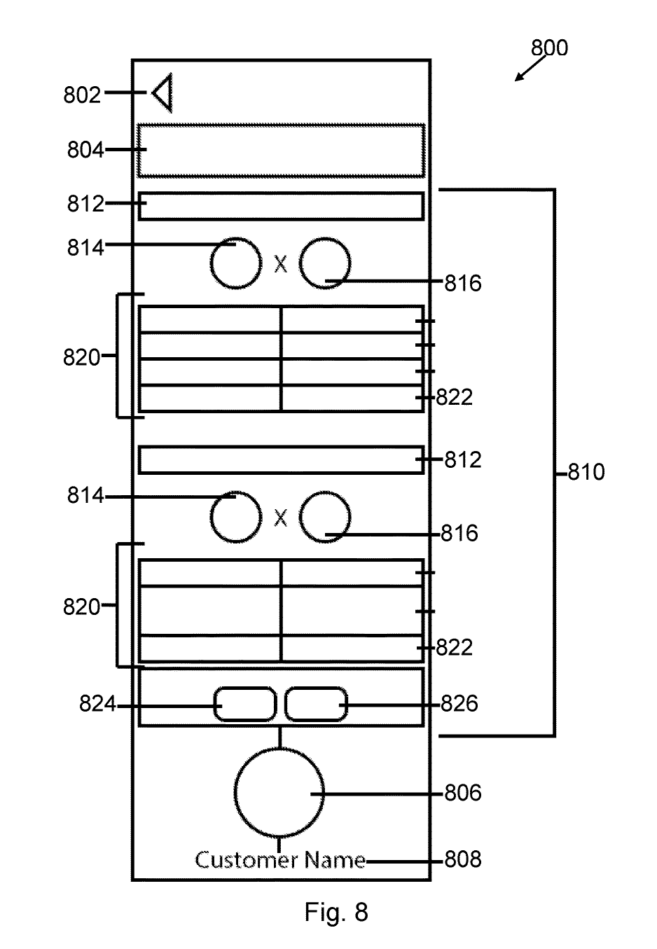

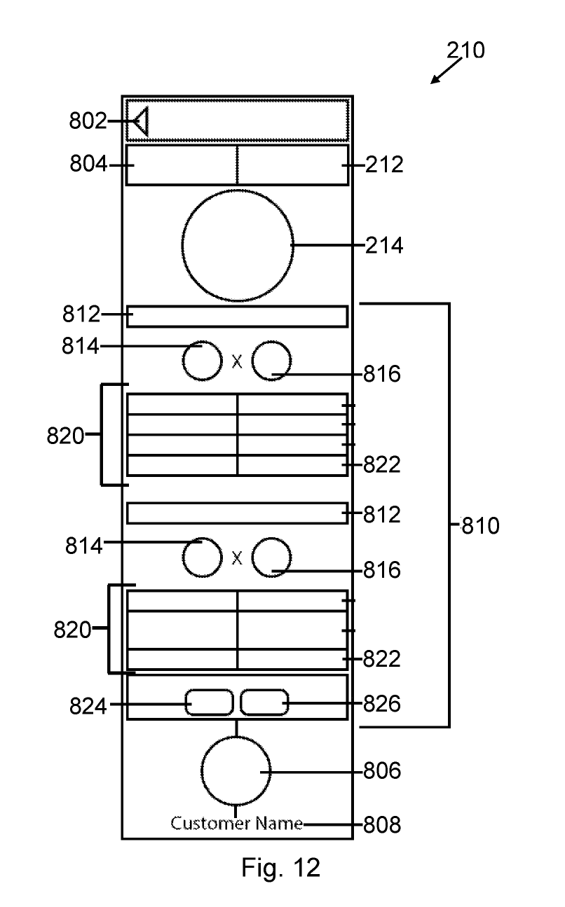

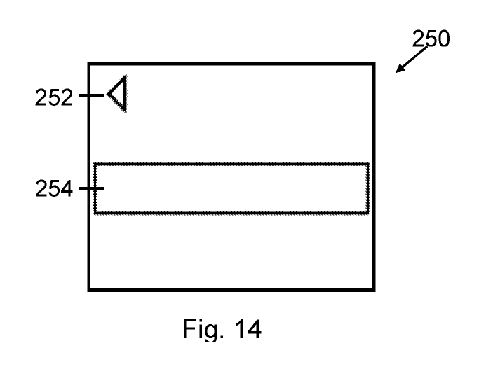

Once the desired vouchers are added to the redemption list 3820, the active user can choose one of the options in the redemption method area 3810. The options in the redemption method area 3810 may include a server/bartender button 3812, a pick-up button 3814 or a bring-to-me button 3816. The active user can select the server/bartender button 3812 to submit the vouchers for redemption from a server or bartender (see FIG. 8). The active user can select the pick-up button 3814 to submit the vouchers through the system for redemption and pick-up (see FIG. 12). The active user can select the bring-to-me button 3816 to submit the vouchers through the system for redemption and to be brought to the active user when ready (see FIG. 14).

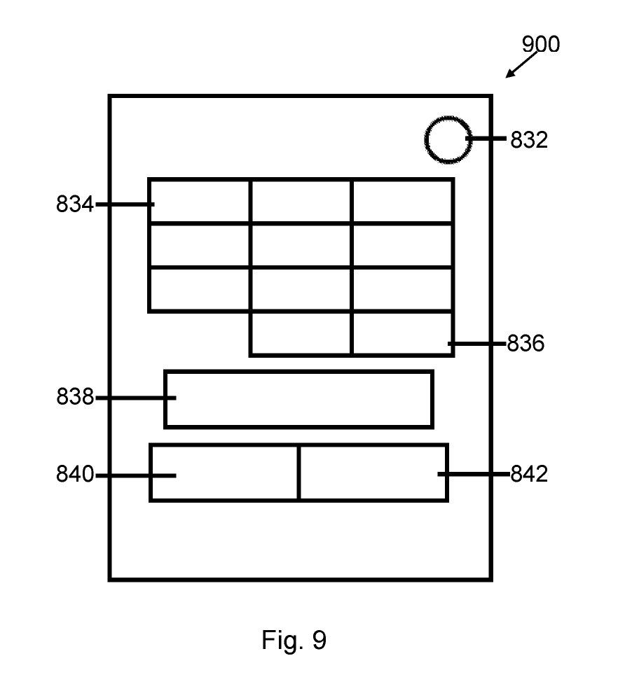

FIG. 8 illustrates an exemplary embodiment of a show order to server/bartender display 800. The show order to server/bartender display 800 may include a back button 802, a prepare order button 804, an item list 810, a user photo area 806 and a user name field 808. The back button 802 can bring the active user back to the my venue items display 700. The prepare order button 804 can link to a show order-server id display 830 (see FIG. 9). The item list 810 may include a list of the specific items that the active user wants to order. The user photo area 806 may include a photo of the active user. The user name field 808 may include the name of the active user. Each item in the item list 810 may include an item name 812, an item image 814, an item quantity 815, a selected options list 820 that shows item options chosen by the active user, and an item price 822 which can include taxes or other charges. The show order to server/bartender display 800 may also include a subtotal 824 and a total price with taxes 826. The selected options list 820 can differ based on the type of item/voucher, for example a burger voucher may have an options list that includes: medium-rare, lettuce, tomato, cheddar cheese; while a free drink voucher may have an options list that includes: martini, extra olives; or white wine, chardonnay.

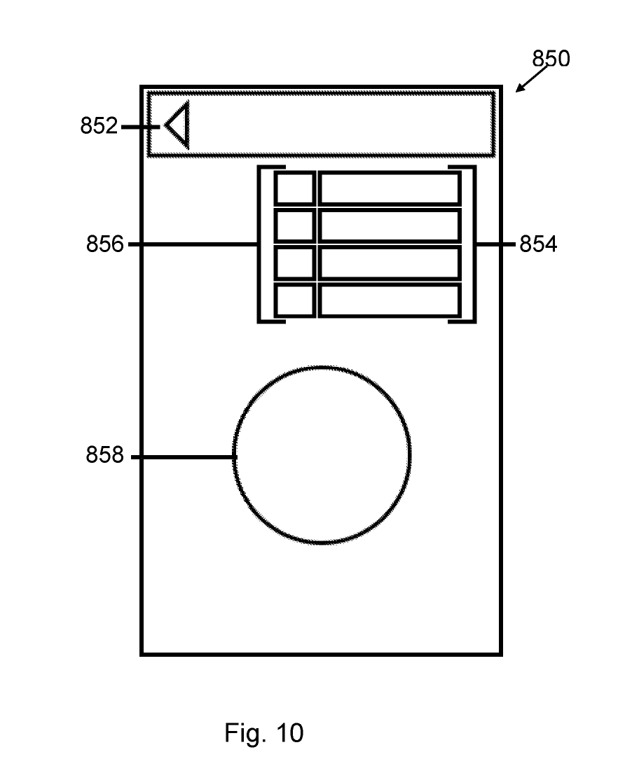

FIG. 9 illustrates an exemplary embodiment of a show order-server id display 830 that tells the system which bartender or server accepted and is responsible for this order from the active user. The show order-server id display 830 may include a close button 832, a key pad 834, a back button 836, a server id field 838, an accept button 840 and a decline button 842. The close button 832 can bring the active user back to the show order to server/bartender display 800. The bartender/server can use the key pad 834 to enter their personal identification number into the server id field 838. This server id field 838 may also display the numbers entered when the active user uses the key pad 834. The server/bartender can select the accept button 840 to submit the order, and bring the active user to the show order-status display 850 (see FIG. 10). The server/bartender can select the decline button 842 to decline the order, and bring the active user back to the show order to server/bartender display 800.

FIG. 10 illustrates an exemplary embodiment of a show order-status display 850 that lets the active user track the stages of receiving their ordered items. The show order-status display 850 may include a back button 852, order processing steps 854, processing step status flags 856 and a confirm order received button 858. The back button 852 can bring the active user back to the my venue items display 700. The order processing steps 854 can list one or more steps that the venue takes in processing the active user's order. Each of the order processing steps 854 can have a processing step status flag 856 that changes as the processing step progresses. The order processing steps 854 may include, for example, In Queue, Being Prepared, Being Delivered, etc. The processing step status flags 856 can be, for example, icons or animated icons letting the active user know which step is being performed and/or the progress of that step. The confirm order received button 858 can be selected by the active user to confirm to the venue that the active user has received the order. The confirm order received button 858 may also bring the active user back to the show order-tip display 860.

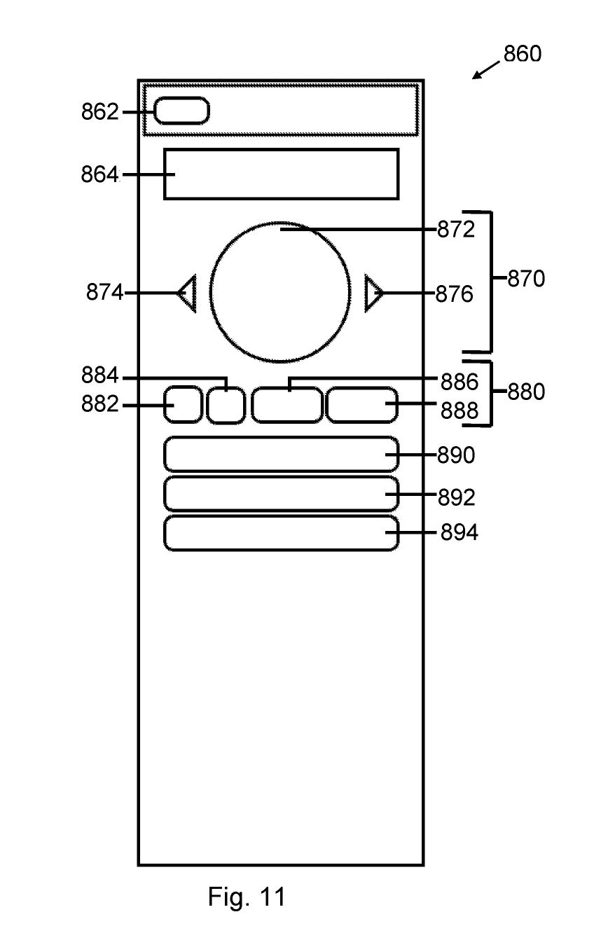

FIG. 11 illustrates an exemplary embodiment of a show order-tip display 860 that enables the active user to tip their bartender/server using the system. The show order-tip display 860 may include a close button 862, a server list area 870, a server search box 864, a tip amount area 880, a credit tip button 890, a system currency or points tip button 892, and a cash tip button 894. The close button 862 can bring the active user back to the my venue items display 700. The server list area 870 may include a list of all the servers at the venue to enable the active user to select which server or servers they would like to leave a tip or gratuity for using the system. The server list area 870 may include a server photo area 872 showing a currently selected server, a back selector 874 to change the currently selected server by scrolling backwards through the server list, and a next selector 876 to change the currently selected server by scrolling forwards through the server list. The active user can start entering a server name in the server search box 864 to filter the server list and find a desired server for display in the server photo area 872. The tip amount area 880 can include a percentage tip field 886, a decrease percentage selector 882, an increase percentage selector 884 and a total tip field 888. The active user can use the decrease and increase percentage selectors 882, 884 to change the percentage tip field 886, and the total tip field 888 will display the order total cost multiplied by the value currently in the percentage tip field 886. The active user can select the credit tip button 890 to charge their credit card or payment account for the amount in the total tip field 888 and send that amount as a tip for the server currently selected in the server list area 870. The active user can select the points tip button 892 to use their system currency or reward points for the amount in the total tip field 888 and send that amount as a tip for the server currently selected in the server list area 870. The active user can select the cash tip button 894 to indicate that they will leave a cash tip, and the system does not need to remind the active user that they have not yet tipped their server/bartender. After selecting one of the pay tip buttons 890, 892, 894, the active user can be returned to the my venue items display 700.

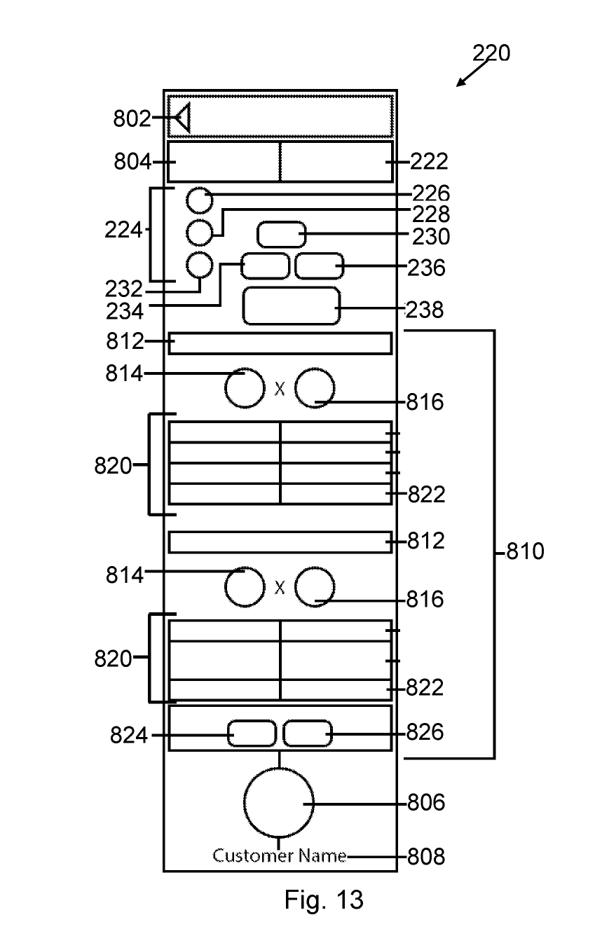

FIG. 12 illustrates an exemplary embodiment of a pick-up order display 210 that the active user can use to indicate that they will pick-up the order when it is ready. The pick-up order display 210 can include many of the same fields as the show order to server/bartender display 800 (FIG. 8), for example the back button 802, the prepare order button 804, the item list 810, the user photo area 806 and the user name field 808. The pick-up order display 210 may also include a later pick-up button 212 and a submit order button 214. The active user can select the later pick-up button 212 to go to a submit order for later pickup display (see FIG. 13) where the active user can set a time that they would like to pick up the order. The active user can select the submit order button 214 to send the order for the items in the item list 810 to the venue's order queue so the venue can begin preparing the order.

FIG. 13 illustrates an exemplary embodiment of a submit order for later pickup display 220 that enables the active user to submit an order for pick-up at a later time. The submit order for later pickup display 220 can include many of the same fields as the show order to server/bartender display 800 and the pick-up order display 210, for example the back button 802, the prepare order button 804, the item list 810, the user photo area 806 and the user name field 808. The submit order for later pickup display 220 may also include a pick-up order when ready button 222 that links back to the pick-up order display 210. The submit order for later pickup display 220 may also include a pick-up time selection area 224 and a submit order button 238. The active user can select the pick-up time using the controls in the pick-up time selection area 224 which can include a one-touch trigger selection 226, a user-selected time duration selection 228, and a user-selected pick-up time selection 232.

The one-touch trigger 226 is associated with a preset time duration that can be set by the venue based on workload and items in the item list 810, for example the preset time can be 5 minutes, 30 minutes, etc. The active user can select the one touch trigger 226 to indicate they would like to pick the items in the item list 810 in the preset time. The user selected time duration selection 228 is associated with a user-specified time duration 230 specified by the active user. The active user can select the user-selected time duration selection 228 to indicate that they would like to pick the items in the item list 810 in the time specified in the user-specified time duration 230. The user can specify a time or time and day in an hour field 234 and a minute field 236. The active user can select the user-selected pick-up time selection 232 to indicate that they would like to pick the items in the purchase list 810 at the time of day specified in the hour field 234 and minute field 236. Only one of the one-touch trigger selection 226, the user-selected time duration selection 228, and the user-selected pick-up time selection 232 can be selected at a time. When the active user selects the submit order button 238, the order for the items in the item list 810 is submitted to the venue for pickup at a time specified by whichever of the one-touch trigger selection 226, the user-selected time duration selection 228, and the user-selected pick-up time selection 232 is currently selected.

FIG. 14 illustrates an exemplary embodiment of a bring-to-me-table number display 250 that enables the active user to specify where to deliver the items in the selected item list 3820. The bring-to-me-table number display 250 may include a back button 252 that brings the active user back to the my venue items list 700 (FIG. 7), and a table number field 254 where the active user can enter their location in the venue or a table number of their table in the venue.

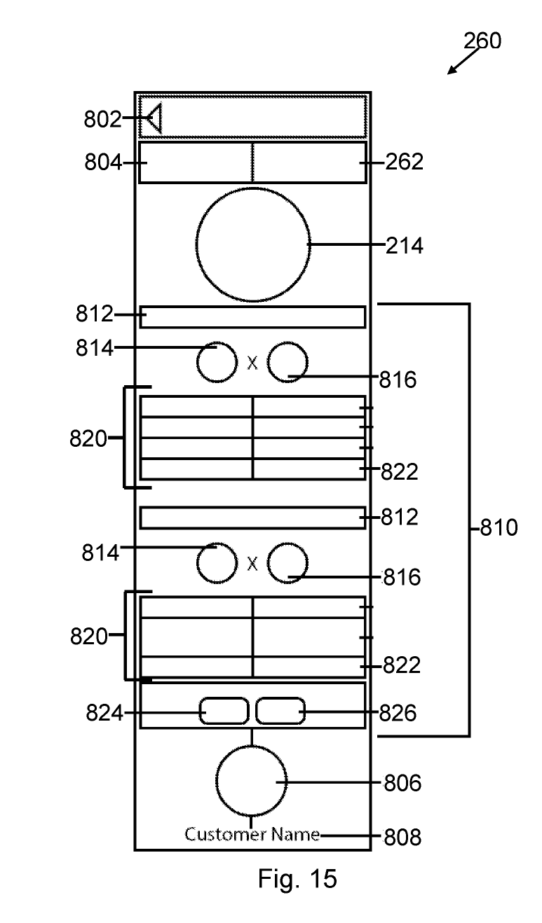

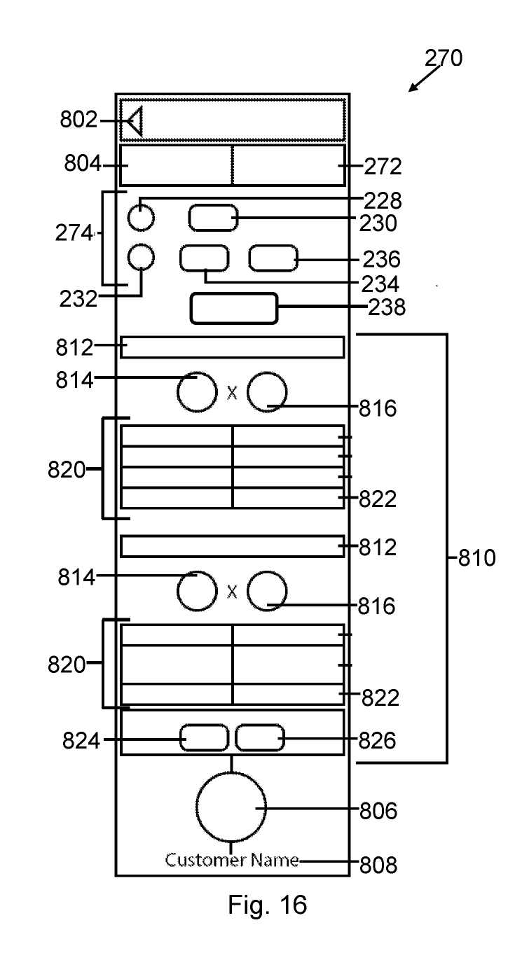

FIG. 15 is an exemplary diagram of the bring-to-me display 260 that the active user can use to indicate that they want the order brought to them at the location specified on the bring-to-me-table number display 250 when the order is ready. The bring-to-me display 260 can include many of the same fields as the show order to server/bartender display 800 (FIG. 8) and the pick-up order display 210 (FIG. 12), for example the back button 802, the prepare order button 804, the item list 810, the user photo area 806 and the user name field 808. The bring-to-me display 260 may also include a bring-me-later button 262 and a submit order button 214. The active user can select the bring-me-later button 262 to go to a bring-me-later display (see FIG. 16) where the active user can set a time that they would like the order brought to them. The active user can select the submit order button 214 to send the order for the items in the item list 810 to the venue's order queue so the venue can begin preparing the order. The order status, progress displays and/or order ready notifications for different ordering methods can share the same basic order status/progress screen(s) while orders are being possessed, for example see FIG. 10.

FIG. 16 illustrates an exemplary embodiment of a bring-me-later display 270 that enables the active user to submit an order to be brought to them at a later time. The bring-me-later display 270 can include many of the same fields as the submit order for later pickup display 220 (FIG. 13), for example the back button 802, the prepare order button 804, the item list 810, the user photo area 806, the user name field 808, and the submit order button 238. The bring-me-later display 270 may also include a bring-to-me when ready button 272 that links back to the bring-to-me display 260. The bring-me-later display 270 may also include a delivery time selection area 274 that includes control the active user can use to specify an order delivery time. The delivery time selection area 274 can include any or all of the time selection methods described with reference to FIG. 13, the one-touch trigger selection 226, the user-selected time duration selection 228, and the user-selected pick-up time selection 232 or other delivery time selection methods. FIG. 16 shows an embodiment with just the user-selected time duration selection 228 and the user-selected pick-up time selection 232 methods. When the active user selects the submit order button 238, the order for the items in the item list 810 is submitted to the venue for delivery at the location specified in the bring-to-me-table number display 250 (FIG. 14) at the time specified in the delivery time selection area 274.

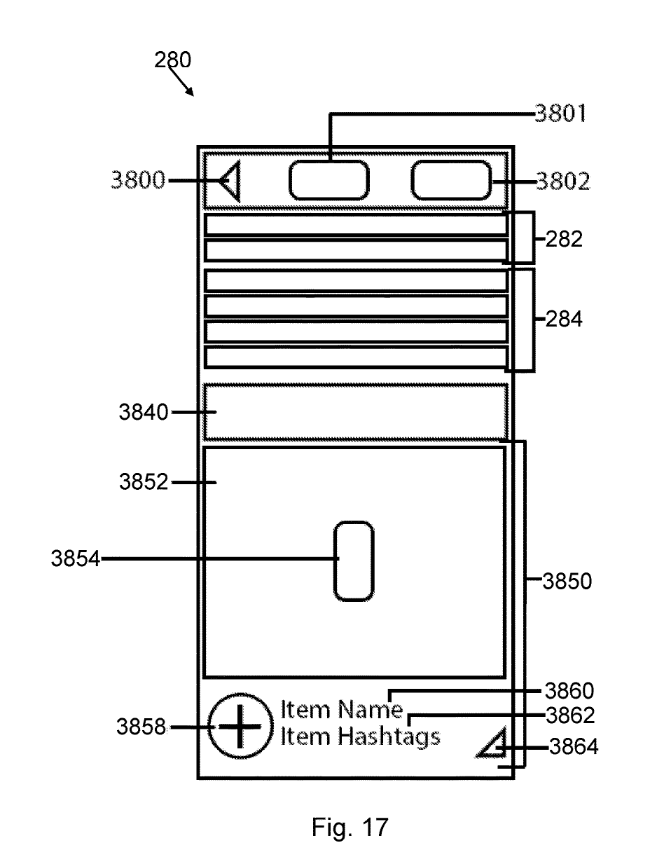

FIG. 17 illustrates an exemplary embodiment of a status and alerts display 280. The status and alerts display 280 may be a part of the my venue items display 700 (FIG. 7) or can be a separate display. The status and alerts display 280 is shown having many of the same fields as the my venue items display 700, including the back button 3800, the my venue menu tab 3801, the venue menu tab 3802, the search bar 3840, the item voucher list 3850 and other fields described above. The status and alerts display 280 may also include an alerts area 282 and a status area 284. The alerts area 282 can let the active user know if there is an order conflict, error, or something that needs the active user's attention. The status area 284 can let the active user know the status of an order they have requested to be prepared, for example, In Queue, Ready for Pick-up, Being Prepared, Being Delivered, etc.

FIG. 18 illustrates an exemplary embodiment of a settings display 900. The settings display 900 may include a cancel button 1700 that the active user may select to disregard any changes made, and a done/save button 1701 that allows the active user to exit the settings display 900 and save any changes made therein. The settings display 900 may also include a profile settings area 1731, a search settings area 1732, a notifications settings area 1730, a privacy settings area 1729, and an account information settings area 1728.

The profile settings area 1731 may include a username field 1702, a profile picture 1703, a public username field 1704, a user website field 1705 and a user biography field 1706. The active user can enter a username in the username field 1702 to be used by the system. In one embodiment, the entry in the username field 1702 may be used to identify the active user on guest lists or reservations. The username field 1702 may also remain private with respect to other remote users and only remote users that are following the active user can see the active user's username. The active user can upload a photo for the profile picture 1703 to be used as the active user's profile picture in the system. The active user can enter a public username in the public username field 1704 to be visible by other users even if they are not following the active user. The user website field 1705 may allow the active user to set a website to be displayed with the active user's profile. The active user may have a user biography field 1706 that allows the user to specify a user biography accessible through the system.

The search settings area 1732 may include an active GPS enabler 1707, a distance selector 1708 and a target age group selector 1709. The active GPS enabler 1707 can allow the active user to choose whether they want the system to use the GPS sensor 162 of the active user's mobile device 120 when determining a user location. In one embodiment, the user location may be used to determine distances of the active user from a particular venue or other users. In another embodiment, there may be a drop down menu that allows the active user to select “Use my current location” or to select a city from a list. The active user can use the distance selector 1708 to set a radial distance that is determined relative to the user location or selected city within which the system will perform searches. The distance selector 1708 may be a slider control to select a desired radial distance between some preset nearest distance and some preset furthest distance. The active user can use the target age group selector 1709 to specify an age group to be used by the system when performing searches. The target age group selector 1709 may include a first slider to select a lower age limit and a second slider to select an upper age limit.

The notifications settings area 1730 may include a plurality of on/off toggles that the active users can use to specify what events they want the system to notify them about. For example, the notifications settings area 1730 can include a new message notification toggle 1710, a match notification toggle 1711, a like notification toggle 1712, and a chili pepper notification toggle 1713. The new message notification toggle 1710 can allow the active user to select whether they would like to get system notifications when they receive a new message. The match notification toggle 1711 can allow the active user to select whether they would like to get system notifications when a remote user indicates interest in the active user. The like notification toggle 1712 can allow the active user to select whether they would like to get system notifications when the system receives a “like” indication for the active user from a remote user. The chili pepper notification toggle 1713 can allow the active user to select whether they would like to get system notifications when they receive chili pepper notifications from a remote user.

The privacy settings area 1729 may include a privacy toggle 1714, a description field 1715, an automatic check-in toggle 1716, a private check-in toggle 1717, and a check-in description box 1718. The privacy toggle 1714 can allow the active user to activate and deactivate a private profile option. When the privacy toggle 1714 is in the ON position, only people the active user approves can see the active user's photos in the system. The description field 1715 may describe to the active user the effects of changing the privacy toggle 1714. The automatic check-in toggle 1716 can allow the active user to activate and deactivate the automatic check-in feature. More specifically, if the automatic check-in feature is ON, the system can automatically check the active user into a venue when the GPS sensor 162 or the Wi-Fi location sensor 164 of the active user's mobile device 120 indicates to the system that the active user is within a given range of the venue. The private check-in toggle 1717 can allow the active user to select whether to make automatic check-ins private. More specifically, when the private check-in toggle 1717 indicates “PRIVATE” the system app may let remote users know that new user has arrived, but not the username or identity of the new user. The check-in description box 1718 can explain the effects of the selection made in the private check-in toggle 1717 to the active user.

The account information settings area 1728 may include a payment button 1719, a personalized invite option 1720, a terms and conditions button 1721, a privacy policy button 1722 and a user feedback link 1723. The payment button 1719 can link the active user to a display on the system that enables the active user to input payment information to be used when purchasing items through the system. The personalized invite option 1720 can allow the active user to send personalized invites to other people inviting them to download the target marketing and tracking system. The active user may get rewards if one of the invitees of the active user downloads the system to their mobile device within seven days of the invitation. The terms and conditions button 1721 can link the active user to legal terms of use for the system. The privacy policy button 1722 can link the active user to the privacy policy for the system. The user feedback link 1723 can display a feedback pop-up text box or field that allows the active user to provide suggestions or feedback to developers and/or managers of the system.

In addition to the areas described above, the settings display 900 may include a logout button 1724, an applications management button 1725, a promoter's portal 1726, and a delete profile button 1727. The logout button 1724 can enable the active user to log out of the system. The applications management button 1725 can link the active user to a location to manage application options for the system. The promoter's portal 1726 can link the active user to a system display or section for promoters. The delete profile button 1727 can enable the active user to permanently delete the active user's account in the system and delete all of the photos and posts associated therewith.

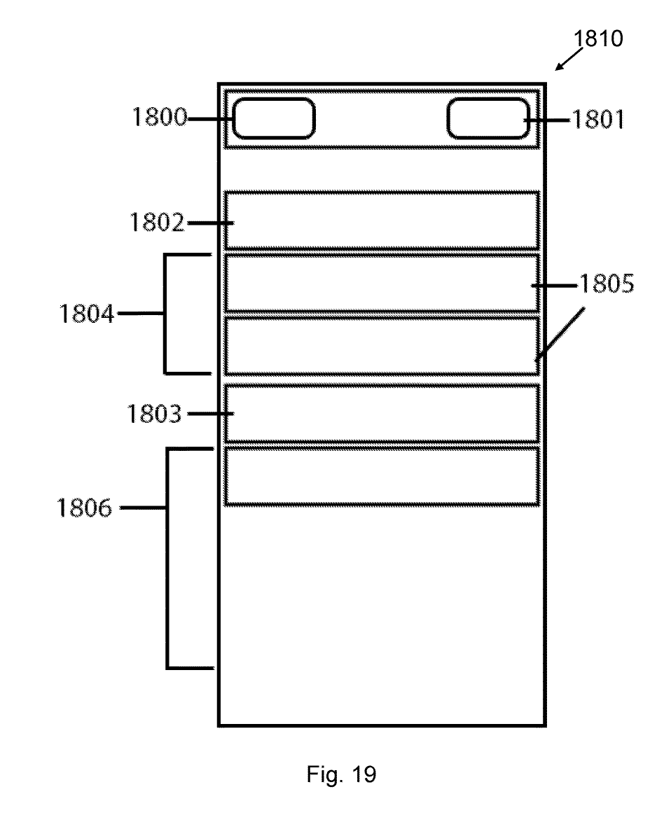

FIG. 19 illustrates an exemplary embodiment of a spot legend display 1810 that may include a cancel button 1800, a done button 1801, a venue management button 1802, and an unverified venue button 1803. The verified accounts area 1804 may include venue links 1805. The cancel button 1800 can enable the active user to exit out of the spot legend display 1810 without saving any changes. The done button 1801 can enable the active user to save the changes made on the spot legend display 1810 and return the active user to the previous display. The venue management button 1802 can enable the active user to manage an associated venue and to link the associated venue to an external location mapping account. In one non-limiting example, the venue management button 1802 may allow the active user to link to an external location mapping account to identify the current location of the active user. The current location may then be saved as the venue location for the associated venue. After the venue management button 1802 is linked to an external location mapping account, a profile for the associated venue may be created utilizing the linked account information. In addition, an external location mapping account properly linked to the system may create a verified system account for the associated venue. Alternatively, the unverified venue button 1803 can enable the active user to create an unverified venue. In this embodiment, the verified venue accounts can be listed in a verified accounts area 1804, and the unverified accounts can be listed in an unverified accounts area 1806. The verified accounts area 1804 may include venue links 1805 that link to areas where the active user can manage an associated venue wherein each venue link 1805 is associated with a different venue.

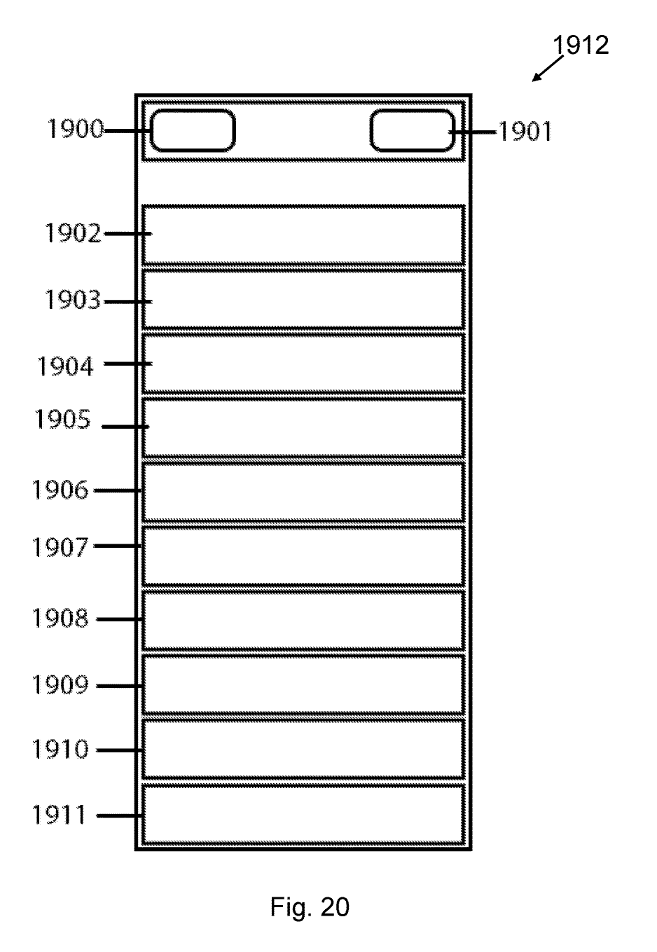

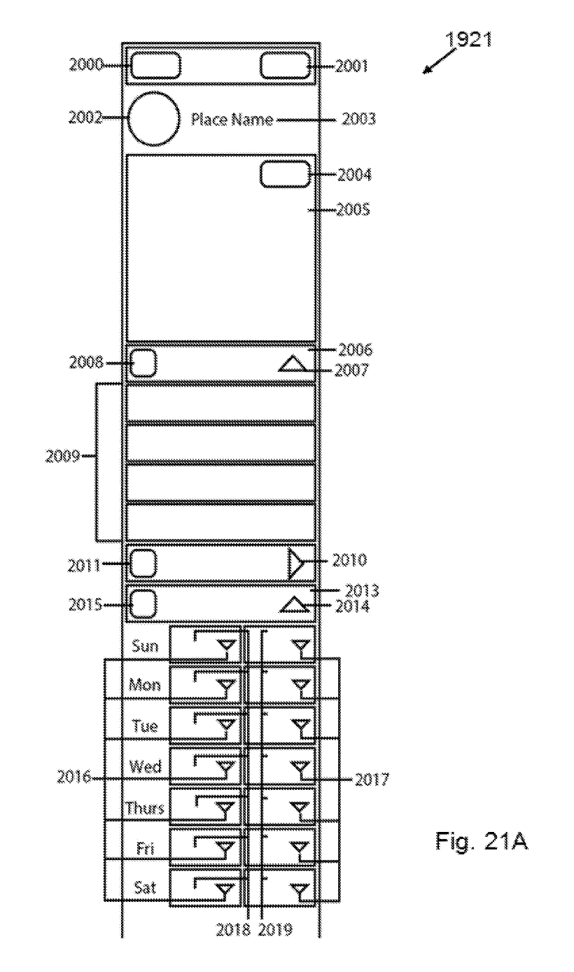

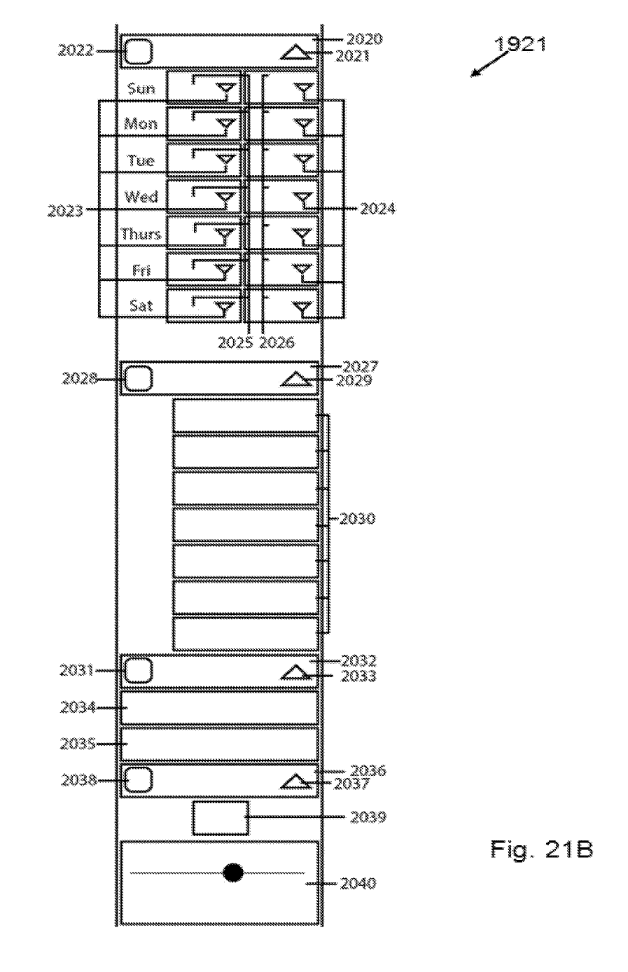

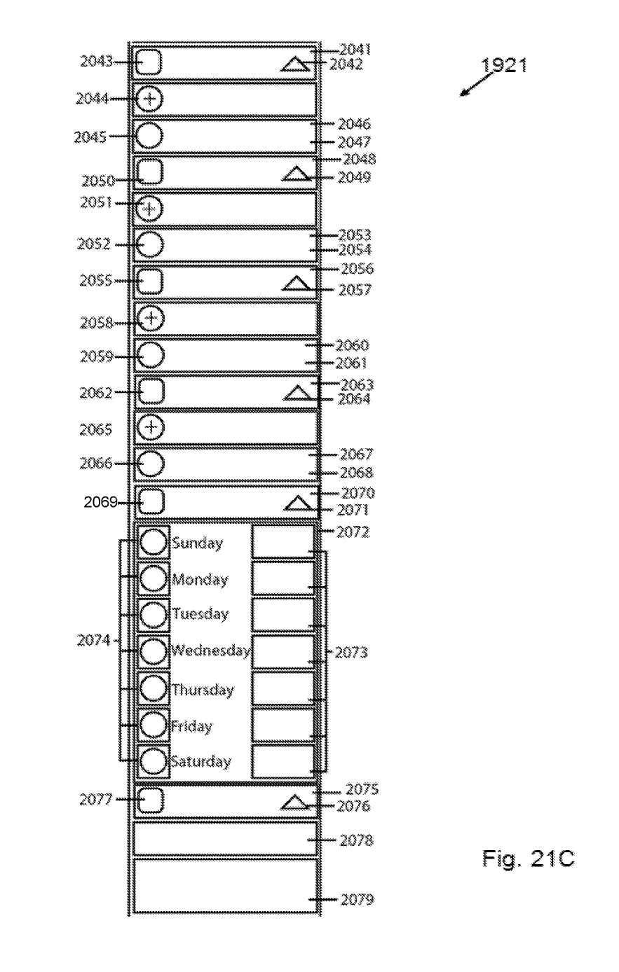

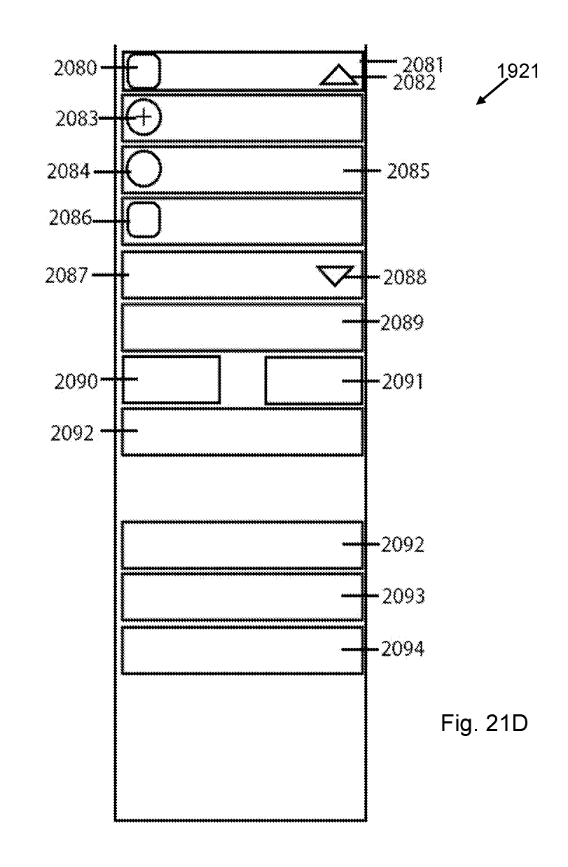

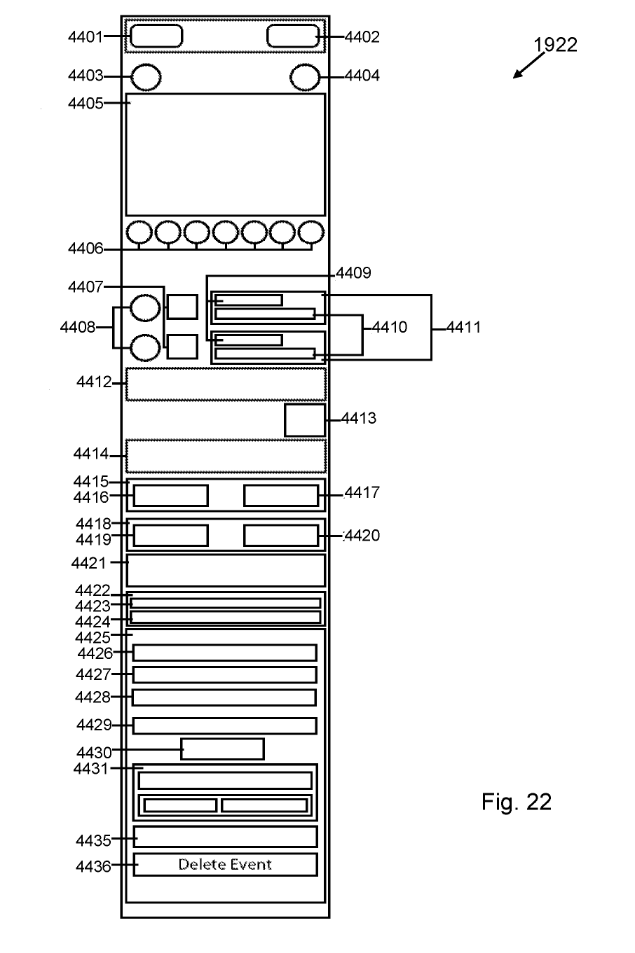

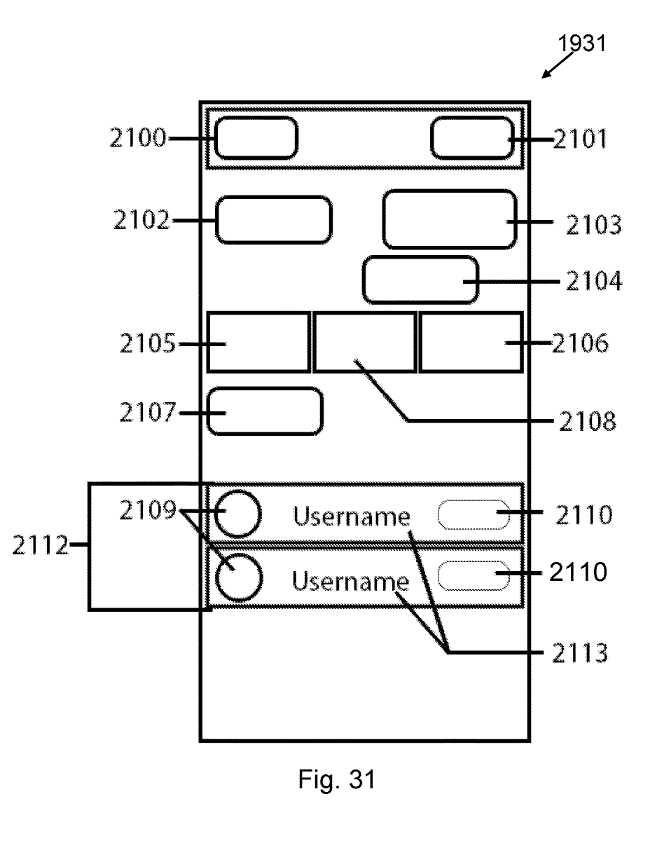

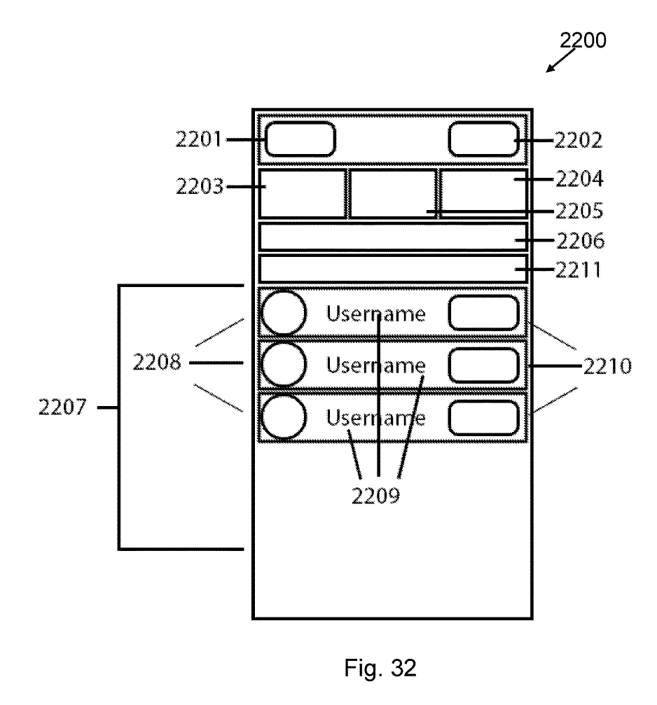

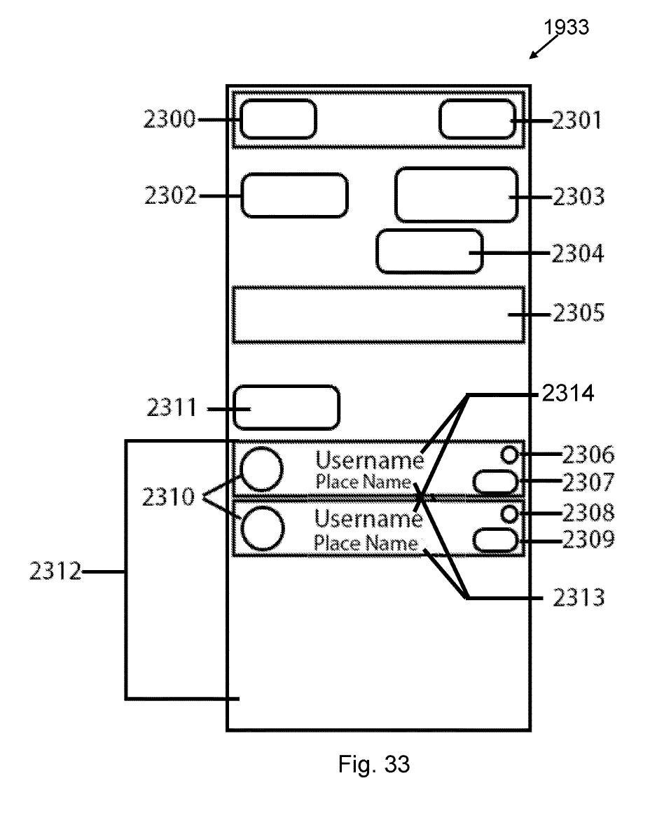

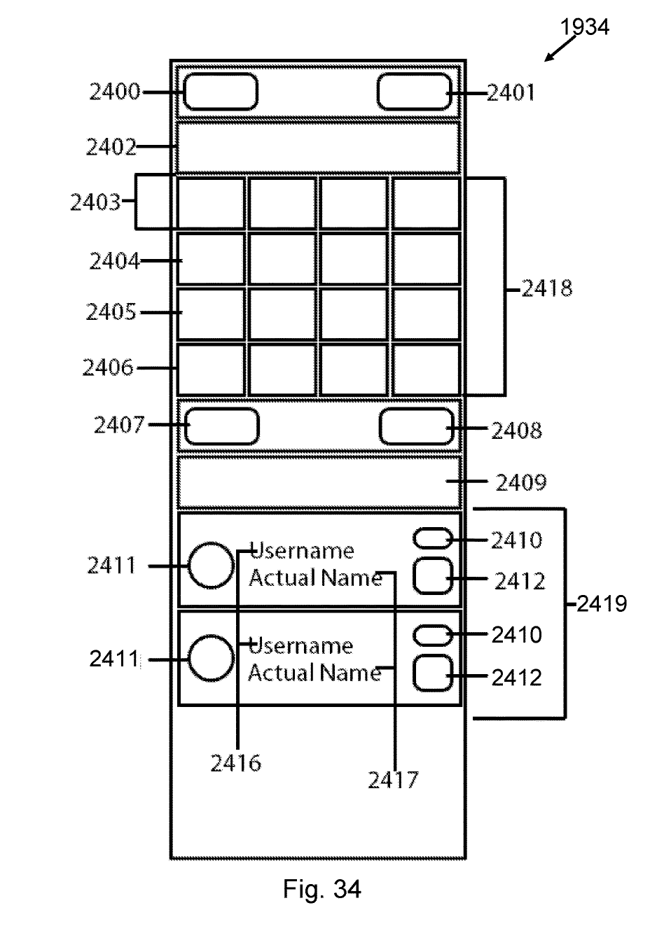

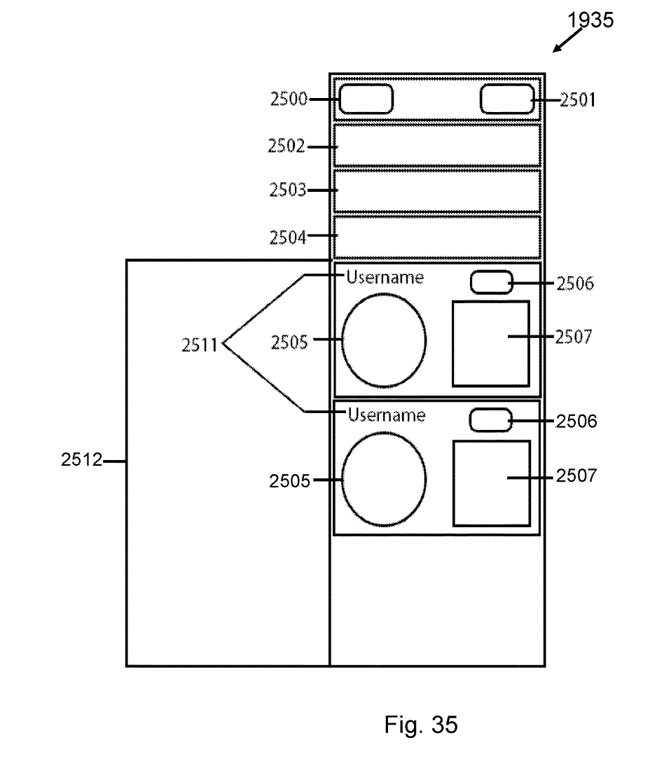

FIG. 20 illustrates an exemplary embodiment of a place open display 1912. The place open display 1912 may include a back button 1900, a save button 1901, a default spot info button 1902, a create event button 1903, a view/edit events button 1904, a customer area button 1905, an account activity button 1906, an attendee button 1907, a drink code button 1908, a referral button 1909, a referral button 1910, and a delete venue button 1911. The back button 1900 can enable the active user to return to the previous display without saving any changes. The save button 1901 can enable the active user to save any changes made in the place open display 19121. The default spot info button 1902 can bring the active user to an edit venue information display 1921 (see FIG. 21). The create event button 1903 can bring the active user to a create event information display 1922 (see FIG. 22). The view/edit events button 1904 can bring the active user to a view/edit event display (FIG. 22). The customer area button 1905 can bring the active user to a customer display 2200 (see FIG. 32). The account activity button 1906 can bring the active user to an account activity display 1933 (see FIG. 33). The attendee button 1907 can bring the active user to an attendee display 1934 (see FIG. 34). The drink code button 1908 can bring the active user to a drink code display 1935 (see FIG. 35). The referral button 1909 can bring the active user to a referral program display 1931 (see FIG. 31). The restore button 1910 can bring the active user to a settings restore display that can enable the active user to selectively restore the settings to a previous configuration. The delete venue button 1911 can enable the active user to delete the venue created in the place open display 1912.

FIGS. 21A-21D illustrate an exemplary embodiment of an edit venue information display 1921. The edit venue information display 1921 may include a back button 2000 to return the active user to the previous display without saving any changes made in the edit venue information display 1921, and a save button 2001 to return to the previous display while saving any changes made in the edit venue information display 1921.

A logo area 2002 may display the currently selected venue logo and enable the active user to change the venue logo by selecting the logo area 2002 and uploading an image. A venue name field 2003 may enable the active user to input a venue name. If the venue is not a verified venue, then the active user can change the venue name using the venue name field 2003. Alternatively, if the venue is a verified venue then verified place names will come from the location mapping application on the mobile device 120. An add venue photos button 2004 may enable the active user to upload and change the profile photos for the venue. A photos section 2005 may show profile photos for the venue. The active user can swipe left or swipe right to view other place profile photos in the photos section 2005.

A venue type area 2006 may enable the active user to select a venue type for the venue. More specifically, when a venue is unverified, the active user can set what type of venue it is in the venue type area 2006. However, if the venue is a verified venue then verified venue information may pull automatically from the location mapping application. The venue type area 2006 may include a venue type expand/unexpand button 2007 that allows the active user to expand and compress the venue type area 2006. A validity icon 2008 may indicate whether information has been properly input into the venue type area 2006. In one embodiment, the validity icon 2008 may light up green for information that has been entered correctly for the venue, and red if any information is missing or incorrect for the venue. In some embodiments, changes made on the edit venue information display 1921 may not be saved if the validity icon 2008 indicates any information is missing or incorrect for the venue, for example the validity icon 2008 is red. An unverified venue editing area 2009 may be used when the active user is editing or creating an unverified place or venue. More particularly, the unverified venue editing area 2009 is where the active user may select what type of venue they are creating. A venue information link 2010 may be selectable to direct the active user to a venue information area. A validity indicator 2011 may indicate whether information has been entered correctly in the unverified venue editing area 2009.

A venue hours area 2013 may be used by the active user to specify opening and closing hours for the venue. The venue hours area 2013 may include a venue hours expand/unexpand button 2014 that allows the active user to view or compress the venue hours area 2013. The venue hours area 2013 may also utilize an validity indicator 2015 that indicates whether information has been entered correctly in the venue hours area 2013. The active user may select a default venue begin time for each day of the week from begin time dropdown menus 2016. Alternatively, the active user can enter a venue or event opening time when venue or event operations will begin for each day of the week in venue opening time fields 2018. The active user may select a default venue end time for each day of the week from end time dropdown menus 2017. Alternatively, the active user can enter a venue or event closing time when venue or event operations will end for each day of the week in venue closing time fields 2019.

A cover charge area 2020 allows the active user to select a default cover charge for an event or for the venue for each day of the week. The cover charge area 2020 may include a cover charge expand/unexpand button 2021 that allows the active user to view or compress the cover charge area 2020. A validity indicator 2022 may indicate whether information has been entered correctly in the cover charge area 2020. The active user can enter male cover charges for each day of the week in male cover charge fields 2025, and female cover charges for each day of the week in female cover charge fields 2026. The active user may select default male cover charges for any day of the week from male cover charge dropdown menus 2023, and may select default female cover charges for any day of the week from female cover charge dropdown menus 2024.

An entertainment area 2027 may display the default entertainment available at the venue for any day of the week. A validity indicator 2028 may indicate whether information has been entered correctly in the entertainment area 2027. The entertainment area 2027 may include an entertainment area expand/unexpand button 2029 that allows the active user to view or compress the entertainment area 2027. The entertainment area 2027 may also include entertainment entry fields 2030 for each day of the week, and the active user can enter the types of entertainment the venue or event offers on each day of the week in the entertainment entry fields 2030. In some embodiments, the active user may separate each different type of entertainment in one of the entertainment entry fields 2030 with a comma.

The active user may enter dress code information for the venue in a dress code area 2032. A validity indicator 2031 may indicate whether information has been entered correctly in the dress code area 2032. The dress code area 2032 may include an dress code area expand/unexpand button 2033 that allows the active user to view or compress the dress code area 2032. The dress code area 2032 may include a female dress code field 2034 where a women's dress code can be specified, and a male dress code field 2035 where a men's dress code can be specified.

The edit venue information display 1921 may include standard features that a venue can use free of charge and advanced features that the venue has to pay to access and use. The system can include an advanced features lock icon 2039 and an advanced features slider 2040 for advanced features that the venue has to pay to access and use. The advanced features lock icon 2039 may be switched between locked and unlocked depending on the advanced features slider 2040. If the advanced features slider 2040 is set to zero, then the advanced features lock icon 2039 is locked. If the advanced features slider 2040 is set to a number greater than zero, then the advanced features lock icon 2039 is unlocked. When a venue moves the advanced features slider 2040 or enters a number greater that zero they are indicating to the system that the venue operators will pay an amount to the system for use of the advanced features, for example $1 for each person that checks into their venue using the system. Any of the features in the edit venue information display 1921 can include locks using similar mechanisms.

The advanced features may include a pay-per check-in area 2036. A validity indicator 2038 may indicate whether information has been entered correctly in the pay-per check-in area 2036. The pay-per check-in area 2036 may also include a pay-per check-in area expand/unexpand button 2037 that allows the active user to view or compress the pay-per check-in area 2036.

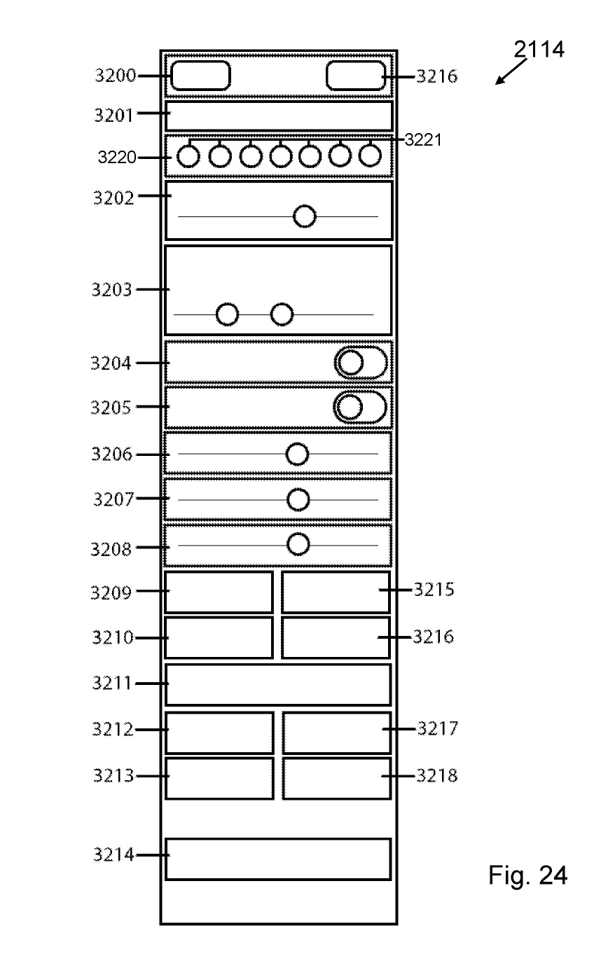

The advanced features may include a guest list area 2041 that enables an active user to create and modify a guest list. The guest list area 2041 may include a validity indicator 2043, and a guest list area expand/unexpand button 2042. The validity indicator 2043 can indicate whether information has been entered correctly in the guest list area 2041. The guest list area expand/unexpand button 2042 can enable the active user to view or compress the guest list area 2041. The guest list area 2041 can include a create guest list button 2045, and a user-selectable list of previously created guest lists. The create guest list button 2044 may be configured to take the active user to a display where they can create a new guest list. Each guest list in the list of previously created guest lists can include an active guest list indicator 2045, a guest list link 2046 and a guest list name 2047. The active guest list indicator 2045 can indicate whether the associated guest list is active or inactive. In some embodiments, the active user can activate or deactivate the associated guest list by selecting the active guest list indicator 2045. The guest list link 2046 can open a guest list display 2114 (see FIG. 24) to enable an active user to view and edit the selected guest list and its details. The guest list name 2047 displays a user assigned name for the guest list.

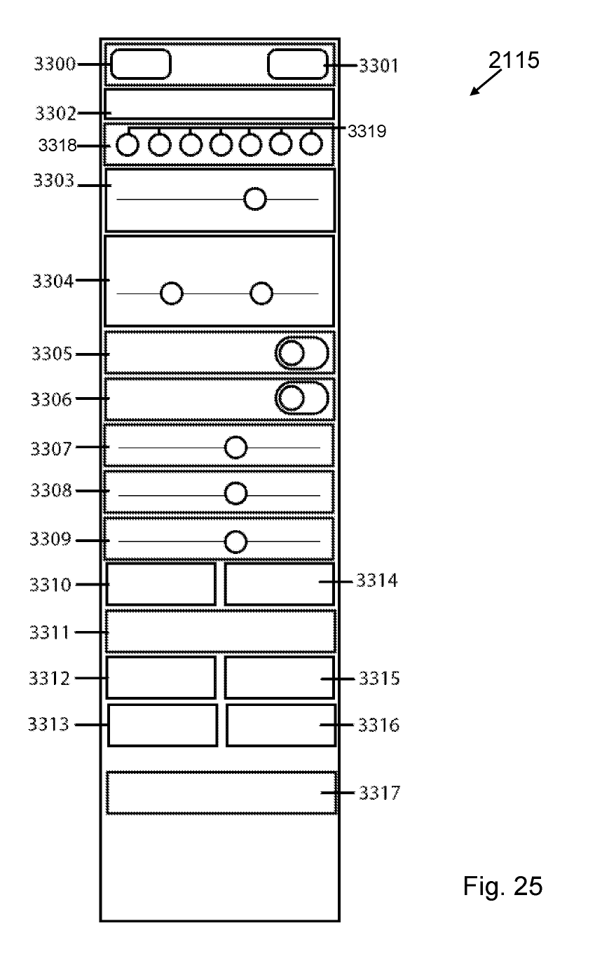

A VIP list area 2048 can enable an active user to create and modify a VIP list. The VIP list area 2048 may include a validity indicator 2050, and a VIP list area expand/unexpand button 2049. The validity indicator 2050 can indicate whether information has been entered correctly in the VIP list area 2048. The VIP list area expand/unexpand button 2049 can enable the active user to view or compress the VIP list area 2048. The VIP list area 2048 can include a create VIP list button 2051, and a user-selectable list of previously created VIP lists. The create VIP list button 2051 may be configured to take the active user to a display where they can create a new VIP list. Each VIP list in the list of previously created VIP lists can include an active VIP list indicator 2052, a VIP list link 2053 and a VIP list name 2054. The active VIP list indicator 2052 can indicate whether the associated VIP list is active or inactive. In some embodiments, the active user can activate or deactivate the associated VIP list by selecting the active VIP list indicator 2052. The VIP list link 2053 can open a VIP list display 2115 (see FIG. 25) to enable an active user to view and edit the selected VIP list and its details. The VIP list name 2054 displays a user assigned name for the VIP list.

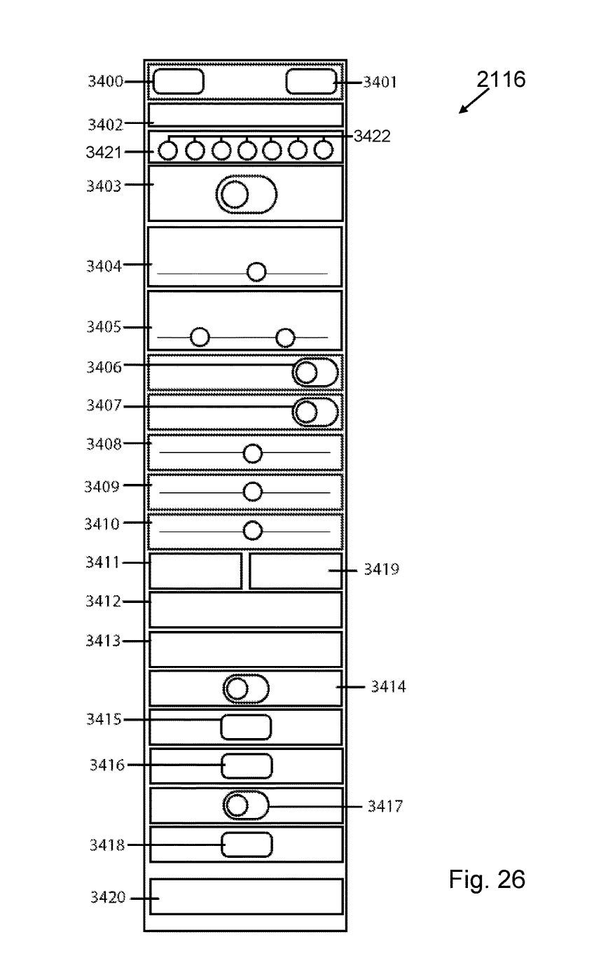

A free drinks area 2056 can enable an active user to enter and edit free drink offers. The free drinks area 2056 may include a validity indicator 2055, and a free drinks area expand/unexpand button 2057. The validity indicator 2055 can indicate whether information has been entered correctly in the free drinks area 2056. The free drinks area expand/unexpand button 2057 can enable the active user to view or compress the free drinks area 2056. The free drinks area 2056 can include a create drink offer button 2058, and a user-selectable list of previously created drink offers. The create drink offer button 2058 may be configured to take the active user to a display where they can create a new drink offer. Each drink offer in the list of previously created drink offers can include an active drink offer indicator 2059, a drink offer link 2060 and a drink offer name 2061. The active drink offer indicator 2059 can indicate whether the associated drink offer is active or inactive. In some embodiments, the active user can activate or deactivate the associated drink offer by selecting the active drink offer indicator 2059. The drink offer link 2060 can open a drink offer display 2116 (see FIG. 26) to enable an active user to view and edit the selected drink offer and its details. The drink offer name 2061 displays a user assigned name for the drink offer.

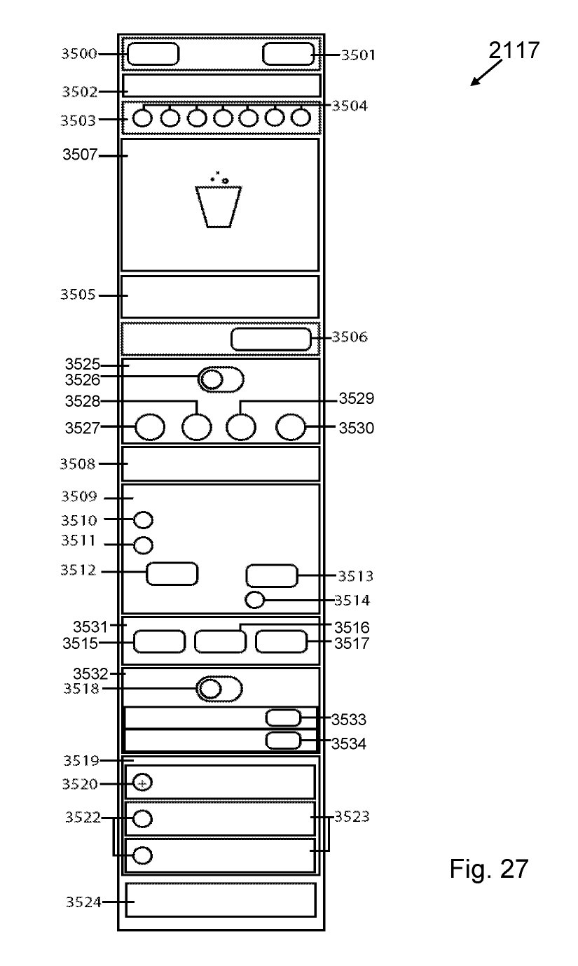

A sell items area 2063 can enable an active user to enter and edit item offers. The sell items area 2063 may include a validity indicator 2062, and a sell items area expand/unexpand button 2064. The validity indicator 2062 can indicate whether information has been entered correctly in the sell items area 2063. The sell items area expand/unexpand button 2064 can enable the active user to view or compress the sell items area 2063. The sell items area 2063 can include a create item offer button 2065, and a user-selectable list of previously created item offers. The create item offer button 2065 may be configured to take the active user to a display where they can create a new item offer. Each item offer in the list of previously created item offers can include an active item offer indicator 2066, an item offer link 2067 and an item offer name 2068. The active item offer indicator 2066 can indicate whether the associated item offer is active or inactive. In some embodiments, the active user can activate or deactivate the associated item offer by selecting the active item offer indicator 2066. The item offer link 2067 can open an item offer display 2117 (see FIG. 27) to enable an active user to view and edit the selected item offer and its details. The item offer name 2068 displays a user assigned name for the item offer.

A marketing budget area 2070 can enable an active user to enter and edit a marketing budget. The marketing budget area 2070 may include a validity indicator 2069, and a marketing budget area expand/unexpand button 2071. The validity indicator 2062 can indicate whether information has been entered correctly in the marketing budget area 2070. The marketing budget area expand/unexpand button 2071 can enable the active user to view or compress the marketing budget area 2070. The marketing budget area 2070 can include, for each day of the week, a maximum budget field 2073 and an active budget indicator 2074. The active user can set a cap on the amount of money they want to spend for each day of the week in the maximum budget fields 2073. The active budget indicator 2074 can indicate whether the budget for that day is active or inactive. In some embodiments, the active user can activate or deactivate the budget for that day by selecting the active budget indicator 2074 for that day. The active user may also view statistics on the number of remote users that utilize the marketing features of the system.

A promotion area 2075 can enable an active user to enter and edit details for a promotion. The promotion area 2075 may include a validity indicator 2077, and a promotion area expand/unexpand button 2076. The validity indicator 2077 can indicate whether information has been entered correctly in the promotion area 2075. The promotion area expand/unexpand button 2076 can enable the active user to view or compress the promotion area 2075. The promotion area 2075 can include a promotion timing area 2078 and a promotion pause area 2079. In the promotion timing area 2078, the active user can choose how many days in advance before an event or the default days of the week to begin promoting an event or venue. In the promotion pause area 2079, the active user can set how often they want to pause promotions and marketing for an event or venue. The active user can use the promotion pause area 2079 to utilize marketing resources in intervals instead of marketing constantly.

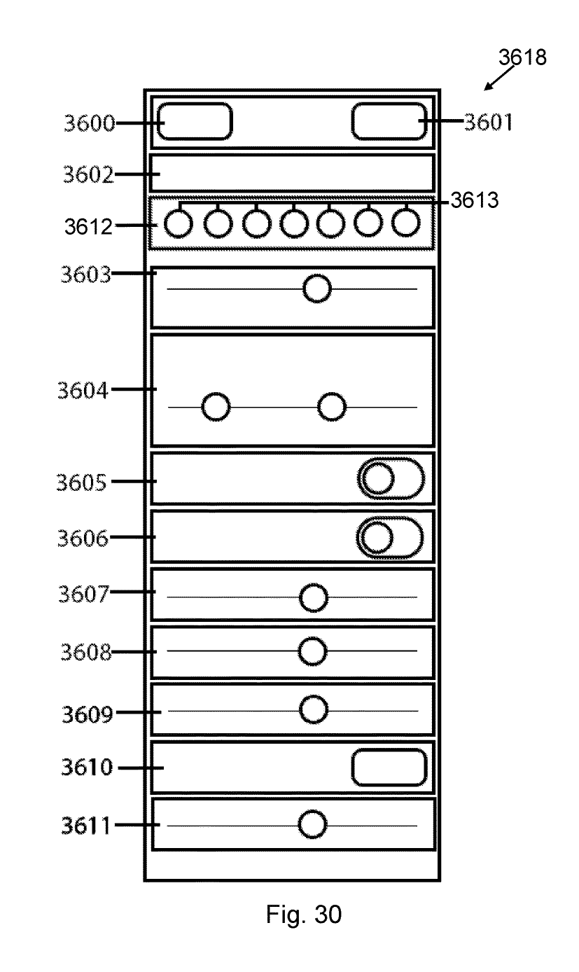

An offer selection area 2081 can enable an active user to enter and edit offers to attract a desired demographic. The offer selection area 2081 may include a validity indicator 2080, and an offer area expand/unexpand button 2082. The validity indicator 2080 can indicate whether information has been entered correctly in the offer selection area 2081. The offer area expand/unexpand button 2082 can enable the active user to view or compress the offer selection area 2081. The offer selection area 2081 can include a create offer button 2083, and a user-selectable list of previously created demographic offers. The create offer button 2083 may be configured to take the active user to an offer creation/edit display 3618 (see FIG. 30) where they can create a new demographic offer. Each demographic offer in the list of previously created offers can include an active offer indicator 2084, and an offer name 2085. The active offer indicator 2084 can indicate whether the associated offer is active or inactive. In some embodiments, the active user can activate or deactivate the associated offer by selecting the active offer indicator 2084. The offer name 2085 can open the offer creation/edit display 3618 to enable an active user to view and edit the selected demographic offer and its details. A demographic offer could include, for example, the distribution of system credits, loot or other enticements to users for attendance at an event or venue.

A payment area can include a validity indicator 2086 that indicates whether information has been entered correctly in the payment area. A credit card type area 2087 may indicate to the active user to either select a credit card type or show the active user that the credit card type has already been selected. A payment profiles dropdown 2088 may allow the active user to select from different types of payment profiles to tell the system what type of payment method they would like to use for the advanced marketing options. The active user can use payment input fields 2089-2092 to enter payment information such as a credit card number, CVV code, expiration date, name, address, etc. The Advanced Marketing features begin at item 2038. When a venue elects to pay the system for Advanced Marketing features, they can indicate it with the advanced features slider 2040. They can select how much they are willing to pay per check in. For example, if the venue sets the advanced features slider 2040 to $1.00 then the venue will need to pay us $1.00 for each person who checks into the venue that day. The venues can set their marketing budget in section 2070. If a venue's marketing budget for Monday is $100 and their payment per check in is $1, then once 100 people indicate that they are GOING in the system then marketing for that day will stop. If only 20 people actually end up attending Monday's event, then the remaining $80 can roll over (be added) to the venue's marketing budget for the next day. The venue's credit card can be billed on a rolling basis. When the system starts marketing for a new day, the venue's card can be charged the full amount for that day's event. Un-used budget can roll over to their next day of marketing. Charges can begin once the venue's payment method is verified. Their marketing schedule can be modified any time as long as marketing for that day has not already begun or is not finished.

A marketing schedule area 2093 can shows the date and the total budget for each day. This area can show a summary of upcoming charges that will be made using the selected payment method and the dates the payments would be charged so a user has a better understanding of the marketing charges they are committing to. The marketing schedule area 2093 may also have a begin marketing button 2094 that allows the active user to execute the marketing schedule 2093. The begin marketing button 2094 can enable the active user to indicate to the system when they are ready to begin utilizing the marketing features described above and indicates that the active user agrees to the costs associated with the marketing features on the marketing schedule.

FIG. 22 illustrates an exemplary embodiment of a create event display 1922. The create event display 1922 may include a back button 4401 to return to the place open display 1912 without saving changes made on the create event display 1922, and a save button 4402 to save changes made on the create event display 1922 and return to the place open display 1912. The create event display 1922 can include a calendar 4405, a month back button 4403 and a month forward button 4403 to enable the active user to select the days the event is going to take place. For example, if February is displayed in the calendar 4405 then a user can select the month back button 4403 to see January in the calendar 4405 or select the month forward button 4404 to see March. Recurring day buttons 4406 can be located near each day of the week on the calendar to enable the active user to choose one or more of the recurring day buttons 4406 to select every Monday, Tuesday, Wednesday, Thursday, Friday, Saturday and/or every Sunday going forward as the days the event will take place. The create event display 1922 may also include a list of previously created events 4411. Each entry in the list of previously created events 4411 may include fields for an event name 4409, event date(s) 4410 that the event takes place, an event image 4407, and an on/off toggle button 4408 to enable or disable the event. The create event display 1922 can include a create new event area that includes a new event name field 4412, a new event image field 4413, a new event description field 4414, an hours of operation area 4415, a cover charge area 4418, an entertainment type field 4421, a dress code area 4422, and an advanced features area 4425. The hours of operation area 4415 can enable the active user to override default hours of operation for the day(s) of the event by entering times in a start time field 4416 and an end time field 4417. The cover charge area 4418 can include a female cover charge field 4419 and a male cover charge field 4420. The dress code area can include a female dress code field 4423 and a male dress code field 4424. The advanced features area 4425 can include tools a venue can use to market their venue and sell items through the system. The advanced features area 4425 may include a pay-per check in area 4426 that indicates the amount the venue will pay the system for every attendee that checks in for the event using the system. The advanced features area may include a create guest list area 4427 that is similar to the guest list area in the venues default information except a guest list created here will override a default guest list. The advanced features area 4425 may include a create free drink area 4428 that is similar to the create free drink offer area in the venues default information except free drink offers created here will override the default free drink offers. The advanced features area 4425 may include a create item offer area 4429 that is similar to the create an item offer area in the venues default information except item offers created here will override the default item offers. The advanced features area 4425 may include an additional marketing budget area 4430 that shows the current default marketing budget set for the venue and enables the active user to enter a new value to change the marketing budget for the event. The advanced features area 4425 may include a promotion timing area 4431 that is similar to the default promotion timing area for the venue except this promotion timing area 4431 will override the default promotion timing for the venue for the selected days of the event. The advanced features area 4425 may also include a demographic selection area 4435 that is similar to the demographic selection area for the venue except this demographic selection area 4435 will override the default demographic selection area for the venue for the selected days of the event. The create event display 1922 also includes a delete event button 4436 that enables the active user to delete the event created or being created on the create event display 1922.

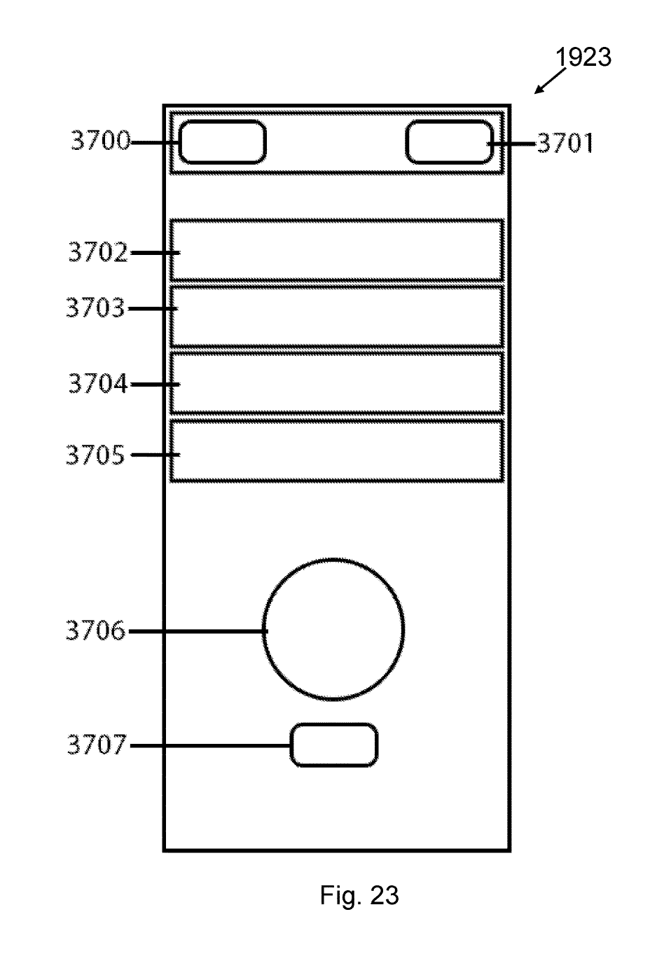

FIG. 23 illustrates an exemplary embodiment of a spot location display 1923. The spot location display 1923 may include a back button 3700 to return to the place open display 1912 without saving changes made on the spot location display 1923, and a save button 3701 to save changes made on the spot location display 1923 and return to the place open display 1912. The spot location display 1923 can enable the active user to enter information about the location of the venue or event. For example, the spot location display 1923 can include a country field 3702, a state field 3703, a city field 3704, a street address field 3705, a pinpoint map location area 3706, and a GPS coordinates field 3707. The information from the fields of the spot location display 1923 can be used by the system to show the proper location for the venue or event.

FIG. 24 illustrates an exemplary embodiment of a guest list display 2114 that enables an active user to create or edit a guest list, to vary the number of male and female guests, to target age ranges and distance, to vary cover charges, to allow invited guests to bring additional people at set cover charges, and to set other parameters. The guest list display 2114 may include a back button 3200 to return to the edit venue information display 1921 without saving changes made on the guest list display 2114, and a save button 3216 to save changes made on the guest list display 2114 and return to the edit venue information display 1921. The guest list display 2114 can enable an active user to edit or view guest list information. The guest list display 2114 can include a guest list name field 3201, an active day area 3220, a distance selector 3202 and an age range selector 3203. The active user can enter a name for the guest list in the guest list name field 3201. The active day area 3220 can include an active indicator 3221 for each day of the week where the active indicator 3221 lights up or changes colors when activated. The active user can activate or deactivate the guest list for any day of the week by toggling the active indicator 3221 for that day. The distance selector 3202 can be a target distance slider that can set a target geographical distance for people included in the guest list where the slider can be moved between a close distance threshold and a far distance threshold. The age range selector 3203 can be two sliders where one slider sets a lower target age for the guest list and the other slider sets an upper target age for the guest list. The guest list display 2114 can include target guest list gender mix toggles, for example, a female toggle 3204 and a male toggle 3205. The guest list display 2114 can include a chili pepper or attractiveness rating slider 3206 to set a minimum attractiveness rating for people on the guest list. The guest list display 2114 can include a minimum followers slider 3207 to set a target number of followers for people on the guest list. The guest list display 2114 can include a guest list length slider 3208 to set a target number of guests for the guest list. The guest list display 2114 can include a female cover charge field 3209 and a male cover charge field 3215. The guest list display 2114 can include a timing dropdown 3210 where the active user selects what time a guest must say they are going to the event in order to claim this guest list offer. The guest list display can include a timing dropdown 3216 where the active user can select what time a guest must arrive by in order to use the guest list offer. The guest list display 2114 can include a user check-in information field 3211 that enables the active user to specify how to check-in to the venue in order to receive the guest list offer. The guest list display 2114 can include an additional female guest field 3212 and an additional male guest field 3217 to specify the number of additional female and male guests a user on the guest list may bring. The guest list display 2114 can include an additional female cover charge field 3213 and an additional male cover charge field 3218 that enables the active user to specify any cover charge for additional people accompanying a user on the guest list. The guest list display 2114 can include a delete button 3214 that enables an active user to delete a guest list.

FIG. 25 illustrates an exemplary embodiment of a VIP list display 2115. The VIP list display 2115 may be similar to the guest list display 2114 described above. The VIP list display 2115 may include a back button 3300 to return to the edit venue information display 1921 without saving changes made on the VIP list display 2115, and a save button 3301 to save changes made on the VIP list display 2115 and return to the edit venue information display 1921. The VIP list display 2115 can enable an active user to edit or view VIP list information. The VIP list display 2115 can include a VIP list name field 3302, an active day area 3318, a distance selector 3303 and an age range selector 3304. The active user can enter a name for the VIP list in the VIP list name field 3302. The active day area 3318 can include an active indicator 3319 for each day of the week where the active indicator 3319 lights up or changes colors when activated. The active user can activate or deactivate the VIP list for any day of the week by toggling the active indicator 3319 for that day. The distance selector 3303 can set a target distance from the event location within which to include guests on the VIP list where the slider can be moved between a close distance threshold and a far distance threshold. The age range selector 3304 can be two sliders where one slider sets a lower target age for the VIP list and the other slider sets an upper target age for the VIP list. The VIP list display 2115 can include target VIP list gender mix toggles, for example, a female offer toggle 3305 to offer the selected VIP list to females, and a male offer toggle 3306 to offer the selected VIP list to males. The VIP list display 2115 can include a chili pepper or attractiveness rating slider 3307 to set a minimum attractiveness rating for people on the VIP list. The VIP list display 2115 can include a minimum followers slider 3308 to set a minimum number of followers for people on the VIP list. The VIP list display 2115 can include a VIP list length slider 3309 to set a target number of guests for the guest list. The VIP list display 2115 can include VIP expiration fields 3310, 3314 to set a VIP offer expiration date and time. The VIP list display 2115 can include a VIP instructions box 3311 to enter VIP list instructions. The VIP list display 2115 can include an additional female guest field 3312 and an additional male guest field 3315 to specify the number of additional female and male guests a VIP guest on the VIP guest list can bring with them. The VIP list display 2115 can include an additional female cover charge field 3313 and an additional male cover charge field 3316 that enables the active user to specify any cover charge for additional people accompanying a VIP guest. The VIP list display 2115 can include a delete VIP list button 3317 to delete a VIP list.

FIG. 26 illustrates an exemplary embodiment of a free drinks display 2116. The free drinks display 2116 can enable the active user to create and edit drink coupons to be distributed to select remote users. The free drinks display 2116 may include a back button 3400 to return to the edit venue information display 1921 without saving changes made on the free drinks display 2116, and a save button 3401 to save changes made on the free drinks display 2116 and return to the edit venue information display 1921. The free drinks display 2116 can include a guest list name field 3402, an active day area 3421, a new customer toggle 3403, a distance selector 3404 and an age range selector 3405. The active user can view and/or edit the name of the free drink in the free drink name field 3402. The active user can choose the days of the week they want the free drink to be activated in the active day area 3421. The active day area 3421 can include an active indicator 3422 for each day of the week where the active indicator 3422 lights up or changes colors when activated. The active user can activate or deactivate the free drink for any day of the week by toggling the active indicator 3422 for that day. The active user can control whether free drink offers only go to first time customers using the new customer toggle 3403. The distance selector 3404 can be a target distance slider, and the active user can identify a target distance within which to offer free drink offers to qualifying users with the target distance slider where the slider can be moved between a close distance threshold and a far distance threshold. The age range selector 3405 can be two sliders where one slider sets a lower target age and the other slider sets an upper target age for a target age range within which drink offers will be distributed. The free drinks display 2116 can also include a female toggle 3406 to indicate whether to extend the free drink offer to females, and a male toggle 3407 to indicate whether to extend the free drink offer to males. The free drinks display 2116 can include a chili pepper or attractiveness rating slider 3408 to set a minimum attractiveness rating for people that receive the free drink offer. The free drinks display 2116 can include a minimum followers slider 3409 to set a minimum number of user followers for people that receive the free drink offer. The free drinks display 2116 can include a free drink offer limit slider 3410 to set a free drink offer limit. The free drinks display 2116 can include a daily free drink offer timeframe in which a drink offer must be redeemed using a free drink start time field 3411 and a free drink end time field 3419. The free drinks display 2116 can include a drink type box 3412 to identify a type of product or drink associated with the free drink coupon. The free drinks display 2116 can include a redemption instruction box 3413 to enter any free drink offer redemption instructions. The free drinks display 2116 can include a reload toggle 3414, a reload time field 3415 and a reload number field 3416. The free drink reload toggle 3414 can control whether the free drink offer reloads after a set time. The free drink reload time field 3415 can set a time duration for a free drink offer to reload. The reload number field 3416 can set a maximum number of free drink reloads per guest. The free drinks display 2116 can include a check-in toggle 3417 and a check-in time field 3418. The check-in time toggle 3417 can set whether the guest must be checked-in to a venue a certain amount of time before redeeming the free drink coupon. The check-in time field 3418 can set the amount of time the user must be checked-in to the venue before redeeming the free drink coupon. The free drinks display 2116 can include a delete button 3420 that enables an active user to delete the free drink offer.

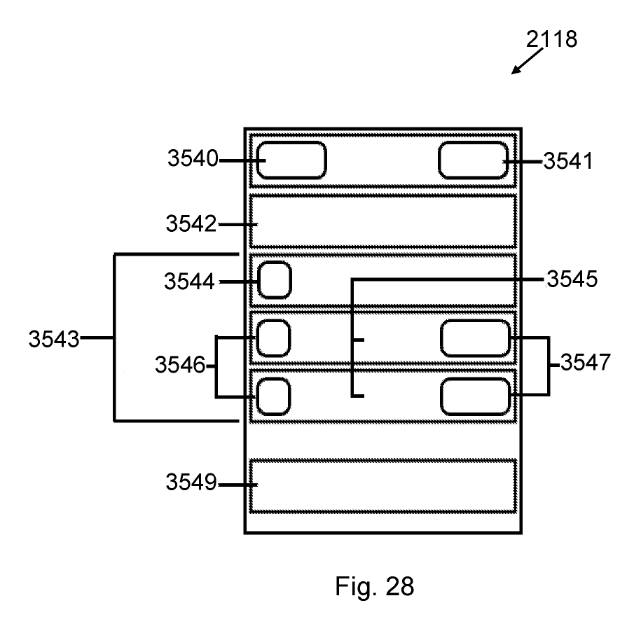

FIG. 27 illustrates an exemplary embodiment of a sell items display 2117. The sell items display 2117 may include a back button 3500 to return to the edit venue information display 1921 without saving changes made on the sell items display 2117, and a save button 3501 to save changes made on the sell items display 2117 and return to the edit venue information display 1921. The sell items display 2117 can include an item name field 3502, an active day area 3503, an item image area 3507, an item use indicator 3505 and a sale price field 3506. The active user can view and/or edit the name of the item in the item name field 3502. The active user can choose the days of the week they want the item for sale to be activated in the active day area 3503. The active day area 3503 can include an active indicator 3504 for each day of the week where the active indicator 3504 lights up or changes colors when activated. The active user can activate or deactivate the item for sale any day of the week by toggling the active indicator 3504 for that day. The active user can upload photo(s) of the item for sale in the item image area 3507. The active user can indicate what the item may be redeemed for in the item use indicator 3505. The active user can set the price for the item in the sale price field 3506. The sell items display 2117 may also include a reoccurring payments area 3525 where the active user can set reoccurring payment methods for membership type items for sale. The reoccurring payments area 3525 may include an activation toggle 3526 that sets whether or not the items price can be charged on a reoccurring basis. When the activation toggle 3526 is in the activated position, reoccurring payment button selections can be revealed. The reoccurring payment button selections may include a weekly selection 3527, a bi-weekly selection 3528, a monthly selection 3529, and an annual selection 3530. When one of the reoccurring payment button selections is selected then the system will charge whatever amount has been set in the sale price field 3506 on the selected reoccurring basis based on the reoccurring payment button option selection. The sell items display 2117 may have a hashtag area 3508 where the active user can include hashtags categories for this item so the item may be easily searchable. The sell items display 2117 may have a redemption time area 3509 where the active user can indicate what time of day the item may be redeemed once purchased. The redemption time area 3509 can include an anytime option 3510 to indicate the item can be redeemed anytime the venue is open, a time window option 3511 to indicate the item can be redeemed in the time window specified between a beginning time field 3512 and an ending time field 3513. A following day indicator 3514 can indicate that the ending time field 3513 if for the day following day the beginning time field 3512. The sell items display 2117 may include a production time area 3531 indicating the production time for the item, and the production time field 3531 can include an production hours field 3517, a production minutes field 3515 and a production seconds field 3516 to specify the production time for the item. The sell items display 2117 may include a presale area 3532 that enables the active user to set discounts for people purchasing items before the venue opens. The presale area 3532 can include an activation toggle 3518, a presale time field 3533 and a presale discount field 3534. The activation toggle 3518 can indicate whether there are any presale discounts. When the activation toggle 3518 is in the on position, the customer can receive the discount specified in the presale discount field 3534 if they purchase the item more than X hours before the venue opens, where X is the value specified in the presale time field 3533. For example, if the venue wants to offer 30% off items that are purchased 4 hours before the venue opens, then 4 would be entered in the presale time field 3533 and 30% would be entered in the presale discount field 3534. The sell items display 2117 may also include an item options area 3519 where the active user can enter options that may be specific to the item. The item options area 3519 can include a new option selection 3520, an existing options list 3523 and an option activator 3522 for each of the options in the existing options list 3523. The new option selection 3520 can enable the active user to create a new item option, and can open an option edit display 2118 (see FIG. 28) where this option may be created. The existing options list 3523 can include a list of previously created item options, and each list entry can link to an area where that item option may be viewed and edited in an option edit display 2118. The option activator 3522 for each option can indicate whether that option is activated for this item. The active user can toggle the option activator 3522 to activate and deactivate that option for this item. The sell items display 2117 can include a delete button 3524 that enables an active user to delete the item.

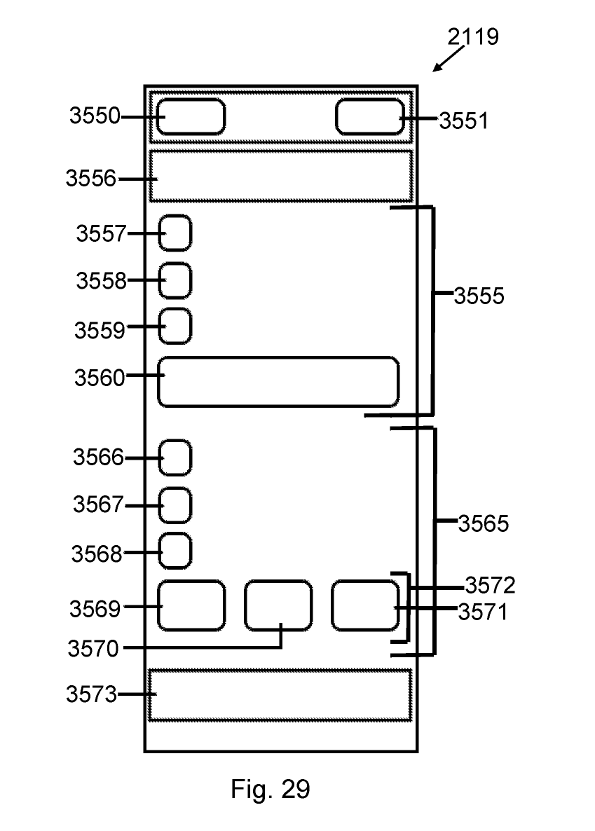

FIG. 28 illustrates an exemplary embodiment of an option edit display 2118. The option edit display 2118 may include a back button 3540 to return to the sell items display 2117 without saving changes made on the option edit display 2118, and a save button 3541 to save changes made on the option edit display 2118 and return to the sell items display 2117. The option edit display 2118 can include an option name field 3542 and an option choices area 3543. The active user can enter, view and/or edit the name of the option in the option name field 3542. Option choices can be created and edited in the option choices area 3543. The option choices area 3543 may include a new choice selection 3544, and an existing choices list 3545. The new choice selection 3542 can enable the active user to create a new option choice, and can open an option choice edit display 2119 (see FIG. 29) where this option choice may be created. Each option choice in the existing choices list 3545 can include a choice activator 3546 and a price impact field 3547. Each list entry in the existing choices list 3545 can link to an area where that option choice may be viewed and edited in an option choice edit display 2119. The choice activator 3546 for each option choice can indicate whether that choice is activated for this option. The active user can toggle the choice activator 3546 to activate and deactivate that choice for this option. The price impact field 3547 can indicate how much the option choice increases or decreases the item price for the consumer. The option edit display 2118 can include a delete button 3549 that enables an active user to delete the option being edited.

FIG. 29 illustrates an exemplary embodiment of an option choice edit display 2119. The option choice edit display 2119 may include a back button 3550 to return to the option edit display 2118 without saving changes made on the option choice edit display 2119, and a save button 3551 to save changes made on the option choice edit display 2119 and return to the option edit display 2118. The option choice edit display 2119 may include a choice name field 3552, a choice price effect area 3555 and a choice time effect area 3565. The active user can enter, view and/or edit the name of the choice in the option choice name field 3552. The choice price effect area 3555 enables the active user to indicate any effects this choice will have on the item price. The choice price effect area 3555 may include a no price effect selection 3557, an increase price effect selection 3558, a decrease price effect selection 3559 and a price effect amount field 3560. The active user can select the no price effect selection 3557 to indicate that this option choice will not affect the price of the item. The active user can select the increase price effect selection 3558 to indicate that this option choice will increase the price of the item, and the active user can enter the expected increase in item price in the price effect amount field 3560. The active user can select the decrease price effect selection 3559 to indicate that this option choice will decrease the price of the item, and the active user can enter the expected decrease in item price in the price effect amount field 3560. The choice time effect area 3565 may include a no time effect selection 3566, an increase time effect selection 3567, a decrease time effect selection 3568 and a time effect amount area 3572. The active user can select the no time effect selection 3566 to indicate that this option choice will not affect the preparation time for the item. The active user can select the increase time effect selection 3567 to indicate that this option choice will increase the preparation time for the item, and the active user can enter the expected increase in preparation time in the time effect amount area 3572. The active user can select the decrease time effect selection 3568 to indicate that this option choice will decrease the preparation time for the item, and the active user can enter the expected decrease in preparation time in the time effect amount area 3572. The time effect amount area 3572 may include a hour field 3569, a minute field 3570 and a second field 3571 to enable the active user to input the anticipated increase/decrease in preparation time due to this choice for the item from the preparation time of the original item without the choice. The option choice edit display 2119 can also include a delete button 3573 that enables an active user to delete the option choice being edited.

FIG. 30 illustrates an exemplary embodiment of an loot offer display 3618 where an active user can create, view and edit offers to attract a desired demographic. The loot offer display 3618 may include a back button 3600 to return to the edit venue information display 1921 without saving changes made on the loot offer display 3618, and a save button 3601 to save changes made on the loot offer display 3618 and return to the edit venue information display 1921. The loot offer display 3618 can include a loot offer name field 3602, an active day area 3612, a distance selector 3603 and an age range selector 3604. The active user can enter, view and/or edit a name for the loot offer in the loot offer name field 3602. The active day area 3612 can include an active indicator 3613 for each day of the week where the active indicator 3613 lights up or changes colors when activated. The active user can activate or deactivate the loot offer for any day of the week by toggling the active indicator 3613 for that day. The distance selector 3603 can be a target distance slider that can set a target geographical distance for people included in the loot offer where the slider can be moved between a close distance threshold and a far distance threshold. The age range selector 3604 can be two sliders where one slider sets a lower target age for the loot offer and the other slider sets an upper target age for the loot offer. The loot offer display 3618 can include target loot offer gender mix toggles, for example, a female loot offer toggle 3605 to indicate whether to extend the loot offer to women and a male loot offer toggle 3606 to indicate whether to extend the loot offer to men. The loot offer display 3618 can include a chili pepper or attractiveness rating slider 3607 to set a minimum attractiveness rating a person must have in order to receive the loot offer. The loot offer display 3618 can include a minimum followers slider 3608 to set a minimum number of followers a person must have in order to receive the loot offer. The loot offer display 3618 can include a loot offer limit slider 3609 to limit the number of loot offers to a set number of users who are going to the event. The loot offer display 3618 can include a loot timing dropdown 3610 to set a time when a person must arrive at the event/venue to receive the loot offer. The loot offer display 3618 can also include a loot maximum budget slider 3611 to set a maximum budget to be used for the loot offer.

FIG. 31 illustrates an exemplary embodiment of a referral program display 1931. The referral program display 1931 may include a back button 2100 to return to the place open display 1912 without saving changes made on the referral program display 1931, and a save button 2101 to save changes made on the referral program display 1931 and return to the place open display 1912. The referral program display 1931 may include a loot balance field 2102 that shows the active user the balance in their loot or system credit account. The referral program display 1931 may include a withdrawal button 2103 that enables the active user to select an amount of loot they would like to withdraw from their loot account. The withdrawal button 2103 can open a pop-up window that displays a field where the user can select the amount of loot they would like to withdraw and a withdrawal confirmation button. The referral program display 1931 may include a total loot earned field 2104 that shows the active user how much loot they have earned using the system. The referral program display 1931 may include a referral program tab 2105, a promoters tab 2108 and a venue tab 2106. The referral program tab 2105 can bring the active user back to this referral program display 1931. The promoters tab 2108 can bring the active user to a referral program promoter area. The venue tab 2106 can bring the active user to a referral program venue area. The referral program promoter area and the referral program venue area can be similar to the referred users scrollable area 2112 (described below) with different filtered results. The referral program display 1931 may include a referral income field 2107 that shows the active user how much loot they have earned by referring users.

The referral program display 1931 may include a referred users scrollable area 2112 that includes a referrals list of remote users that have been referred to the system by the active user. Each entry in the referrals list can include a user name field 2113, a user icon 2109 and a commission field 2110. The user name field 2113 may display the user name of a referred user referred to the system by the active user. The user icon 2109 may show the icon of the corresponding referred user, and the user icon 2109 can be selectable by the active user to link to the corresponding referred user's profile on the system. The commission field 2110 may show the amount of commission or loot the active user has made from referring the corresponding referred user.

FIG. 32 illustrates an exemplary embodiment of a customer display 2200. The customer display 2200 may include a back button 2201 to return to the place open display 1912 without saving changes made on the customer display 2200, and a save button 2202 to save changes made on the customer display 2200 and return to the place open display 1912. The customer display 2200 may include a scrollable user list 2207 of all the users that have ever checked into this place/venue. The active user can filter and search the scrollable user list 2207 using functions provided on the customer display 2200. The active user or administrator for the place/venue can decide which users get VIP status, normal status and blacklist status. The customer display 2200 may include a VIP filter selection 2203, blacklist filter selection 2205, a normal user filter selection 2204, and a gender filter selection 2206. The VIP filter selection 2203 may filter the customer list to generate a filtered list of only VIP customers. The blacklist filter selection 2205 may filter the customer list to generate a filtered list of only those that have been put on a blacklist. The normal user filter selection 2204 may filter the customer list to generate a filtered list of only normal customers. The gender filter selection 2206 may enable the active user to filter the customer list to generate a filtered list of only male or female customers. The VIP, blacklist, normal user, and gender filter selections 2203-2206 can be toggles that when activated generate the filtered customer list and when deactivated restore the unfiltered customer list. The customer display 2200 may include a search filed 2211 where the active user can search the customer list 2207 for particular usernames. The customer list 2207 is scrollable by the active user. Each entry in the customer list 2207 may include a user profile icon 2208, a corresponding user name 2209, and a corresponding user status indicator 2210 for remote users who have checked into a venue. The user profile icon 2208 can be a link that the active user can select to view the system profile for that user. The user status indicator 2210 can be a selectable field where the active user can view the current status of a user, and the active user can change the status of the user between VIP, normal, and black listed.

FIG. 33 illustrates an exemplary embodiment of an account activity display 1933. The account activity display 1933 may include a back button 2201 to return to the place open display 1912 without saving changes made on the account activity display 1933, and a save button 2202 to save changes made on the account activity display 1933 and return to the place open display 1912. The account activity display 1933 may include a loot balance field 2302 that shows the active user the balance in their loot or system credit account. The account activity display 1933 may include a withdrawal button 2303 that enables the active user to select an amount of loot they would like to withdraw from their loot account. The account activity display 1933 may include a total loot earned field 2304 that shows the active user how much loot they have earned using the system. Many of these fields can be set up like the correspondingly named fields described above with regard to FIG. 31. The account activity display 1933 may include a scrollable activity list 2312, an activity search field 2305 and an activity list date field 2311. The scrollable activity list 2312 can include of all the system tracked activities of all users that the active user has referred to the system. The active user can enter search terms in the activity search field 2305 to search and filter the scrollable activity list 2312 for things like activity types, place names, user names and other parameters. The activity list date field 2311 can show the latest date for activities currently displayed in the scrollable activity list 2312, and as the active user scrolls through the scrollable activity list 2312 the date in the activity list date field 2311 can change to show the date of the activities currently displayed. Each activity in the scrollable activity list 2312 may include a profile image 2310 and a username 2314 for the user that attended the activity, a place name 2313 for the location of the activity, a time stamp 2306 of when the activity took place, and an event type field 2307 that displays an event type for this activity. The profile image 2310 can be a link that the active user can select to view the system profile for the user.

FIG. 34 illustrates an exemplary embodiment of an attendee display 1934. The attendee display 1934 may include a back button 2400 to return to the place open display 1912 without saving changes made on the attendee display 1934, and a save button 2401 to save changes made on the attendee display 1934 and return to the place open display 1912. The attendee display 1934 may have a calendar dropdown 2402 that allows the active user to select a date they want to view which brings up an event for the selected date. When the active user selects a date using the calendar dropdown 2402, the system can populate various fields in the attendee display 1934, including for example, an attendee table 2418, a copy URL button 2407, a total attendees field 2408 and an attendee list 2419. The attendee table 2418 may show how many guys and how many girls will be attending the event/special event, the people who are going to the event that are not on any list for the event, that are on a guest list for the event, and that are on a VIP list for the event. A top row 2403 can include headers for each column of the attendee table 2418, for example “List”, “Guys”, “Girls”, “Total”. The second row 2404 can have the entry “No List” in the first column and then the next three columns can have entries for the number of guys, number of girls, and total number of guys and girls, respectively, that are going to the venue on the given day but are not on a guest list or VIP list. The third row 2405 can have the entry “Guest List” in the first column and then the next three columns can have entries for the number of guys, number of girls, and total number of guys and girls, respectively, that are on the guest list. The bottom row 2406 can have the entry “VIP List” in the first column and then the next three columns can have entries for the number of guys, number of girls, and total number of guys and girls, respectively, that are on the VIP list.

The copy URL button 2407 can provide the active user with a URL (Uniform Resource Locator) for a website associated with the event/venue. For example, this URL may enable representatives of the venue hosting the event to view lists of live orders and activity associated with the event, and/or a place to create and manage server profiles. The total attendees field 2408 can provide a total number of guys and girls that have indicated that they are going to the event/venue on the date selected in the calendar dropdown 2402. The attendee list 2419 can include a list of the people that have indicated that they are going to the event/venue on the date selected in the calendar dropdown 2402. An attendee filter field 2409 can enable the active user to enter parameters to filter the attendee list 2419, for example the attendee filter field 2409 can present filters to list people not on any list, or list people on the guest list, or list people on the VIP list, or list females, or list males, etc. The entry for each attendee in the attendee list 2419 can include attendee information. The attendee information may include, for example, an attendee profile image 2411, an attendee username field 2416, an attendee actual name field 2417, and attendee cover charge field 2410, an attendee check-in option 2412, etc. The attendee profile image 2411 may link to the system profile for the attendee. The attendee username field 2416 may show the attendee's username, and the attendee actual name field 2417 may show the attendee's actual name. The attendee cover charge field 2410 may show the cover charge that this attendee will have to pay on arrival to the event if they show up to the venue by the time specified by the guest list check-in time, VIP list check-in time, or, if not on any list, the regular cover charge price. The attendee check-in option 2412 may allow the venue to use the system to check the attendee into the event on arrival.

FIG. 35 illustrates an exemplary embodiment of a drink code display 1935. The drink code display 1935 may include a back button 2500 to return to the place open display 1912 without saving changes made on the drink code display 1935, and a save button 2501 to save changes made on the drink code display 1935 and return to the place open display 1912. The drink code display 1935 may include a drink code filter 2502, a drink code URL field 2503, a drink code field 2504 and a drink coupon list 2512. The drink code filter 2502 enables the active user to change the venue for which drink codes are being displayed. The drink code URL field 2503 may display URLs to the active user to access drink codes on a remote system. The URL may show pending Item orders and the statuses of the orders. The status types may include Ready to be prepared, Prepared, Being Delivered, Delivered, Transaction Complete, Ready for pick up, and Delivery Conflict. Each of the orders may show the server what's been ordered, how many and the selected delivery method. The server area of the URL may let the venue or end user add a server so that the end user can at times select which server they want to tip. The entry for each user coupon in the drink coupon list 2512 can include user and drink coupon information. The user and drink coupon information may include, for example, a profile photo area 2505, a username field 2511, an activation time stamp field 2506, a drink code display 2507, etc. The profile photo area 2505 and the username field 2511 may show a photo and the username, respectively, of the user that redeemed the drink code/coupon. One or both of the profile photo area 2505 and the username field 2511 may provide a link to the user's system profile. The activation time stamp field 2506 may indicate how long ago the drink code/coupon was used. The drink code display 2507 may show the drink code of the drink coupon used. Alternatively, the drink coupon list 2512 may show the orders that have been ordered from the phone so that no order code is necessary to validate the order, the order just showing up in this area can be validation enough that the order is real.

FIG. 36 illustrates an exemplary embodiment of a check-in display 1310. The check-in display 1310 may include a back button 1300 that returns the user to the previous display. The check-in display 1310 may present the active user with a venues list 1301 of venues that they can check into based on their GPS location. For each place/venue in the venues list 1301, the check-in display 1310 may show venue information to the user. The venue information can include, for example, a venue logo or profile image 1302, a venue name 1303, a venue distance 1308, a venue event name 1304, venue event details 1307, a rewards indicator 1305, a promotions indicator 1306, etc. The venue logo or profile image 1302 may provide a link to a system profile for the venue. The venue distance shows the distance to the venue from the user's current location using their GPS location. The venue event name 1304 and venue event details 1307 fields may be displayed to describe an event at the venue if the venue is hosting a special event today/tonight. The rewards indicator 1305 may show the active user how much rewards in system credits they may get for checking into this venue. The promotions indicator 1306 may show the active user how many drink coupons, item coupons or other promotional offers they may get for checking into the venue. The user can use the check-in display 1310 to check-into a venue as long as they are within the venues check in distance.

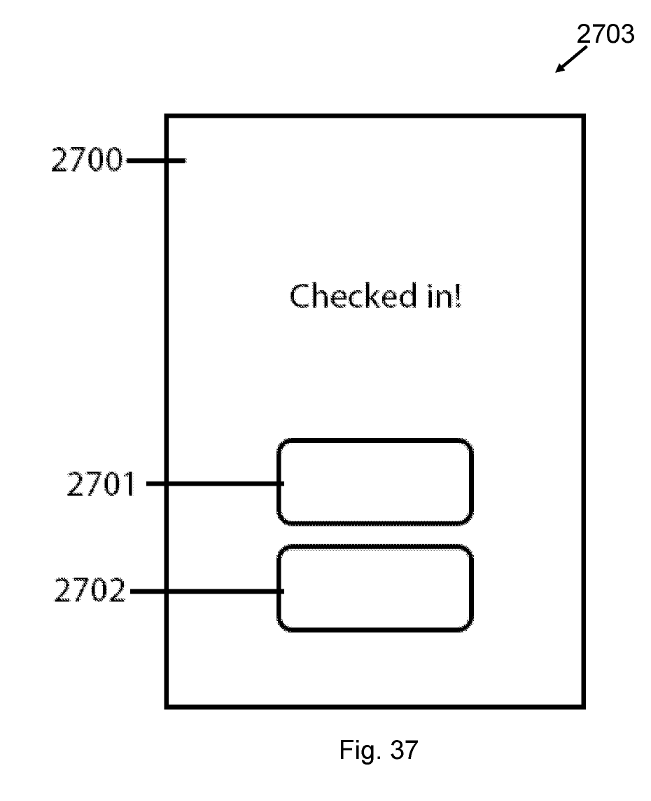

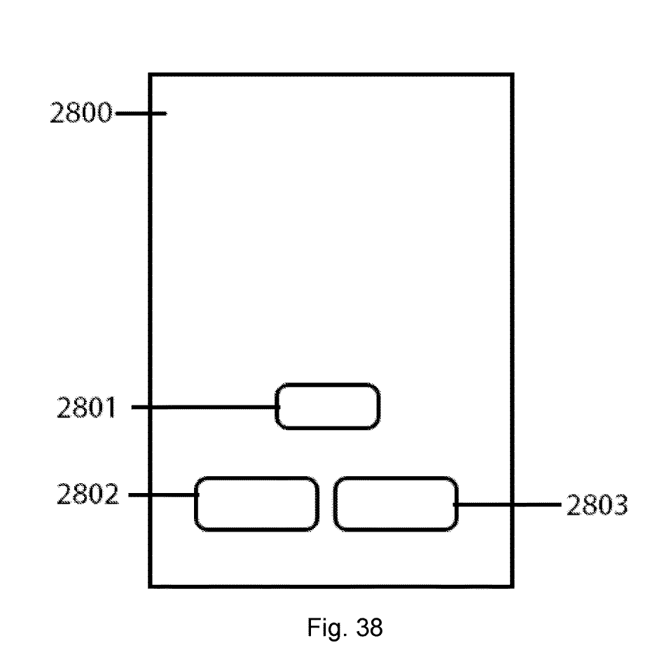

FIG. 37 illustrates an exemplary embodiment of a checked in display 2700, which may be a pop-up window that indicates to the active user that they have received system rewards for checking into a venue. If a user has auto check in enabled on their device, then they will automatically be checked into a venue if they are within a venues check in distance for a set amount of time, for example for more than one minute. They can also manually check-in to a venue using the check-in display 1310. The checked in display 2700 may include a rewards amount field 2701 showing the active user how many system credits, for example hootloot, they have received for checking into the venue. The checked in display 2700 may also include a post a photo link 2702 that can link the active user to a post-a-photo earn rewards display 2800 (see FIG. 38).

FIG. 38 illustrates an exemplary embodiment of a post-a-photo earn rewards display 2800 that may be a pop-up window. The post-a-photo earn rewards display 2800 may include a rewards amount field 2801 showing the active user how many system credits, for example hootloot, they will receive for posting a photo from the venue. The venue may require that the user uses a camera rewards display 2909 for posting the photo. The post-a-photo earn rewards display 2800 may include a close button 2802 that closes the post-a-photo earn rewards display 2800 without posting a photo and brings the active user to the previous display. The post-a-photo earn rewards display 2800 may include a camera rewards link 2803 that directs the active user to the camera rewards display 2909 for posting a photo to receive the rewards.

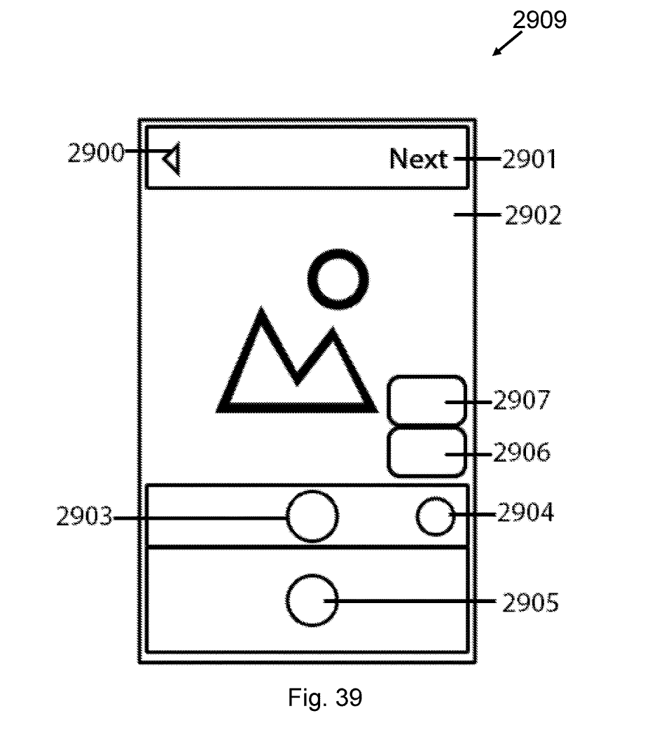

FIG. 39 illustrates an exemplary embodiment of a camera rewards display 2909. The camera rewards display 2909 may include a back button 2900 and a next button 2901. The back button 2900 may take the active user back to the post-a-photo earn rewards display 2800. The next button 2901 may take the active user to a camera share display 3109. The camera rewards display 2909 may include a camera display area 2902, a venue name/logo 2907, a system name/logo 2906, a camera select button 2903, a flash type button 2904, and a capture button 2905. The camera display area 2902 may show what the camera 142 of the mobile device 120 is viewing. The venue name/logo 2907 may show a venue identifier to be superimposed on the camera image. The system name/logo 2906 may show a system identifier to be superimposed on the camera image. For a mobile device with multiple cameras, the camera select button 2903 may select which camera view of the mobile device is being displayed in the camera display area 2902. The flash type button 2904 may allow the active user to select from one or more flash options. The capture button 2905 may be engaged by the active user to capture the image in the camera display area 2902 with the venue name/logo 2907 and system name/logo 2906 superimposed.

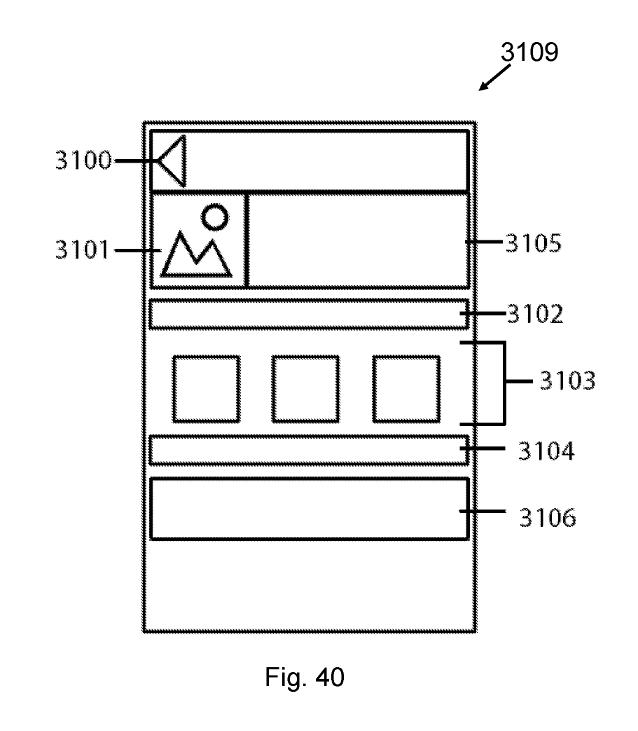

FIG. 40 illustrates an exemplary embodiment of a camera share display 3109. The camera share display 3109 may include a back button 3100 that takes the active user back to the camera rewards display 2909. The camera share display 3109 may include a thumbnail area 3101, a text editing area 3105, an indicators list 3102, a social media listing 3103, a social media requirements field 3104 and a submit picture button 3106. The thumbnail area 3101 may show a thumbnail image of the photo captured on the camera rewards display 2909 for sharing on social media. The text editing area 3105 may provide an area where the active user can add text that will get shared along with the captured photo. The indicators list 3102 may show a group of indicators, for example hashtags, that the system and/or venue require to be shared with the photo for the user to receive the rewards for posting the photo. The social media listing 3103 may show third party social media sites to which the active user may post the captured photo to get system rewards. The social media requirements field 3104 may tell the active user the social media posting requirements for the captured photo in order to receive the system rewards. The submit picture button 3106 may enable the active user to submit the captured image and text to the selected social medial sites.

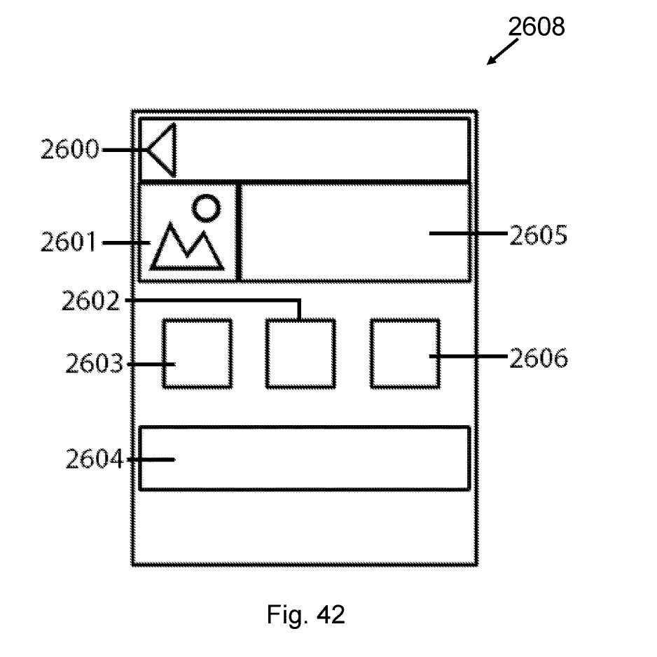

FIG. 41 illustrates an exemplary embodiment of a camera display 1408. A user can get to the camera display 1408 by selecting the camera button 1017 which may be on the bottom navigation legend 1014. The camera display 1408 may include a back button 1400 that takes the active user back to the previous display and a next button 1401 that takes the active user to a camera share display 2608 (see FIG. 42). The camera display 1408 may include an active image display 1402, a camera selection button 1403, a flash options button 1404, a photo upload button 1405 and a capture button 1406. The active image display 1402 may show an image from a camera of the mobile device or an uploaded image. The camera selection button 1403 may enable the active user to select a desired camera for a mobile device having more than one camera. The flash options button 1404 may enable the active user to select a preferred flash option. The photo upload button 1405 may enable the active user to access saved photos to be uploaded to the system. The capture image button 1406 may enable the active user to capture the image in the image display 1402.

FIG. 42 illustrates an exemplary embodiment of a camera share display 2608. The camera share display 2608 may have a back button 2600 that takes the active user back to the camera display 1408. The camera share display 2608 may include a thumbnail area 2601, a text area 2605, a group of social media indicators 2602, 2603, 2606, and a post button 2604. The thumbnail area 2601 may show a thumbnail of the uploaded or captured photo that will be shared. The text area 2605 may provide an area for the active user to attach text for sharing with the photo. The group of social media indicators 2602, 2603, 2606 may enable the active user to select one or more of a plurality of different social media applications to post the photo and text. The post button 2604 may post the captured image to a system newsfeed and to the selected social media applications.

FIG. 43 illustrates an exemplary embodiment of a notifications display 1602. A user can get to the notifications display 1602 by selecting the notification button 1018 which may be on the bottom navigation legend 1014. The notification display 1602 may have a back button 1600 that takes the active user back to the previous display. The notification display 1602 may have a follow request area 1601, an attending events area 1603, a notifications filter 1604 and a notification list 1615. The follow request area 1601 may indicate if any remote users have requested to follow the active user, and how many requests still require action by the active user. If the active user has their account set as a private account, then they will need to approve remote users that want to follow them. The follow request area 1601 may only appear if the active user has follow requests. The follow request area 1601 may provide a link to an area where the active user can approve, deny, or remove follow requests. The attending events area 1603 may show events the active user has indicated they are going to attend, or show whether there are any upcoming events the active user has indicated they are going to attend and how many. The attending events area 1603 may also include a link that brings the active user to a calendar area so they can see where they can review the events they indicated they are going to attend, along with links to the calendar and/or an event description. The notifications filter 1604 may enable the active user to filter and sort the notification list 1615. The notifications list 1615 may include various types of notifications for the active user. The notifications list 1615 may include, for example, a new match notification 1605, a new message notification 1606, an opened message notification 1607, a like notification 1608, a chili pepper/attractiveness notification 1609, etc. The new match notification 1605 may indicate the active user has received a new match request from a remote user. The new message notification 1606 may indicate the active user has received a new message. The opened message notification 1607 may indicate a recipient has opened the active user's message. The like notification 1608 may indicate that a remote user has indicated they like the active user. The new chili pepper/attractiveness notification 1609 may indicate a remote user has given chili peppers/attractiveness points to the active user. Each of the notifications may include a time stamp 1612 identifying when the active user received the notification, a profile image or chili pepper 1613 related to the notification, or a thumbnail image 1614 showing the image that was liked by a remote user, if applicable.

FIG. 44 illustrates an exemplary embodiment of a profile display 1514. The profile display 1514 may include a username field 1500, a settings button 1501, a profile image area 1504, a followers indicator 1502, a following indicator 1503, a system credit balance field 1505 and a chili pepper/attractiveness field 1507. The username field 1500 may provide a username associated with the profile. The settings button 1501 may take the active user to the settings display 900 (see FIG. 18). The profile image area 1504 may an image associated with the profile. The followers indicator 1502 may show the number of remote users following the user associated with the profile. The following indicator 1503 may show the total number of remote users that the user associated with the profile is following. The system credit balance field 1505 may show the amount of system credits or hootloot currently held by the user associated with the profile. The chili pepper/attractiveness field 1507 may show the attractiveness rating or chili pepper score of the user associated with the profile. The profile display 1514 may also include an actual name field 1506, a user website link 1508, a user bio area 1509 and a user check-in status field 1510. The actual name field 1506 may show the actual name of the user associated with the profile. The user website link 1508 may show the URL of a website for the user associated with the profile. The user bio area 1509 may provide biographical information for the user associated with the profile. The user check-in status field 1510 may indicate whether the user associated with the profile is checked into any venues and/or events. The profile display 1514 may also include a plurality of user profile images 1511, and a plurality of posted photos 1512 that have been posted to or through the system by the user associated with the profile.

Some system embodiments may allow an active user to indicate that they like a remote user in the people display, an example of which is shown in FIG. 4. When a remote user indicates that they like the active user, the active user's chili pepper score or attractiveness rating in the system database or server can be increased by one. The chili pepper score or attractiveness rating may be used by venues using the system to target market to users with high attractiveness ratings, the “hottest’ people. Marketing people may indicate what and when they would like to market through areas of the system including, for example, the spot legend display 1810 (FIG. 19), the edit venue info display 1921 (FIG. 21), the guest list display 2114 (FIG. 24), the VIP list display 2115 (FIG. 25), and/or the create event display 1922 (FIG. 22). The offers may then be made available to the users through, for example, the hoots/news stream display 200 (FIG. 2) and/or the spots/places display 500 (FIG. 5).

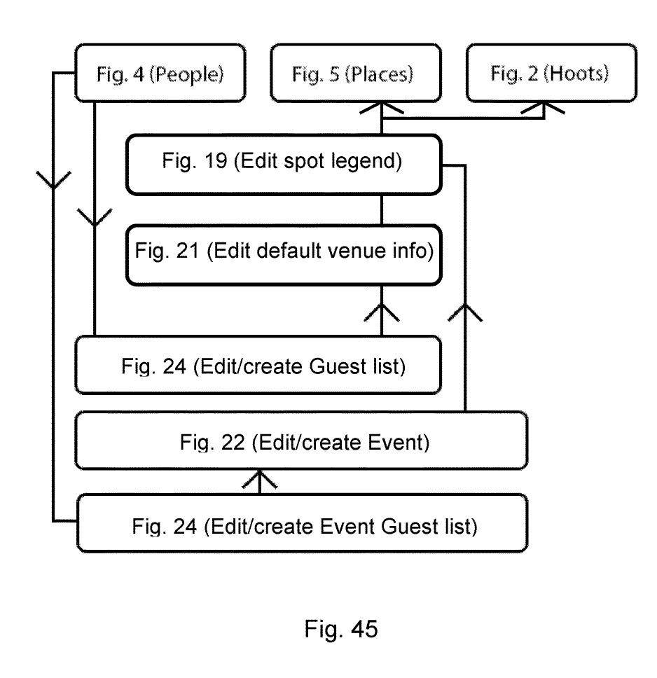

FIG. 45 illustrates an exemplary system implementation and corresponding displays that a venue could use to target market to particular people or users. The venue can create guest lists for an event using the guest list display 2114 (FIG. 24) and the VIP list display 2115 (FIG. 25), and then create the event entry using the create event display 1922 (FIG. 22). Alternatively or in addition, the venue marketing people can create default guest lists for the venue using the guest list display 2114 (FIG. 24) and the VIP list display 2115 (FIG. 25), and create the venue entry using the venue information display 1921 (FIG. 21). The entries in the system database for the people from the people display 400 (FIG. 4) are used in creating the guest lists. The guest list, event and venue information along with the spot legend display 1810 (FIG. 19), are processed by the system to create updates and offers that may then be made available to the users through, for example, the hoots/news stream display 200 (FIG. 2) and/or the spots/places display 500 (FIG. 5).

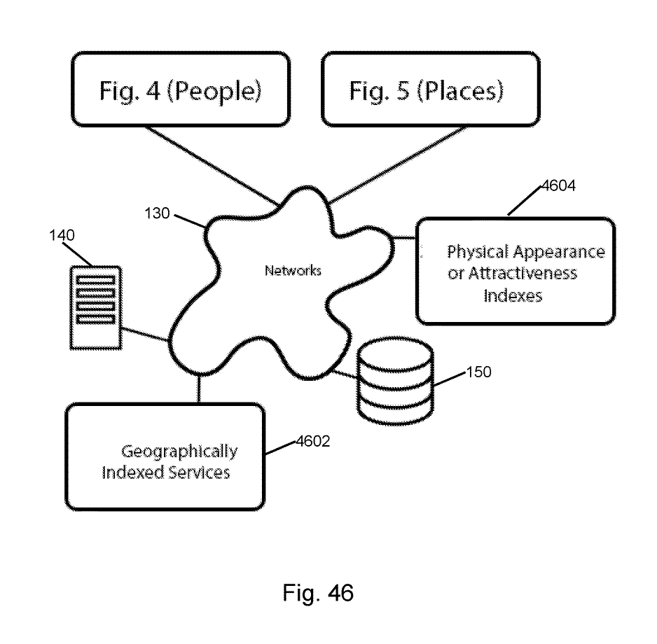

FIG. 46 illustrates an exemplary system implementation to determine a hot/attractiveness rating for a venue based on the people attending the venue. The system obtains some of the people information through the people display 400 (FIG. 4) and venue information through the spots/places display 500 (FIG. 5) which can be stored in the system database 150 and/or server 140. The system can determine all the users attending or planning to go to a certain venue using user entries as well as user GPS information transmitted from user devices over networks 130 to the system database 150 and/or server 140. The system can then get the chili pepper/attractiveness rating 4604 of all the users attending or planning to go to the venue from the system database 150 and/or server 140 which are all interconnected over the networks 130. The system can then determine an average attractiveness rating of people for the venue. This hot/attractiveness rating for a venue based on the people attending the venue can be done for any or all of the venues, and users can compare the attractiveness ratings of different venues to determine where the “hottest” people are expected to be.

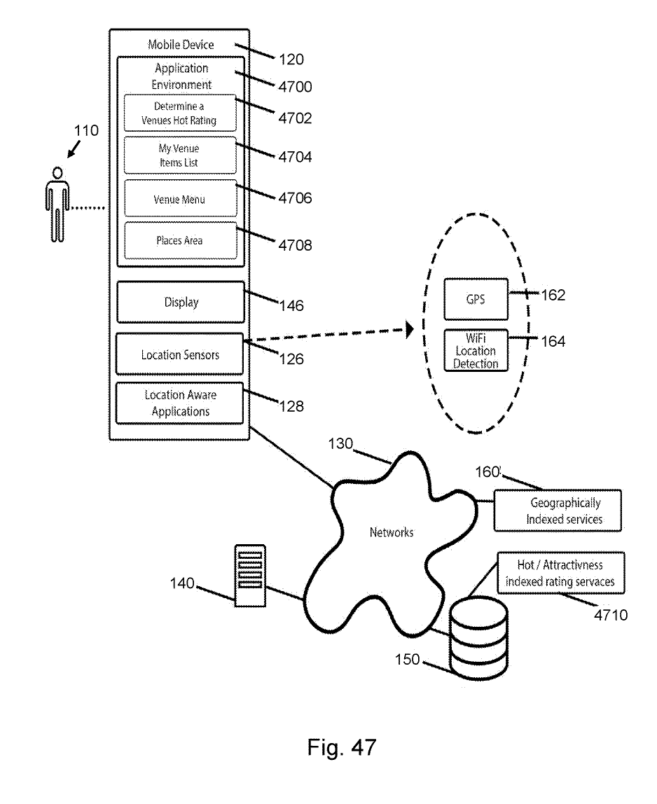

FIG. 47 illustrates exemplary system implementations to purchase items from a venue. This can be used by a venue to sell drinks and other items faster and more efficiently, and by users to pre-purchase items for a venue to reduce wait times. As explained above, for example with reference to a venue menu display (FIG. 6), an active user may purchase items through the system. In one embodiment, an option to buy items from a venue may allow the active user to find a venue with the best hot/attractiveness rating (see for example FIG. 46) and buy items from that venue through the system. A purchase item display (see for example, the venue menu display 600 of FIG. 6) may have a purchase button that takes the active user to a purchase item/drink display, and an item/drink display button that may take the active user to an item/drink display with descriptions and/or pictures. A coupon/voucher profile (see for example, the my venue items display 700 of FIG. 7) may include a venue indicator that identifies where a respective voucher may be used, a cost indicator that shows the cost of a respective voucher, a type indicator that shows what type of item the voucher may be used for, a date indicator that identifies the time/date when the voucher can be redeemed, a redemption instruction box that explains how to redeem the respective voucher, and a payment input location that allows the active user to input payment information to purchase a voucher. A next voucher display may be shown or partially shown that allows the active use to scroll through available item vouchers for review and/or purchase. The purchase item functionality may also include a list of purchased items, a purchase item button that takes the user to a purchase item display, and an item/menu display that takes the user to a menu or display of items available for purchase at a venue. Additionally, a voucher display area may have a use button that a server or representative from the venue can press in order to indicate that the voucher is used.

FIG. 47 shows an active user 110 with their mobile device 120 with an application environment 4702, a display 146, location sensors 126 and location aware applications 128. The location sensors 126 can include a GPS receiver 162 and WiFi location detection 164 as well as other location functionality. The mobile device 120 can wirelessly connect with networks 130, which may include venue networks, to access system server 140, system database 150 that may contain hot/attractiveness indexed rating services 4710 for users and venues, and other geographically indexed services 160. The active user 110 can use their mobile device 120 to view a list of places/spots 4708 (see for example, spots/places display of FIG. 5) near the user's current location or a selected location. The system can determine a venue hot rating 4702, for example based on hot/attractiveness ratings of attendees (see for example, FIG. 46). Based on proximity, hot rating or other criteria the user 110 can select a venue and pull up a venue menu 4706 for the selected venue (see for example, venue menu display of FIG. 6) to review and/or purchase items/drinks for the venue. The user 110 can also pull up a my venue items list 4704 for the selected venue (see for example, my venue items display of FIG. 7) to review items/drinks already provided or purchased for the venue.

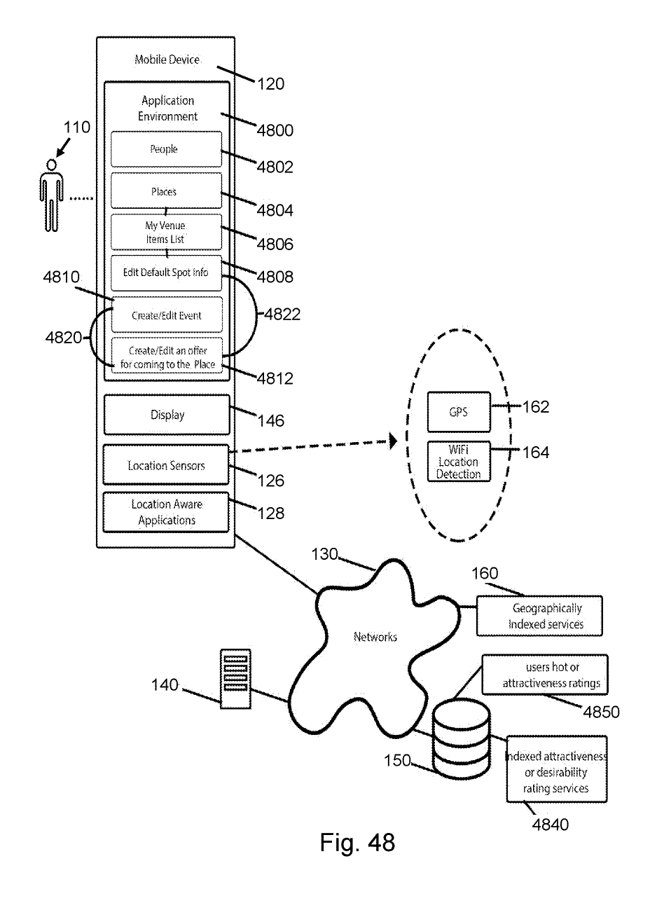

FIG. 48 illustrates an exemplary system implementation to market offers to hot/attractive people. This system can gather information about its users from within the application environment 4800 where remote users judge users on their attractiveness or attractiveness and likability. When the system is gathering information from within the application environment 4800, it may be doing so from a user or people area 4802 (see for example, people display of FIG. 4). The system may also gather information from outside the application environment from third party or outside indexed attractiveness or desirability rating services 4840 when it is determining the hot/attractive ratings of its users. The system may use and/or store this third party indexed attractiveness or desirability rating services 4840 information in the database 150. The hot/attractiveness ratings 4850 for users determined by the system may be stored in the database 150. Places/venues can make offers 4812 available to selected users, for example free drink vouchers, when those selected users achieve a certain hotness or attractiveness ratting determined by the venues. These offers 4812 may be made available to the selected users in a newsfeed or wall area of social networks or be shown to users along with information about a venue. One example of how these offers 4812 can be displayed to a user would be to show the offer 4812 when they are searching for a specific venue/place 4804 (see for example, spots/places display of FIG. 5) or types of venues. The venue display may have an area that lists offers 4812 being made by each venue to the selected user (hot user). These offers 4812 may help entice the user to go to the venue, and it my entice them to check into the venue in order to receive the offer. The offers 4812 may be created by the venues or third party marketing management companies. The offers 4812 may be created in a display similar to the free drinks display shown in FIG. 26. The offers 4812 can be set in a default venue display 4808 (see for example, venue information display of FIG. 21) to be made on a recurring basis, or the offers can be made for particular events 4810 (see for example, create event display of FIG. 22) so they are only given for the event. Venues may be able to require the user or guest to check in using their mobile device 120 publically or privately on one or more social networks in order to receive their Hot/Attractiveness offer/reward 4812. Offers may be for items the venue offers, discounts from the venue or reward points that may be used to purchase items from the venue. The marketing and tracking system itself may also provide offers or rewards to users for checking in depending on the users hot/attractiveness ratings. Offers and rewards offered from the marketing and tracking system may include types of in system currencies that may have actual purchasing power at venues listed in the system or on menus that venues display along with their venue information. The mobile device 120 may have location sensors 126 to help determine if a user is within a check in distance of a venue that may have been set by the venue. Check in distances may be set by a venue and the check in distances may determine if a user is close enough to a venue to receive their reward or offer. The mobile device 120 may communicate with a network or multiple networks 130 that may connect to a server 140 that may connect to the system database 150 and/or connect to geographically indexed services 160. The geographically indexed services may allow the application environment 4800 to automatically populate with information about places in the area, and the system may then attach the hot/attractive rating scores for the venues 4840. Connection 4820 indicates that the venue can create/edit an offer 4812 for guests coming to a place for special events 4810. Connection 4822 indicates that the venue can create/edit an offer 4812 on recurring weekly default basis using default spot information 4808.

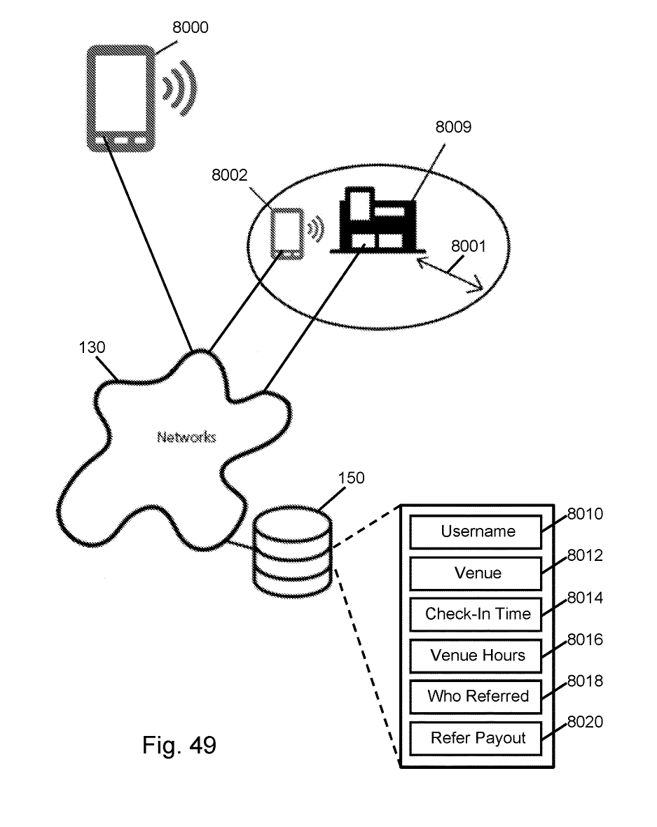

FIG. 49 illustrates an exemplary system implementation for GPS promotion guest list tracking. The system may determine that a mobile device 8000 is outside of a check-in distance 8001 set by a venue 8009, and another mobile device 8002 is inside the check-in distance 8001. Each mobile device 8000, 8002 may check GPS location in set intervals to determine whether it is within the check-in distance 8001 and provide this information over networks 130. When the mobile device 8002 becomes located within the check-in distance 8001 of the venue 8009, the system can automatically check-in the active user to the venue 8009 if the auto check-in feature is enabled.

In another aspect of the system, a system database 150 may have a plurality of inputs saved therein. More specifically, when any user checks-in to a venue, the database 150 may add an entry to a list that includes a username 8010 of the checked-in remote user and a venue name 8012 that they checked-into. The database 150 may also maintain a check-in time 8014 when the user checked into the venue, the hours of operation 8016 for the venue 8012. The database 150 may also include a referral tracker that tracks each successful user referral, and the referral tracker may include a promoter identifier 8018 for who referred the user, and a promoter commission 8008 indicating how much commission the promoter should receive for the successful user referral.

In another embodiment, the system may provide added security features to keep malicious users from providing incorrect GPS coordinates. In one non-exclusive example, this may be achieved by using a Wi-Fi location check-in verification. More specifically, when a venue 8009 enables Wi-Fi check-in verification, the active user's mobile device 8002 will check the database for venues where the user is within the venue's check-in distance 8001 (in one nonexclusive example, the mobile device may check every minute). The system may then check the database 150 to identify the Wi-Fi connection name of the venue 8009. The system may then check to see if the Wi-Fi functionality of the active user's mobile device 8002 is able to discover the Wi-Fi connection name of the venue 8009. If the system properly correlates the venue's Wi-Fi name with the active user's mobile device Wi-Fi connection name, then the Wi-Fi check-in verification is successful.

Another embodiment of the present disclosure may include a tool for active users to identify venues with remote users who have the most followers. More specifically, the system may determine a score for each user in the database 150 based on the user's social interaction in the system and on other social media metrics. This user score can then be assigned to the respective user within the system and may be shown to other users via the scored user's profile. This embodiment may also allow the system to consolidate all user scores for users attending a particular venue or event, and generate an average social media score for the venue or event based on the scores of all of the users attending the event.

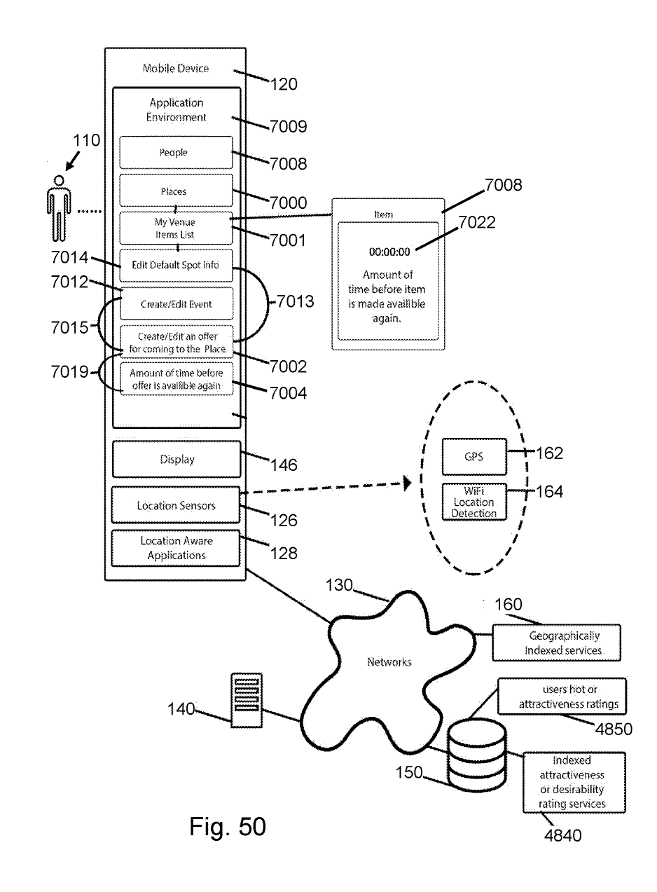

FIG. 50 illustrates an exemplary implementation of a reloading coupon/voucher. A reloading coupon 7008 may be used by a venue that wants to attract customers to their venue and retain customers in their venue. The venue may have multiple offers, coupons, or rewards they have budgeted to give to a customer, but they only want the offers distributed to customers that have stayed at the venue for a set amount of time. The reloading coupon 7008 can activate at venue check-in or a preset time after venue check-in, and then reload a certain amount of time thereafter or a certain amount of time after each use. For example, the coupon 7008 could reward a user 110 with a free drink for checking into the venue, and then reward the user 110 again each hour thereafter for some preset or unlimited number of times. A venue could change each offer so that the user 110 gets alternating offers after each reloading period. The reloading coupons 7008 could be accessible to users 110 that have a mobile device 120 with an application environment 7009 that includes information about the venue 7000 (see for example, spots/places display of FIG. 5) and/or information about the relevant offer for the venue in an items list 7001 (see for example, My Venue Items display of FIG. 7). The reloading coupon 7008 my show the active user 110 a time left until the coupon 7008 becomes available to them again 7022. Displaying the time left 7022 to the active user may become a motivator to get the active user 110 to stay longer at a venue and may convince them to motivate others spending money at the venue to stay longer, increasing venue revenues. The venue may set a reload time 7004 for the coupon 7008 in an area linked 7019 to an offer creation area 7002 for creating offers for coming to a place. The offer creation 7002 can be linked 7013 to venue default information 7014 to create venue default offers, for example to create an offer that occurs every week on a particular day of the week. The offer creation 7002 can be linked 7015 to venue event information 7012 to occur only for a special venue event. The application environment 7009 may include a display 146, location sensors 126, and location aware applications 128. The location sensors 126 may include GPS sensors 162 and/or WiFi Location Detection 164. The mobile device 120 may be connected to one or more networks 130 that allow the mobile device 120 to connect to the internet, one or more servers 140, databases 150, and/or geographically Indexed services 160.

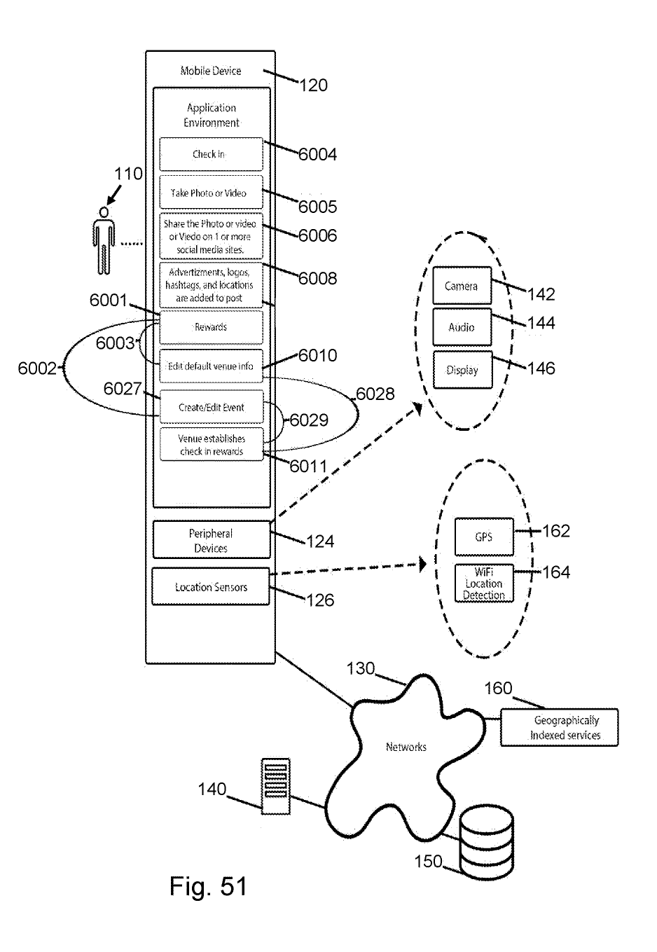

FIG. 51 illustrates an example of an embodiment for providing rewards to users for taking a photo or video for marketing once checked into a place. A venue can use this functionality to encourage people checking into the venue to act as marketers for their venue. FIG. 51 illustrates an example of a user 110 with a mobile device 120 with a check-in module 6004 that tracks the user 110 checking into a venue. After checking into the venue, a photo/video reward module 6005 may prompt the user 110 with a reward offer for taking a photo while checked into the venue if the user 110 shares the photo/video to at least one social media network using a social media sharing module 6006. The venue may require that the photo/video needs to include venue logos and hash tags 6008 in order for the user 110 to receive the reward 6001. The hash tags that the venue may require the user to include or the hash tags that may be automatically included in the post may include the city, venue name, system name, or other information. The logos that the venue may require on the photo may also be automatically attached to the photo when the photo is shared. The venue may be able to set the reward 6001 using a rewards module 6011, or the system may automatically create the reward 6001 for the venue based on marketing budgets set by the venue in the system database 150. Rewards and marketing budgets for rewards may include coupons, items the venue offers for sale (tangible or intangible), or reward points that may be used to buy things from the venue or from a store accessible through the application environment. The rewards for checking in, taking photos and posting the photos may be created by the venue 6011 and linked 6028 to default venue information 6010 for each day of the week. The rewards may be created by the venue 6011 and linked 6009 when the venue is creating information about special events 6027 that may not be reoccurring events. The mobile device 120 may include peripheral devices including a camera 142, audio inputs and outputs 144, and/or a display 146. Like in other areas of this document and in other embodiments, the mobile device 120 may be in communication over networks 130 that may be connected to one or more databases 150, servers 140 and/or geographically indexed services 160.

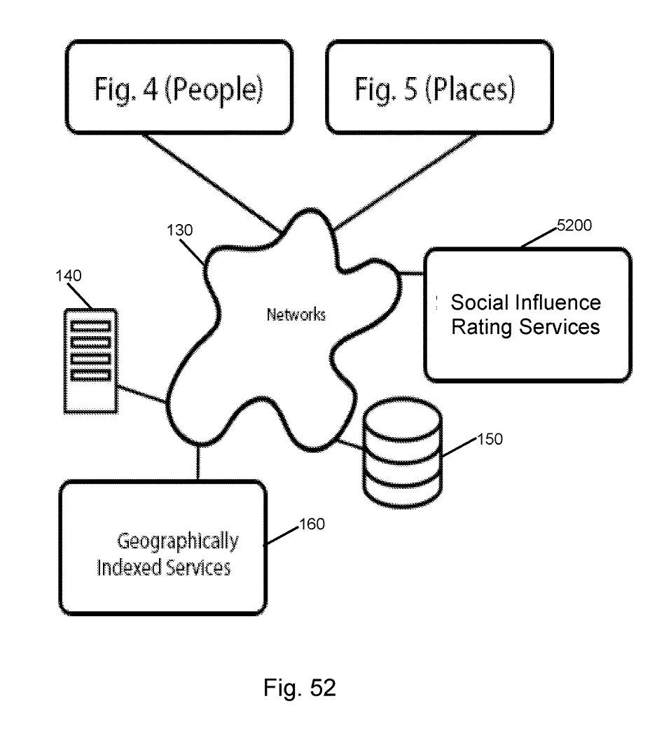

FIG. 52 illustrates an exemplary embodiment for locating people with social influence. An application environment may be connected over networks 130 to social networks or social influence rating services 5200 that index information about which users are most influential in their networks, for example facebook may give information about how many likes or how many friends a particular user has allowing an application to score its users. Once social influence scores are created for users of the application, the scores may be kept in a database 150. By tracking the locations of system users with geographically indexed services 160, the system can determine the venues (see for example, spots/places display of FIG. 5) which people/users (see for example, people display of FIG. 4) are currently located at or checked into. The system can also access the social media scores of the people from the database 150. Using this information, the system can tell the other users where the people with the most influence are or are going to be located. Users could also use the system to let other users know where they were planning on going in a public way (where any user can find out) or a private way (where only selected users can find out). Whether through a public or private way, the system may be able to use this information to determine what users are going where and determine a venue's social influence based on its guests. This would be beneficial to people wanting to go to places where influential people were hanging out in order to boost their career or become seen by influential people. Using a similar procedure, the system could also be connected to career sites (for example LinkedIn) or pay scale sites over the networks 130, to allow users to see where the people with the best jobs and/or the jobs with the highest salaries or pay are going to or are already checked into. Filters could allow active users to search for the places around them with people that have the best jobs, types of jobs, most social influence. If users elect to disclose financial information, even where the wealthiest people are checked in or have indicated they are going to be.

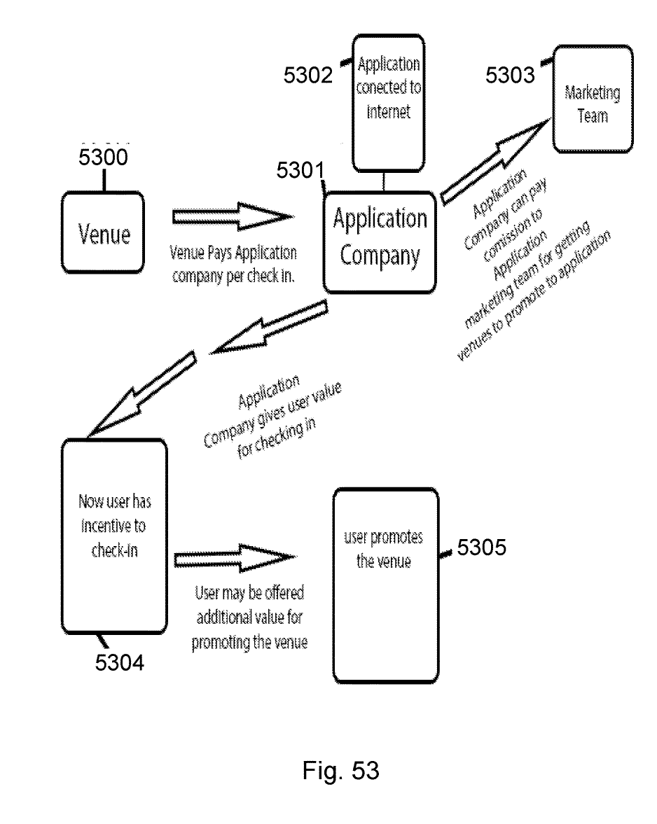

FIG. 53 illustrates an example of a marketing company business model using the disclosed system. A venue 5300 may pay a marketing company 5301 to help them market their venue using a marketing system 5302 owned or developed by the marketing company 5301. The venue 5300 may pay the marketing company 5301 for each user that checks into their venue the marketing system 5302. The marketing system 5302 may be a mobile application that can be downloaded to mobile devices carried by customers that can be connected to the internet. The marketing company 5301 may then be able to use some of the money the venue pays them per check-in to a marketing team 5303 to get more venues to sign up to use the marketing system 5302 and pay thus pay the marketing company 5301. The marketing company 5301 may also offer rewards to users for checking into the venue 5300 using the marketing system 5302 through their mobile device to provide users with an incentive to check-in 5304. The more users of the marketing system 5302 that check-in to the venue 5300 using the marketing system 5302, the more popular the venue 5300 will look because the venue 5300 will show a larger crowd. The venue 5300 may wish for users of the marketing system 5302 to check-into their venue via outside social media applications in which case the marketing company 5301 could also reward the users for that action. The marketing company 5301 may also reward users' additional rewards for promoting the venue 5305 on the application 5302 or on other social media applications. An example of how users could promote the venue would be to post photos on social media sites while they are at the venue. These posts may be coupled with hash tags relevant to the venue so that the venue would show up in search results for people searching for places similar to the venue.

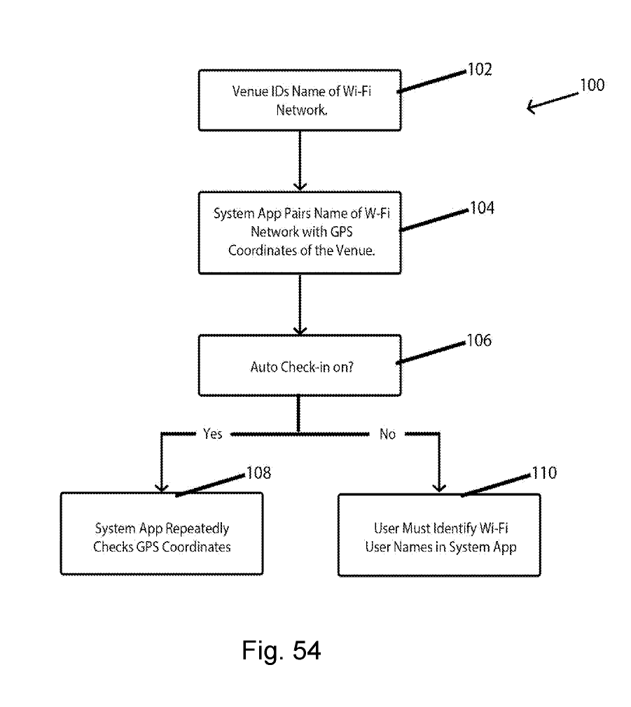

FIG. 54 shows a flow diagram for an exemplary wireless check-in verification process 100 that may be implemented to allow proper verification of venue location. In some embodiments, a venue may provide additional security to dissuade users from providing a fake GPS location. At block 102, the check-in verification process 100 may provide additional security measures to ensure an active user's location, for example the system may transmit a wireless signal to the system to identify the name of the wireless network used by the venue. At block 104, the system pairs the name of the Wi-Fi network with the GPS coordinates of the specific venue. At block 106, the system determines whether the auto check-in feature is enabled. If the auto check-in feature is enabled, then at block 108 the system regularly checks the GPS coordinates of the user. At block 108, when the user is near the venue for an established amount of time, the system may check-in the user to the guest list. When the system is trying to check-in the active user to the venue with the Wi-Fi location check-in verification turned on, it will only check-in to the venue if the active user's mobile device checks the Wi-Fi networks and verifies the Wi-Fi network name correlates with the GPS location set by the venue. If the system auto check-in feature is not enabled, then at block 110 the system app waits for the active user to go to the check-in screen to check to see what venues are around the active user that the active user can check into. The venues shown to the active user are venues that are both within Wi-Fi network range and venues that have Wi-Fi network names. The system may then match the venue's network name detected by the system with the selected venue.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

I claim:

1. A target marketing and tracking method comprising:
collecting user-specific information for a plurality of users;
collecting venue-specific information for a plurality of venues;
storing the user-specific information and the venue-specific information in a system database;
tracking and communicating with each of the plurality of users using a plurality of mobile devices, each of the plurality of mobile devices being associated with one of the plurality of users;
allowing each of the plurality of users to enter an user attractiveness value for each of the other users of the plurality of users;
storing the user attractiveness values in the system database;
for each particular user of the plurality of users, determining an user attractiveness rating for the particular user based on the user attractiveness values for the particular user;
storing a venue location for each of the plurality of venues in the system database;
receiving user location information from each of the plurality of mobile devices;
determining user attendance at a particular venue of the plurality of venues based on the venue location for the particular venue and the user location information.

2. The target marketing and tracking method of claim 1, further comprising for each particular venue of the plurality of venues:
determining users currently at the venue based on the venue location for the particular venue and the user location information from the plurality of mobile devices;
retrieving the user attractiveness rating for each of the users currently at the venue;
calculating a current venue attractiveness rating for the particular venue based on the user attractiveness ratings for the users currently at the venue.

3. The target marketing and tracking method of claim 1, further comprising:
allowing each individual user of the plurality of users to enter going-to information, the going-to information including a going-to location identifier and a going-to time identifier.

4. The target marketing and tracking method of claim 3, further comprising for each particular venue of the plurality of venues:
determining users currently at the venue based on the venue location for the particular venue and the user location information from the plurality of mobile devices;
determining users planning to attend the venue today based on the going to information where the going-to location identifier indicates the particular venue and the going-to time identifier indicates today;
retrieving the user attractiveness rating for each of the users currently at the venue and for each of the users planning to attend the venue today that are not currently at the venue;
calculating a current venue attractiveness rating for the particular venue based on the user attractiveness ratings for the users currently at the venue and the users planning to attend the venue today.

5. The target marketing and tracking method of claim 1, further comprising for each particular venue of the plurality of venues:
determining users currently at the venue based on the venue location for the particular venue and the user location information from the plurality of mobile devices;
retrieving the user attractiveness rating for each of the users currently at the venue;
determining the N most attractive users of the users currently at the venue based on the user attractiveness ratings for the users currently at the venue, N being a positive whole number.

6. The target marketing and tracking method of claim 5, wherein a requesting user specifies the value of N.

7. The target marketing and tracking method of claim 1, further comprising:
allowing each individual user of the plurality of users to enter going-to information, the going-to information including a going-to location identifier and a going-to time identifier; and
for each particular venue of the plurality of venues:
determining users currently at the venue based on the venue location for the particular venue and the user location information from the plurality of mobile devices;
determining users planning to attend the venue today based on the going to information where the going-to location identifier indicates the particular venue and the going-to time identifier indicates today;
retrieving the user attractiveness rating for each of the users currently at the venue and for each of the users planning to attend the venue today that are not currently at the venue;
determining the N most attractive users of the users currently at the venue and planning to attend the venue today based on the user attractiveness ratings for the users currently at the venue and planning to attend the venue today, N being a positive whole number.

8. The target marketing and tracking method of claim 1, further comprising for each individual venue of the plurality of venues:
enabling the individual venue to access the user-specific information and the user attractiveness values for the plurality of users;
enabling the individual venue to generate a venue guest list, the venue guest list comprising a plurality of the plurality of users;
when an individual user of the plurality of users is determined to be at the individual venue based on the venue location for the individual venue and the user location information for the mobile device associated with the individual user:
automatically checking the venue guest list to determine whether the individual user is included on the venue guest list; and
if the individual user is included on the venue guest list, updating the venue guest list to indicate the individual user has arrived.

9. The target marketing and tracking method of claim 8, further comprising for each individual venue of the plurality of venues:
enabling the individual venue to offer venue vouchers to selected users of the plurality of users, the venue vouchers being redeemable for discounted items at the individual venue.

10. The target marketing and tracking method of claim 9, further comprising for each individual venue of the plurality of venues:
enabling the individual venue to set a discount level for the venue vouchers offered to the selected users, the discount level of a particular venue voucher offered to a particular selected user being based on the user attractiveness rating for the selected user.

11. The target marketing and tracking method of claim 9, further comprising for each individual venue of the plurality of venues:
enabling the individual venue to set a reload time for the venue vouchers offered to the selected users, the reload time of a particular venue voucher offered to a particular selected user being based on the user attractiveness rating for the selected user.

12. The target marketing and tracking method of claim 9, further comprising for each individual venue of the plurality of venues:
enabling the individual venue to set a discount level and a reload time for the venue vouchers offered to the selected users, the discount level and the reload time of a particular venue voucher offered to a particular selected user being based on the user attractiveness rating for the selected user.

13. The target marketing and tracking method of claim 8, further comprising for each individual venue of the plurality of venues:
enabling the individual venue to set a venue attractiveness threshold;
enabling the individual venue to generate the venue guest list based on one or more guest list criteria, one of the guest list criteria being that the user attractiveness rating of each user on the guest list is higher than the venue attractiveness threshold.

14. The target marketing and tracking method of claim 13, further comprising for each individual venue of the plurality of venues:
enabling the individual venue to offer venue vouchers to selected users of the plurality of users, the venue vouchers being redeemable for discounted items at the individual venue;
enabling the individual venue to set a discount level for the venue vouchers offered to the selected users, the discount level of a particular venue voucher offered to a particular selected user being based on the user attractiveness rating for the selected user.

15. The target marketing and tracking method of claim 13, further comprising for each individual venue of the plurality of venues:
enabling the individual venue to offer venue vouchers to selected users of the plurality of users, the venue vouchers being redeemable for discounted items at the individual venue;
enabling the individual venue to set a reload time for the venue vouchers offered to the selected users, the reload time of a particular venue voucher offered to a particular selected user being based on the user attractiveness rating for the selected user.

16. The target marketing and tracking method of claim 1, further comprising for each individual venue of the plurality of venues:
enabling the individual venue to offer venue vouchers to selected users of the plurality of users, the venue vouchers being redeemable for discounted items at the individual venue.

17. The target marketing and tracking method of claim 16, further comprising for each individual venue of the plurality of venues:
enabling the individual venue to set a discount level for the venue vouchers offered to the selected users, the discount level of a particular venue voucher offered to a particular selected user being based on the user attractiveness rating for the selected user.

18. The target marketing and tracking method of claim 16, further comprising for each individual venue of the plurality of venues:
enabling the individual venue to set a reload time for the venue vouchers offered to the selected users, the reload time of a particular venue voucher offered to a particular selected user being based on the user attractiveness rating for the selected user.

19. The target marketing and tracking method of claim 16, further comprising for each individual venue of the plurality of venues, when an individual user of the plurality of users is determined to be at the individual venue based on the venue location and the user location information for the mobile device associated with the individual user:
retrieving the user attractiveness rating for the individual user;
offering a particular venue voucher to the individual user, if the user attractiveness rating for the individual user is equal to or greater than a user attractiveness threshold set by the individual venue.

20. The target marketing and tracking method of claim 19, further comprising for each individual venue of the plurality of venues:
setting a reload time for the particular venue voucher, the reload time for the particular venue voucher being based on the user attractiveness rating for the individual user.
